(19) United States
(12) Patent Application Publication
(10) Pub. No.: US 2018/0074699 A1
(43) Pub. Date: Mar. 15, 2018

(54) METHOD FOR DYNAMICALLY CONFIGURING POSITIONS OF MULTIPLE KEY BUTTONS

(71) Applicants: Yonggui Li, Qingdao (CN); Kun Li, Qingdao (CN)

(72) Inventors: Yonggui Li, Qingdao (CN); Kun Li, Qingdao (CN)

(21) Appl. No.: 15/817,301

(22) Filed: Nov. 20, 2017

Related U.S. Application Data
(63) Continuation of application No. 15/657,144, filed on Jul. 22, 2017.
Application No. 15/657,144 is a continuation of application No. 15/356,639, filed on Nov. 20, 2016, now abandoned.
Application No. 15/356,639 is a continuation-in-part of application No. 14/555,660, filed on Nov. 27, 2014, now abandoned.
Application No. 14/555,660 is a continuation-in-part of application No. PCT/CN2013/075887, filed on May 20, 2013.
Application No. PCT/CN2013/075887 is a continuation-in-part of application No. 15/149,074, filed on May 6, 2016.
Application No. 15/149,074 is a continuation-in-part of application No. PCT/CN2016/070222, filed on Jan. 6, 2016.

(30) Foreign Application Priority Data
Aug. 9, 2012 (CN) 201210291364.0
Dec. 24, 2012 (CN) 201220724909.8
Nov. 30, 2015 (CN) 201510861828.0
Nov. 24, 2016 (CN) 201611051849.7
Nov. 13, 2017 (CN) 201711110744.9

(51) Int. Cl. G06F 3/0488; G06F 3/0354; G06F 1/16; G06F 3/02; H04M 1/02; H04M 1/23

(52) U.S. Cl. CPC G06F 3/04886; G06F 3/03547; G06F 1/1624; G06F 1/1626; G06F 1/1632; G06F 1/1666; G06F 1/1669; G06F 1/1671; G06F 3/0202; H04M 1/0208; H04M 1/0216; H04M 1/0237; H04M 1/23; H04M 1/236; H04M 2250/22; H04M 2250/70; G06F 2203/0333; G06F 2203/0339; G06F 3/03543; G06F 3/0488

(57) ABSTRACT

A plurality of key buttons are configured on a multi-touch sensitive surface, but their positions are initially configured to be undetermined. When one or two hands of a user touch the multi-touch sensitive surface, a plurality of touch points are detected and further sorted into a touch point sequence which is consistent with a natural order of fingers of the one or two hands. Based on the touch point sequence, the plurality of touch points are configured to be positions of the plurality of key buttons according to predefined corresponding relationships between the fingers and the plurality of key buttons. When detecting none of touch points on the multi-touch sensitive surface, i.e., all of the fingers leave the multi-touch sensitive surface, the positions of the plurality of key buttons are configured to be undetermined again.

### CROSS-REFERENCE TO RELATED APPLICATION

This application is a continuation-in-part of U.S. patent application Ser. No. 15/149,074 filed on May 6, 2016, which is a continuation-in-part of PCT patent application No. PCT/CN2016/070222 filed on Jan. 6, 2016, which claims priority benefit of China patent application No. CN201510861828.0 filed on Nov. 30, 2015, all of which are hereby incorporated by reference in their entirety.

This application is also a continuation of U.S. patent application Ser. No. 15/657,144 filed on Jul. 22, 2017, which is a continuation of U.S. patent application Ser. No. 15/356,639 filed on Nov. 20, 2016, which is a continuation-in-part of U.S. patent application Ser. No. 14/ 555,660 filed on Nov. 27, 2014, which is a continuation-in-part of PCT patent application No. PCT/CN2013/075887 filed on May 20, 2013, which claims priority benefit of China patent application No. CN201210291364.0 filed on Aug. 9, 2012 and CN201220724909.8 filed on Dec. 24, 2012, all of which are hereby incorporated by reference in their entirety.

This application also claims priority benefit of China application No. CN201611051849.7 filed on Nov. 24, 2016, and China application No. CN201711110744.9 filed on Nov. 13, 2017, all of which are hereby incorporated by reference in their entirety.

### TECHNICAL FIELD

This invention relates to a method for dynamically configuring positions of a plurality of key buttons on a touch sensitive surface such as a multi-touch pad/screen.

### BACKGROUND OF THE INVENTION

A PCT patent application with a publication No. WO 2014/023118 A1 disclosed that a plurality of key buttons can be configured on a touch pad mounted at a side of a handheld digital device. But it did not describe in detail about how to dynamically configuring positions of such key buttons.

As we know, positions of a plurality of conventional key buttons configured on a touch sensitive surface are usually predetermined and fixed.

### BRIEF SUMMARY OF THE INVENTION

A plurality of key buttons are configured on a multi-touch sensitive surface, but their positions are initially configured to be undetermined, and at least a portion of them correspond one to one to at least a portion of fingers of one or two hands of a user by predefining.

And when the one or two hands touch the multi-touch sensitive surface, a plurality of touches/touch points/touch areas are generated and detected.

A touch on the multi-touch sensitive surface is detected in the form of a touch point or/and a touch area. If only a touch area is available for a touch, a centroid of the touch area is deemed to be a touch point of the touch. In all of the following parts of this specification, a touch point represents a touch/touch point/touch area for simplicity.

Firstly, at least a portion of the plurality of touch points are matched respectively with a plurality of fingers of the one or two hands, and then at least a portion of the plurality of touch points are configured to be positions of at least a portion of the plurality of key buttons according to predefined corresponding relationships between the plurality of fingers and the plurality of key buttons.

There are two methods for operating and identifying a single input operation of one key button of at least a portion of the plurality of key buttons as follows.

Method 1: when first detecting losing of a touch point corresponding to the one key button and then detecting regaining of the touch point, a single input operation of the one key button is identified. Wherein, the one key button is operated by first releasing a corresponding finger being touching/depressing the one key button and then touching/depressing the multi-touch sensitive surface with the corresponding finger again, and after finishing the single input operation, the corresponding finger keeps touching/ depressing the one key button until starting next input operation.

Alternatively or additionally Method 2: when detecting that a pressure applied at a touch point corresponding to the one key button first equals or exceeds a threshold value and then restores to be within the threshold value again, a single input operation of the one key button is identified. Wherein, the one key button is operated by first touching/depressing the one key button hard with a corresponding finger being touching/depressing the one key button naturally and then relaxing the corresponding finger to naturally touch/depress the one key button again, and after finishing the single input operation, the corresponding finger keeps touching/depressing the one key button naturally until starting next input operation.

At any time, when the one or two hands are released and leave the multi-touch sensitive surface, none of touch points will be detected, and the positions of the plurality of key buttons are configured to be undetermined all over again.

By means of dynamically configuring positions of a plurality of key buttons configured on a multi-touch sensitive surface, a user need not align his/her fingers with the plurality of key buttons before operating, because the positions are determined after the fingers touch the multi-touch sensitive surface. And because a position of each key button of at least a portion of the plurality of key buttons is determined each time after a finger corresponding to the each key button touches the multi-touch sensitive surface, the at least a portion of the plurality of key buttons can never be touched/depressed by mistake.

In a portion of the following description, side-keys and mouse buttons, etc. configured on a multi-touch sensitive surface are embodiments of the above-mentioned key buttons.

### BRIEF DESCRIPTION OF THE DRAWINGS

FIG. 1 is a left view of a mobile phone; FIG. 2 is a stereo view thereof; FIG. 3 is a right view thereof; FIGS. 4 and 6 are an alternative side-key layout thereof; FIG. 5 is a front view thereof; FIG. 7-14 are keyboard layouts thereof.

FIG. 15 is a left view of a mobile phone; FIG. 16 is a front view thereof; FIG. 17 is a right view thereof; FIG. 18 is a back view thereof.

FIG. 19 is a stereo view of a curved screen mobile phone; FIG. 20 is also a stereo view thereof; FIG. 21-30 are keyboard layouts thereof.

FIG. 31 is stereo view of a slide mobile phone.

FIG. 32 is a stereo view of a flip mobile phone. FIG. 33-38 are a portion of keyboard layouts thereof.

FIG. 39 is a front view of a tablet computer; FIG. 40 is a stereo view thereof; FIG. 41 is a back view thereof; FIG. 43-48 are a portion of keyboard layouts thereof.

FIG. 42 is a stereo view of a tablet computer; FIG. 49-52 are a portion of keyboard layouts thereof.

FIG. 53 is a front view of a tablet computer; FIG. 54 is a stereo view thereof; FIG. 55 is a back view thereof.

FIG. 56 is a stereo view of a tablet computer.

FIG. 57- FIG. 76 are front views of a touch pad mouse, wherein FIG. 65A-FIG. 67B are larger views of the touch pad mouse.

FIG. 77A is a front view of a touch pad mouse; FIG. 77B is a right view thereof.

FIG. 77C is a front view of a touch pad mouse; FIG. 77D is a right view thereof.

FIG. 77E is a front view of a touch pad mouse; FIG. 77F is a right view thereof.

FIG. 77G is a front view of a touch pad mouse; FIG. 77H is a right view thereof.

FIG. 78A-FIG. 82 are front views of a large touch screen display device.

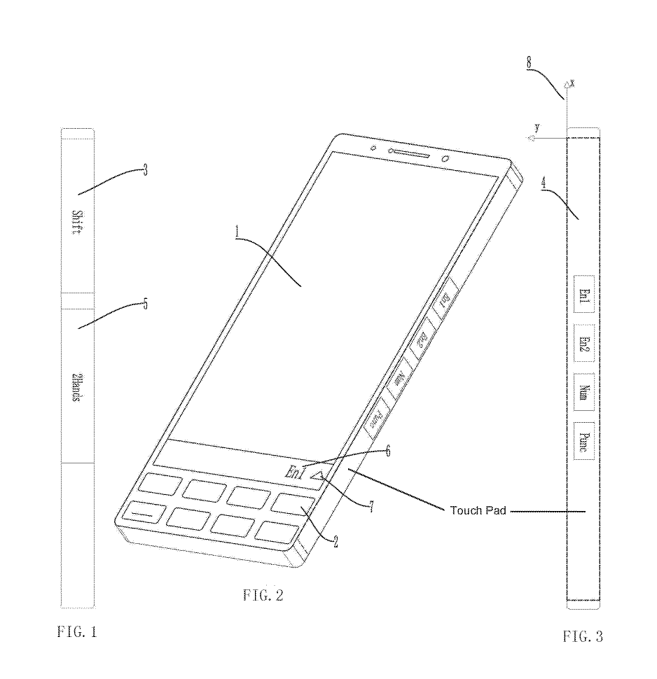

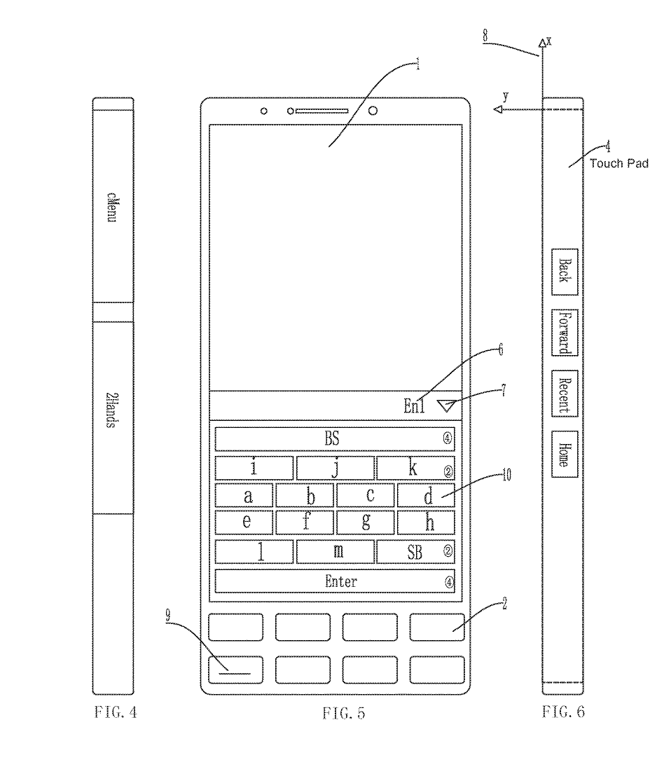

### DETAILED DESCRIPTION OF THE INVENTION

Part A.

FIG. 2 shows a mobile phone, a touch screen display 1 is configured in the front surface; a 2*4 physical keyboard 2 is located at the bottom; a key-positioning mark 9 is configured on a key of the keyboard 2; two side-keys: Shift 3 and 2 Hands 5 are configured at the left side of the phone; four side-keys: En1, En2, Num and Punc are configured on a touch pad 4 located at the right side of the phone. The touch pad 4 is a multi-touch sensitive surface and represented by a broken line box as shown in FIG. 3.

The four side-keys: En1, En2, Num and Punc correspond one-to-one to and respectively operated by index, middle, ring and pinky fingers of a left hand, and their positions are initially configured to be undetermined. Together with the keyboard 2, En1 and En2 is used for inputting 26 English letters; Num is used for mainly inputting numerals; Punc is used for mainly inputting punctuations. And Shift 3 functions like a Shift key of a PC keyboard.

As shown in FIG. 5, a dynamically mapping area 10 is configured on the touch screen display 1. According to a currently operated side-key or side-key combination, the dynamically mapping area 10 dynamically displays one of keyboard layouts as shown in FIG. 7-14 for the keyboard 2. The mapping area 10 itself can also be used as a touch keyboard. A side-key indicator 6 is configured for indicating which side-key or side-key combination is operated currently. A button 7 is configured for closing or opening the mapping area 10. As shown in FIG. 2, the mapping area is closed.

When a left hand of a user holds the mobile phone, a left thumb holds Shift 3, and left index, middle, ring and pinky fingers hold the touch pad 4, and 2 Hands 5 is depressed or touched naturally by a raised portion of a base of the left thumb. The left hand holds the mobile phone as well as holds and operates the side-keys: Shift, En1, En2, Num and Punc. And a right hand of the user operates the keyboard 2.

A control unit, which comprises processing/computing device(s), storage device(s), sensing device(s), and software(s)/firmware(s), etc., is provided for scanning and detecting touches and touch changes on a touch sensitive surface, and for detecting positions and/or areas of the touches on the touch sensitive surface, and also for identifying operations of key buttons configured on the touch sensitive surface, and so on. And all or a portion of the control unit may be either an independent unit or a part of a touch sensitive surface module or a part of a device connected to the touch sensitive surface module by cable or wirelessly. A control unit means the same thing in all parts of the present specification.

The touch pad 4 is one type of touch sensitive surface.

When a control unit detects that 2 Hands and Shift are depressed/touched and there are four touch points, of which each is represented by a coordinate pair (x, y), on the touch pad 4, it processes as follows:

According to a rectangular coordinate system 8, the control unit sorts the four touch points by x value from largest to smallest along a direction perpendicular or roughly perpendicular to the left index, middle, ring and pinky fingers holding the touch pad 4, that is, along a direction parallel or roughly parallel to a long side of the touch pad 4, and gets a touch point sequence.

And then, the control unit sequentially stores touch points in the touch point sequence as pIndex(x, y), pMiddle(x, y), pRing(x, y) and pPinky(x, y) as well as sequentially matches pIndex, pMiddle, pRing and pPinky one to one with the left index, middle, ring and pinky fingers.

And then, the control unit respectivley configures pIndex, pMiddle, pRing and pPinky to be central positions of En1, En2, Num and Punc.

And then, the control unit defines four variables: vIndex, vMiddle, vRing and vPinky which respectively correspond to the left index, middle, ring and pinky fingers, and assigns each of them with “depressing”.

And then, the control unit configures En1 to be “depressed” but Shift, En2, Num and Punc to be “released” by default, even if the left thumb and all of the left index, middle, ring and pinky fingers are respectively depressing or touching Shift, En1, En2, Num and Punc for holding the phone. 2 Hands is always depressed or touched during the phone is held. After that, the control unit enables all of the side-keys to be ready for input operation.

After one side-key of Shift, En1, En2, Num and Punc is configured to be “depressed”, when the one side-key is configured to be “released” depends on a subsequent input operation of side-key. For example, in a case where En1 and Shift are configured to be “depressed” but En2, Num and Punc are configured to be “released” (In fact, at this time, all of the side-keys are being depressed or touched because the phone is holding by the left fingers), if En2 is operated, the control unit will configure En2 to be “depressed” and meanwhile configure En1 and Shift to be “released” (Even though En1 and Shift are being depressed or touched and have never been released during operating of En2). And for another example, in a case where only En1 is configured to be “depressed”, if Shift is operated, the control unit will merely configure Shift to be “depressed” in order to realize a combination of Shift+En1. For more details, please see the following description.

Each of Shift, En1, En2, Num and Punc is operated according to the method 1 described in the brief summary.

Because one or more side-keys are operated, or because the user holds the mobile phone no longer, or because the user unconsciously adjusts holding positions for comfort or for relieving fatigue, and so on, touch points detected on the touch pad 4 will change as follows:

(A) There are more than 0 but less than 3, i.e., 1 or 2 touch points remained, it suggests that more than one finger are released and leave the touch pad 4, that is, more than one side-keys on the touch pad 4 are operated at the same time, no description is for this case in order for simplicity, and moreover it is not recommended to simultaneously operate multiple side-keys on the touch pad 4, or

(B) There is 0 touch point remained, this suggests that all of the fingers holding the touch pad 4 are released, the control unit configures the positions of En1, En2, Num and Punc to be undetermined again, and meanwhile disables all of the side-keys, and then waits for four touch points to be detected on the touch pad 4 again when also detecting that both Shift and 2 Hands are depressed or touched. Hence, at any time, there must be at least one finger keeping holding the touch pad 4, or

(C) There are just 3 touch points remained, this suggests that only a finger is released from the touch pad 4 and is be operating a corresponding side-key.

In the following description, it is assumed that only one side-key can be operated at any time. After enabling all of the side-keys, the control unit circularly scans and detects touches and changes thereof on the touch pad 4, and then proceeds as follows:

At any time, if detecting that there are only 3 touch points remained on the touch pad 4, it suggests that a left finger holding the touch pad 4 is released, the control unit sorts the three touch points by x value from largest to smallest and gets a touch point sequence, and then sequentially stores touch points in the touch point sequence as p31(x, y), p32(x, y) and p33(x, y), and

Option 1:

(a) if p31.x=pMiddle.x or pMiddle.x−(pMiddle.x-pRing.x)*0.5<p31.x<=pMiddle.x+(pIndex.x-pMiddle.x)*0.5, this suggests that the left index finger is released, a touch point of the left index finger on the touch pad 4 is lost, thus the control unit assigns vIndex with “released”, or

(b) if p32.x=pRing.x or pRing.x−(pRing.x-pPinky.x)*0.5<p32.x<=pRing.x+(pMiddle.x-pRing.x)*0.5, this suggests that the left middle finger is released, a touch point of the left middle finger on the touch pad 4 is lost, thus the control unit assigns vMiddle with “released”, or

(c) if p32.x=pMiddle.x or pMiddle.x−(pMiddle.x-pRing.x)*0.5<p32.x<=pMiddle.x+(pIndex.x-pMiddle.x)*0.5, this suggests that the left ring finger is released, a touch point of the left ring finger on the touch pad 4 is lost, thus the control unit assigns vRing with “released”, or

(d) if p33.x=pRing.x or pRing.x−(pRing.x-pPinky.x)*0.5<p33.x<=pRing.x+(pMiddle.x-pRing.x)*0.5, this suggests that the left pinky finger is released, a touch point of the left pinky finger on the touch pad 4 is lost, thus the control unit assigns vPinky with “released”.

Option 2:

(a) if a x value of each of p31, p32 and p33<=pIndex.x−(pIndex.x-pMiddle.x)*0.5, this suggests that the left index finger is released, a touch point of the left index finger on the touch pad 4 is lost, thus the control unit assigns vIndex with “released”, or

(b) if a x value of each of p31, p32 and p33>pMiddle.x+(pIndex.x-pMiddle.x) *0.5 or <=pMiddle.x−(pMiddle.x-pRing.x) *0.5, this suggests that the left middle finger is released, a touch point of the left middle finger on the touch pad 4 is lost, thus the control unit assigns vMiddle with “released”, or

(c) if a x value of each of p31, p32 and p33>pRing.x+(pMiddle.x-pRing.x)*0.5 or <=pRing.x−(pRing.x-pPinky.x)*0.5, this suggests that the left ring finger is released, a touch point of the left ring finger on the touch pad 4 is lost, thus the control unit assigns vRing with “released”, or

(d) if a x value of each of p31, p32 and p33>pPinky.x+(pRing.x-pPinky.x)*0.5, this suggests that the left pinky finger is released, a touch point of the left pinky finger on the touch pad 4 is lost, thus the control unit assigns vPinky with “released”.

Option 3:

Find a difference of a set: p31, p32 and p33 and a set: pIndex, pMiddle, pRing and pPinky, and

(a) if the difference is pIndex, this suggests that the left index finger is released, a touch point of the left index finger on the touch pad 4 is lost, thus the control unit assigns vIndex with “released”, or

(b) if the difference is pMiddle, this suggests that the left middle finger is released, a touch point of the left middle finger on the touch pad 4 is lost, thus the control unit assigns vMiddle with “released”, or.

(c) if the difference is pRing, this suggests that the left ring finger is released, a touch point of the left ring finger on the touch pad 4 is lost, thus the control unit assigns vRing with “released”, or

(d) if the difference is pPinky, this suggests that the left pinky finger is released, a touch point of the left pinky finger on the touch pad 4 is lost, thus the control unit assigns vPinky with “released”.

But at any time, if still or again detecting that there are four touch points on the touch pad 4, the control unit sorts the four touch points by x value from largest to smallest and gets a touch point sequence, and then sequentially stores touch points in the touch point sequence as p41, p42, p43 and p44, and

(a) If vIndex is assigned with “released”, it suggests that the left index finger depresses or touches and holds the touch pad 4 again, and the touch point of the left index finger on the touch pad 4 is regained, thus the control unit configures En1 to be “depressed” and the other side-keys to be “released”, and assigns vIndex with “depressing”, and updates pIndex with p41; or

(b) If vMiddle is assigned with “released”, it suggests that the left middle finger depresses or touches and holds the touch pad 4 again, and the touch point of the left middle finger on the touch pad 4 is regained, thus the control unit configures En2 to be “depressed” and the other side-keys to be “released”, and assigns vMiddle with “depressing”, and updates pMiddle with p42; or

(c) If vRing is assigned with “released”, it suggests that the left ring finger depresses or touches and holds the touch pad 4 again, and the touch point of the left ring finger on the touch pad 4 is regained, thus the control unit configures Num to be “depressed” and the other side-keys to be “released”, and assigns vRing with “depressing”, and updates pRing with p43; or

(d) If vPinky is assigned with “released”, it suggests that the left pinky finger depresses or touches and holds the touch pad 4 again, and the touch point of the left pinky finger on the touch pad 4 is regained, thus the control unit configures Punc to be “depressed” and the other side-keys to be “released”, and assigns vPinky with “depressing”, and updates pPinky with p44.

However, at any time when all of the left index, middle, ring and pinky fingers are released and leave the touch pad 4, the control unit will detect that there are not any touch points on the touch pad 4, i.e., all of the touch points on the touch pad 4 are lost. No one know at what positions the left index, middle, ring and pinky fingers will hold and depress/touch the touch pad 4 next time. So, the control unit configures the positions of En1, En2, Num and Punc to be undetermined again, and meanwhile disables all of the side-keys, and then waits for four touch points to be detected on the touch pad 4 again when also detecting that 2 Hands and Shift are depressed or touched.

In addition, at any time when the control unit detects that both Shift and 2 Hands are depressed or touched no longer, it suggests that the left hand holds the mobile phone no longer. The control unit configures the positions of En1, En2, Num and Punc to be undetermined again, and meanwhile disables all of the side-keys, and then waits for four touch points to be detected on the touch pad 4 again when also detecting that the 2 Hands and Shift side-keys are depressed or touched.

The positions of the side-keys configured on the touch pad 4 are configured to be touch points of the left index, middle, ring and pinky fingers on the touch pad 4 rather than predetermined, and moreover, the positions are dynamically updated by current respective touch points of the left index, middle, ring and pinky fingers on the touch pad 4 when in operation, namely, the positions are always current respective touch points of the left index, middle, ring and pinky fingers on the touch pad 4. So, the positions are dynamically configured rather than fixed even during operating.

By means of dynamically configuring the positions of the side-keys configured on the touch pad 4, the user need not align his/her fingers with the side-keys on the touch pad 4 before operating, and furthermore does not have to worry about depressing or touching a wrong side-key on the touch pad 4 during operating. A finger will always depress or touch a right side-key on the touch pad 4, because a side-key's position on the touch pad 4 is always configured to be a touch point of a corresponding finger after the corresponding finger holds and depresses/touches the touch pad 4.

A “depressed” action of each of En1, En2, Num and Punc can also be determined when a corresponding finger is released, i.e., a corresponding touch point is detected to be lost on the touch pad 4, rather than when the corresponding finger holds and depresses/touches the touch pad 4 again, i.e., the corresponding touch point is detected to be regained again.

When the left fingers holding the mobile phone and operating the side-keys intentionally or subconsciously adjust holding positions because of fatigue, discomfort and the other reason, touch points on the touch pad 4 will also change following the adjusting. In order to avoid identifying this kind of changes as input operations of En1, En2, Num and Punc as far as possible, the control unit can process as follows: (a) when detecting that 2 Hands is released, the control unit disables all of the side-keys; (b) Avoid simultaneously operating two or more side-keys. So, when detecting that two or more side-keys, for example, Shift and En1 are released at the same time, the control unit disables all of the side-keys; (c) Avoid simultaneously operating two or more side-keys configured on the touch pad 4. So, when detecting that there are less than 3 touch points remained on the touch pad 4, i.e., lost touch points on the touch pad 4 is more than one, the control unit disables all of the side-keys. After disabling all of side-keys, the control unit configures the positions of the side-keys: En1, En2, Num and Punc on the touch pad 4 to be undetermined again, and then waits for four touch points to be detected on the touch pad 4 again when also detecting that 2 Hands and Shift are depressed or touched.

Part B.

If the touch pad 4 as shown in FIG. 3 is a 3D multi-touch sensitive surface, a touch point is represented by a coordinate triple (x, y, p), wherein p is a pressure applied at the touch point by a finger.

It is assumed that each of En1, En2, Num and Punc is operated according to the method 2 described in the brief summary.

It is assumed that only one side-key can be operated at any time.

A control unit configures each of En1, En2, Num and Punc to be “depressed” when it is depressed hard.

The positions of En1, En2, Num and Punc are initially configured to be undetermined or pending too.

Steps before enabling all of the side-keys are the same as or similar to the counterpart description of Part A.

After enabling all of the side-keys, the control unit configures En1 to be “depressed” but Shift, En2, Num and Punc to be “released” by default, even if the left thumb and all of the left index, middle, ring and pinky fingers are respectively depressing or touching Shift, En1, En2, Num and Punc naturally for holding the phone.

And then, the control unit circularly scans and detects touches and changes thereof on the touch pad 4. For each detecting loop, if still detecting that there are four touch points on the touch pad 4, the control unit sorts the four touch points by x value from largest to smallest and gets a touch point sequence, and then sequentially stores touch points in the touch point sequence as p41, p42, p43 and p44, and

(a) If p41.p>thresholdIndex or p41.p>thresholdIndex for a given time, it suggests that the left index finger depresses En1 hard, the control unit configures En1 to be “depressed” and the other side-keys to be “released”, or

(b) If p42.p>thresholdMiddle or p42.p>thresholdMiddle for a given time, it suggests that the left middle finger depresses En2 hard, the control unit configures En2 to be “depressed” and the other side-keys to be “released”, or

(c) If p43.p>thresholdRing or p43.p>thresholdRing for a given time, it suggests that the left ring finger depresses Num hard, the control unit configures Num to be “depressed” and the other side-keys to be “released”, or

(d) If p44.p>thresholdPinky or p44.p>thresholdPinky for a given time, it suggests that the left pinky finger depresses Punc hard, the control unit configures Punc to be “depressed” and the other side-keys to be “released”.

The above mentioned thresholdlndex, thresholdMiddle, thresholdRing and thresholdPinky are predefined threshold values, but they can also be replaced with new values determined by means of testing and verifying when a user uses the mobile phone as shown in FIG. 2 for the first time.

When the left fingers holding the mobile phone and operating the side-keys intentionally or subconsciously adjust holding positions because of fatigue, discomfort and the other reason, touch points on the touch pad 4 will change following the adjusting. In order to avoid identifying this kind of changes as input operations of En1, En2, Num and Punc as far as possible, the control unit can process as follows: (a) When detecting that 2 Hands is released, the control unit disables all of the side-keys; (b) Avoid simultaneously operating two or more side-keys configured on the touch pad 4. So, when detecting that more than one finger depress hard on the touch pad 4, i.e., p values of more than one touch point exceed their respective predefined threshold values at the same time, the control unit disables all of the side-keys; (c) When detecting less than four touch points remained on the touch pad 4, the control unit disables all of the side-keys. After disabling all of the side-keys, the control unit configures the positions of the side-keys: En1, En2, Num and Punc on the touch pad 4 to be undetermined again, and then waits for four touch points to be detected on the touch pad 4 again when also detecting that 2 Hands and Shift are depressed or touched.

The other aspects not described in this part are the same as or similar to the counterpart description of Part A.

Part C.

Shift 3 and 2 Hands 5 at the left side of the mobile phone in FIG. 2 can also be configured on a multi-touch pad too. If so, about how to configure their positions, how to operate Shift, and how to identify an input operation of Shift, please refer to the related description in Part A and B.

No matter what kind of key button Shift is, for example, it is a mechanical key button, if Shift is operated according to one of the two methods described in the brief summary, Shift is initially configured to be “released” by default, and then at any time when identifying a single input operation of Shift, the control unit reverses operating configuration of Shift from being “released” to being “depressed” or from being “depressed” to being “released”.

Part D.

For a side-key layout as shown in FIGS. 4 and 6, a side-key corresponding to each side-key in the side-key layout is operated by repeating a same operation, which is described in any of the two methods in the brief summary, twice quickly. For example, if En1 is operated by repeating a same operation twice quickly, Back is deemed to be operated once rather than En1 is operated twice.

In the side-key layout, Home is for returning to Home Page; Recent is for showing recently opened applications; Back and Forward are for navigation; cMenu is short for “context menu” and is used for opening and closing context Menu/Tool Bar of a current application.

Based on a currently opened application, a sliding upwards on the touch pad 4 of the left index finger can be used for volume up or page up, on the contrary, a sliding downwards thereof can be used for volume down or page down.

FIG. 7 shows a keyboard layout corresponding to En1, wherein two rows of keys 11 in the middle correspond to two rows of physical keys of the keyboard 2. An indicator \textcircled{2} 12 indicates that each extension key in an extension key row where the indicator is, is realized by simultaneously depressing and releasing two corresponding physical keys in a corresponding physical key row of the keyboard 2. For example, a “i” key is realized by simultaneously depressing and releasing “a” and “b” keys corresponding to the “i” key. And an indicator ED 13 indicates that each extension key in an extension key row where the indicator is, is realized by simultaneously depressing and releasing four corresponding physical keys in a corresponding physical key row of the keyboard 2. For example, a “BS” key is realized by simultaneously depressing and releasing “a”, “b”, “c” and “d” keys corresponding to the “BS” key. A usage of the other keyboard layouts as shown in FIG. 8-14 is the same as that of the keyboard layout in FIG. 7. A side-key or side-key combination corresponding to one of FIG. 7-14 keyboard layouts is labeled at the top left corner thereof respectively.

Part E.

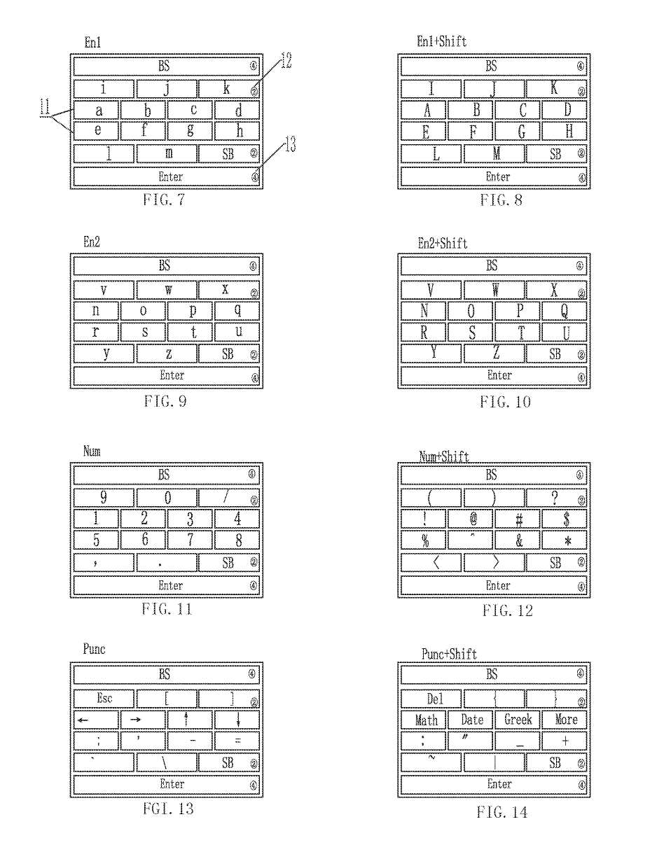

FIG. 16 is also a mobile phone. A touch screen display 14 is configured at the front surface; two side-keys: cMenu and 2 Hands are configured at the left side as shown in FIG. 15; four side-keys: Back, Forward, Recent and Home are configured respectively on two multi-touch pads 15-1 and 15-2 at the right and back sides of the mobile phone as shown in FIGS. 17 and 18.

When a left hand of a user holds the mobile phone, left thumb, index, middle, ring and pinky fingers respectively hold and operate cMenu, Back, Forward, Recent and Home side-keys at the left and right sides, in the other words, the left index, middle, ring and pinky fingers respectively correspond one to one to Back, Forward, Recent and Home.

Each of Back, Forward, Recent and Home is operated according to the method 1 of the brief summary.

Positions of Back, Forward, Recent and Home are initially configured to be undetermined.

It is assumed that only one side-key can be operated at any time.

Steps before enabling all of the side-keys are the same as or similar to the counterpart description of Part A.

After enabling all of the side-keys, Back, Forward, Recent and Home are configured to be “released” by default. And then, the control unit circularly scans and detects touches and changes thereof on the touch pad 15-1, and then proceeds as follows:

(A) At any time, if detecting that there are only 3 touch points remained on the touch pad 15-1, it suggests that a left finger holding the touch pad 15-1 is released, the control unit sorts the 3 touch points by x value from largest to smallest and gets a touch point sequence, and then sequentially stores touch points in the touch point sequence as p31(x, y), p32(x, y) and p33(x, y), and

Option 1:

(a) if p31.x=pMiddle.x or pMiddle.x−(pMiddle.x-pRing.x)*0.5<p31.x<=pMiddle.x+(pIndex.x-pMiddle.x)*0.5, this suggests that the left index finger is released, a touch point of the left index finger on the touch pad 15-1 is lost, thus the control unit configures Back with “depressed”, or

(b) if p32.x=pRing.x or pRing.x−(pRing.x-pPinky.x)*0.5<p32.x<=pRing.x+(pMiddle.x-pRing.x)*0.5, this suggests that the left middle finger is released, a touch point of the left middle finger on the touch pad 15-1 is lost, thus the control unit configures Forward with “depressed”, or

(c) if p32.x=pMiddle.x or pMiddle.x−(pMiddle.x-pRing.x)*0.5<p32.x<=pMiddle.x+(pIndex.x-pMiddle.x)*0.5, this suggests that the left ring finger is released, a touch point of the left ring finger on the touch pad 15-1 is lost, thus the control unit configures Recent with “depressed”, or

(d) if p33.x=pRing.x or pRing.x−(pRing.x-pPinky.x)*0.5<p33.x<=pRing.x+(pMiddle.x-pRing.x)*0.5, this suggests that the left pinky finger is released, a touch point of the left pinky finger on the touch pad 15-1 is lost, thus the control unit configures Home with “depressed”.

Option 2:

(a) if x of each of p31, p32 and p33<=pIndex.x−(pIndex.x-pMiddle.x)*0.5, this suggests that the left index finger is released, a touch point of the left index finger on the touch pad 15-1 is lost, thus the control unit configures Back with “depressed”, or

(b) if x of each of p31, p32 and p33>pMiddle.x+(pIndex.x-pMiddle.x) *0.5 or <=pMiddle.x−(pMiddle.x-pRing.x) *0.5, this suggests that the left middle finger is released, a touch point of the left middle finger on the touch pad 15-1 is lost, thus the control unit configures Forward with “depressed”, or

(c) if x of each of p31, p32 and p33>pRing.x+(pMiddle.x-pRing.x)*0.5 or <=pRing.x−(pRing.x-pPinky.x)*0.5, this suggests that the left ring finger is released, a touch point of the left ring finger on the touch pad 15-1 is lost, thus the control unit configures Recent with “depressed”, or

(d) if x of each of p31, p32 and p33>pPinky.x+(pRing.x-pPinky.x)*0.5, this suggests that the left pinky finger is released, a touch point of the left pinky finger on the touch pad 15-1 is lost, thus the control unit configures Home with “depressed”.

Option 3:

Find a difference of a set: p31, p32 and p33 and a set: pIndex, pMiddle, pRing and pPinky, and

(a) if the difference is pIndex, this suggests that the left index finger is released, a touch point of the left index finger on the touch pad 15-1 is lost, thus the control unit configures Back with “depressed”, or

(b) if the difference is pMiddle, this suggests that the left middle finger is released, a touch point of the left middle finger on the touch pad 15-1 is lost, thus the control unit configured Forward with “depressed”, or.

(c) if the difference is pRing, this suggests that the left ring finger is released, a touch point of the left ring finger on the touch pad 15-1 is lost, thus the control unit configures Recent with “depressed”, or

(d) if the difference is pPinky, this suggests that the left pinky finger is released, a touch point of the left pinky finger on the touch pad 15-1 is lost, thus the control unit configures Home with “depressed”.

(B) At any time, if still or again detecting that there are four touch points on the touch pad 15-1, the control unit sorts the four touch points by x value from largest to smallest and gets a touch point sequence, and then sequentially stores touch points in the touch point sequence as p41, p42, p43 and p44, and

(a) If Back is configured with “depressed”, it suggests that the left index finger holds and depresses/touches the touch pad 15-1 again, and the touch point of the left index finger on the touch pad 15-1 is regained, thus the control unit configures Back to be “released” and updates pIndex with p41.

(b) If Forward is configured with “depressed”, it suggests that the left middle finger holds and depresses/touches the touch pad 15-1 again, and the touch point of the left middle finger on the touch pad 15-1 is regained, thus the control unit configures Forward to be “released” and updates pMiddle with p42.

(c) If Recent is configured with “depressed”, it suggests that the left ring finger holds and depresses/touches the touch pad 15-1 again, and the touch point of the left ring finger on the touch pad 15-1 is regained, thus the control unit configures Recent to be “released” and updates pRing with p43.

(d) If Home is configured with “depressed”, it suggests that the left pinky finger holds and depresses/touches the touch pad 15-1 again, and the touch point of the left pinky finger on the touch pad 15-1 is regained, thus the control unit configures Home to be “released” and updates pPinky with p44.

However, at any time when all of the left index, middle, ring and pinky fingers are released and leave the touch pad 15-1, the control unit will detect that there are not any touch points on the touch pad 15-1, i.e., all of touch points on the touch pad 15-1 are lost. The control unit configures the positions of Back, Forward, Recent and Home to be undetermined again, and meanwhile disables all of the side-keys, and then waits for four touch points to be detected on the touch pad 15-1 again when also detecting that 2 Hands and cMenu side-keys are depressed or touched.

The other aspects not described in this part are the same as or similar to the counterpart description of Part A.

Part F.

The touch pad 15-1 is assumed to be a 3D multi-touch pad, a touch point is represented by a coordinate triple (x, y, p).

Each of Back, Forward, Recent and Home is operated according to the method 2 described in the brief summary.

It is assumed that only one side-key can be operated at any time. The positions of Back, Forward, Recent and Home are initially configured to be undetermined.

Steps before enabling all of the side-keys are the same as or similar to the counterpart description of Part E.

After enabling all of the side-keys, Back, Forward, Recent and Home are configured to be “released” by default.

And then, the control unit circularly scans and detects touches and changes thereof on the touch pad 15-1. For each scanning and detecting loop, if still detecting that there are four touch points on the touch pad 15-1, the control unit sorts the four touch points by x value from largest to smallest and gets a touch point sequence, and then sequentially stores touch points in the touch point sequence as p41, p42, p43 and p44, and

(a1) If Back is configured to be “released”, and p41.p>thresholdIndex or p41.p>thresholdlndex for a given time, it suggests that the left index finger depresses Back hard, the control unit configures Back to be “depressed”, or

(a2) If Back is configured to be “depressed”, and p41.p<=thresholdlndex or p41.p<=thresholdlndex for a given time, it suggests that the left index finger relaxes to depress Back naturally again, the control unit configures Back to be “released”, or

(b1) If Forward is configured to be “released”, and p42.p>thresholdMiddle or p42.p>thresholdMiddle for a given time, it suggests that the left middle finger depresses Forward hard, the control unit configures Forward to be “depressed”, or

(b2) If Forward is configured to be “depressed”, and p42.p<=thresholdMiddle or p42.p<=thresholdMiddle for a given time, it suggests that the left middle finger relaxes to depress Forward naturally again, the control unit configures Forward to be “released”, or

(c1) If Recent is configured to be “released”, and p43.p>thresholdRing or p43.p>thresholdRing for a given time, it suggests that the left ring finger depresses Recent hard, the control unit configures Recnt to be “depressed”, or

(c2) If Recent is configured to be “depressed”, and p43.p<=thresholdRing or p43.p<=thresholdRing for a given time, it suggests that the left ring finger relaxes to depress Recent naturally again, the control unit configures Recnt to be “released”, or

(d1) If Home is configured to be “released”, and p44.p>thresholdPinky or p44.p>thresholdPinky for a given time, it suggests that the left pinky finger depresses Home hard, the control unit configures Home to be “depressed”, or

(d2) If Home is configured to be “depressed”, and p44.p<=thresholdPinky or p44.p<=thresholdPinky for a given time, it suggests that the left pinky finger relaxes to depress Home naturally again, the control unit configures Home to be “released”.

The other aspects not described in this part are the same as or similar to the counterpart description of Part B and Part E.

Part G.

The multi-touch pad 15-2 is configured for holding and operating the mobile phone in FIG. 16 by a single hand (a left or right hand). In this holding case, a cMenu side-key not configured on the multi-touch pad 15-2 is realized by repeating a same input operation twice quickly by an index finger on the multi-touch pad 15-2.

When a hand holding the mobile phone operates the side-keys on the touch pad 15-2 with one or more fingers of the hand, a thumb of the hand may touch the touch screen display 14 at the same time or roughly at the same time, such a touch of the thumb on the touch screen display 14 is obviously unwanted and should be abandoned in order to avoid an undesirable operation on the touch screen display 14.

There are two methods for determining whether abandoning a touch detected on the touch screen display 14 during operating the side-keys on the touch pad 15-2 as follows.

Method 1:

For this method, a side-key configured on the touch pad 15-2 is operated according to the method 1 described in the brief summary.

(1) Detecting a touch or that there is a touch on the touch screen display 14 from detecting losing of at least one touch point to detecting regaining of all four touch points on the touch pad 15-2, wherein the touch may be present before detecting the losing of at least one touch point on the touch pad 15-2.

(2) (i) Abandoning the touch simply, or alternatively

(ii) Abandoning the touch if the touch is detected no longer on the touch screen display 14 within a given time from detecting the regaining of all four touch points on the touch pad 15-2, or alternatively

(iii) Resetting time for the touch and regarding the touch as a new touch on the touch screen display 14 if the touch is still kept in the given time from detecting the regaining of all four touch points on the touch pad 15-2.

Method 2:

For this method, a side-key configured on the touch pad 15-2 is operated according to the method 2 described in the brief summary.

(1) Detecting a touch or that there is a touch on the touch screen display 14 at any time from detecting that a pressure(s) applied at at least one touch point exceed(s) a respective predefined threshold value(s) to detecting that pressures applied at all four touch points restore to be within respective predefined threshold values again on the touch pad 15-2, wherein the touch may be present before the detecting that a pressure(s) applied at at least one touch point exceed(s) a respective predefined threshold value(s) on the touch pad 15-2.

(2) (i) Abandoning the touch simply; or alternatively

(ii) Abandoning the touch if the touch is detected no longer on the touch screen display 14 within a given time from the detecting that pressures applied at all four touch points restore to be within respective predefined threshold values again on the touch pad 15-2; or alternatively

(iii) Resetting time for the touch and regarding the touch as a new touch on the touch screen display 14 if the touch is still kept in the given time from the detecting that pressures applied at all four touch points restore to be within respective predefined threshold values again on the touch pad 15-2.

Part H.

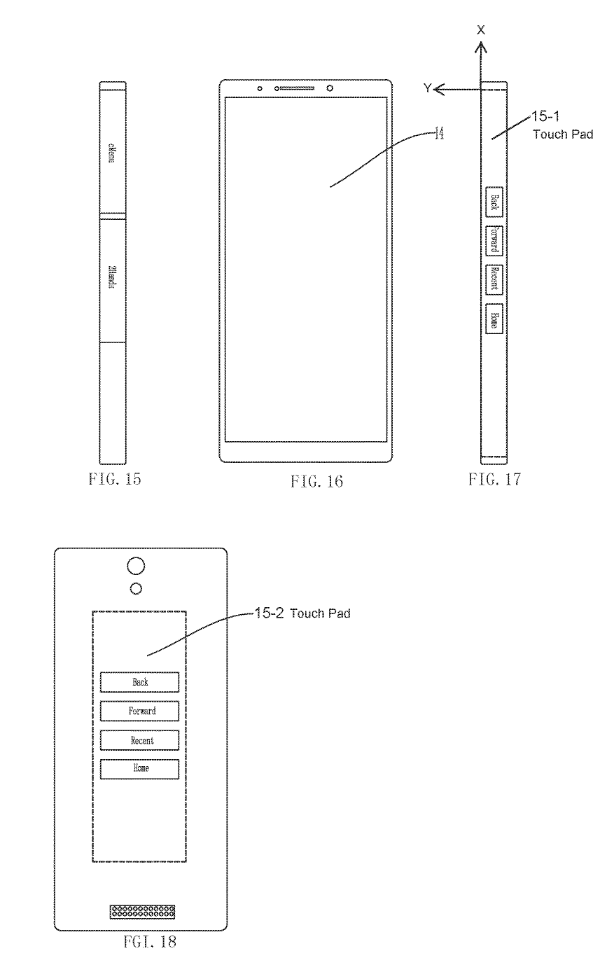

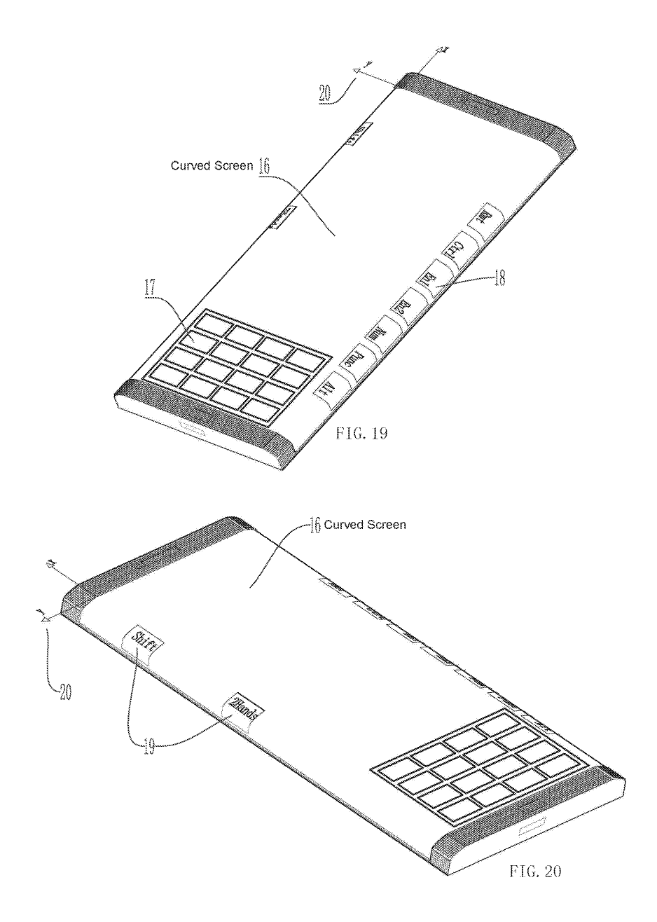

FIG. 19 is a curved screen mobile phone. A curved screen 16 is a multi-touch screen display. Two side-keys: Shift and 2 Hands 19 are configured at the left side of the curved screen 16 and seven side-keys: Rmt, Ctrl, En1, En2, Num, Punc and Alt 18 are configured at the right side of the curved screen 16. And positions of Rmt, Ctrl, En1, En2, Num, Punc and Alt at the right side of the curved screen 16 are initially configured to be undetermined, and positions of Shift and 2 Hands at the left side of the curved screen 16 are initially configured to be undetermined too.

The mobile phone and the side-keys thereof is held and operated by a left hand of a user. By default, left index, middle, ring and pinky fingers is configured to operate respectively and correspond one to one to En1, En2, Num and Punc. Ctrl and Rmt are operated by the left index finger too. Specifically, the left index finger first releases En1 and moves upwards, and then depresses/touches Ctrl or Rmt. And Alt is operated by the left pinky finger too. Specifically, the left pinky finger first releases Punc and moves downwards, and then depresses/touches Alt. Shift is operated by a left thumb and 2 Hands is depressed/touched naturally by a raised portion of a base of the left thumb.

If the user is left-handed, swap two side-key configurations 18 and 19 at the left and right sides of the curved screen 16.

A 4*4 touch keyboard 17 is configured on the curved screen 16 and operated by a right hand. But if the user is left-handed, the touch keyboard 17 is operated by a left hand. A layout of the keyboard 17 will dynamically change in responding to a single input operation of a side-key. FIG. 21-30 are layouts of the keyboard 17 corresponding to different side-keys or side-key combinations.

When the left hand holds the mobile phone, the left thumb holds the curved screen 16 at the left side, the other four left fingers evenly hold the curved screen 16 at the right side. The raised portion of a base of the left thumb naturally depresses/touches the curved screen at the left side. A control unit will detect that there are two touch points at the left side and four touch points at the right side of the curved screen 16 (On the contrary, If the control unit detects that there are two touch points at the right side and four touch points at the left side of the curved screen 16, it suggests that a right hand holds the mobile phone, the user is left-handed, swap the two side-key configurations 18 and 19).

A touch point is represented by a coordinate pair (x, y).

According to a rectangular coordinate system 20, the control unit sorts the four touch points at the right by x value form largest to smallest and gets a touch point sequence, and then sequentially stores touch points in the touch point sequence as pIndex(x, y), pMiddle(x, y), pRing(x, y) and pPinky(x, y). If a perpendicular distance from the top edge of the curved screen 16 to pIndex is greater than (pIndex.x-pMiddle.x)*2.5, and a perpendicular distance from the bottom edge of the curved screen 16 to pPinky is greater than (pRing.x-pPinky.x)*1.5, and moreover (pIndex.x-pMiddle.x)≈(pMiddle.x-pRing.x) and (pMiddle.x-pRing.x) (pRing.x-pPinky.x), it suggests that the left hand holds the mobile phone properly.

And subsequently, the control unit matches pIndex, pMiddle, pRing and pPinky one to one with the left index, middle, ring and pinky fingers, and further configures central positions of En1, En2, Num and Punc to be pIndex, pMiddle, pRing and pPinky respectively. In addition, the control unit also configures central positions of Ctrl, Rmt and Alt to be ((pIndex.x+(pIndex.x-pMiddle.x)), pIndex.y), ((pIndex.x+(pIndex.x-pMiddle.x)*2), pIndex.y), ((pPinky.x−(pRing.x-pPinky.y) respectively.

And meanwhile, the control unit assigns several variables respectively corresponding to the left index, middle, ring and pinky fingers with “depressing”, and configures En1 to be “depressed” but Shift, En2, Num and Punc to be “released” by default even if the left thumb and all of the left index, middle, ring and pinky fingers are depressing or touching Shift, En1, En2, Num and Punc respectively through holding the mobile phone at the left and right sides. Rmt, Ctrl and Alt themselves are released at this time and are of course configured to be “released”. 2 Hands is always depressed or touched during the mobile phone and the side-keys thereof are held.

Besides, the control unit sorts the two touch points at the left side of the curved screen 16 by x value form largest to smallest and gets a touch point sequence, and then sequentially matches touch points in the touch point sequence with the left thumb and the base of the left thumb, and further sequentially configures the touch points in the touch point sequence to be central positions of Shift and 2 Hands.

After that, the control unit enables all of the side-keys to be ready for operating.

Except for Rmt, Ctrl and Alt, each of Shift, En1, En2, Num and Punc is operated according to the method 1 described in the brief summary.

After enabling all of the side-keys, the control unit circularly scans and detects touches and changes thereof at the right side of the curved screen 16 and processes as the following.

At any time, if detecting that there are only 3 touch points remained at the right side of the curved screen 16 (About how to process in responding to the other cases where touch points remained at the right side of the curved screen 16 is not equal to 3, please refer to the counterpart description in Part A), it suggests that a left finger holding and depressing/touching at the right side of the curved screen 16 is released, and a side-key at the right side, which corresponds to the left finger, is released. The control unit sorts the 3 touch points by x value from largest to smallest and gets a touch point sequence, and then sequentially stores touch points in the touch point sequence as p31(x, y), p32(x, y) and p33(x, y), and then proceeds as follows:

(A) If p31.x=pMiddle.x or p31.x<=pMiddle.x+(pIndex.x-pMiddle.x)*0.5, it suggests that the left index finger is released, a touch point of the left index finger at the right side of the curved screen 16 is lost, thus the control unit assigns a variable corresponding to the left index finger with “released”.

Subsequently, at any time, if detecting that there are four touch points at the right side of the curved screen 16 again, it suggests that the left index finger holds and depresses/touches the curved screen 16 at the right again, and the touch point of the left index finger at the right side of the curved screen 16 is regained. Thus, the control unit assigns the variable corresponding to the left index finger with “depressing”, and meanwhile sorts the four touch points by x value from largest to smallest and gets a touch point sequence, and then sequentially stores touch points in the touch point sequence as p41(x, y), p42(x, y), p43(x, y) and p44(x, y), and then proceed as follows:

(1) If pMiddle.x+(pIndex.x-pMiddle.x)*0.5<p41.x<=pMiddle.x+(pIndex.x-pMiddle.x) *1.5, it suggests that the left index finger holds and depresses/touches the curved screen 16 at En1, thus the control unit configures En1 to be “depressed” and the other side-keys except Alt to be “released”, in other words, after a single input operation of En1 is identified, a possible “depressed” side-key or side-key combination may be En1 or Alt +En1(if Alt has been configured to be “depressed” before). And then the control unit updates pIndex with p41; or

(2) If pMiddle.x+(pIndex.x-pMiddle.x)*1.5<p41.x<=pMiddle.x+(pIndex.x-pMiddle.x) *2.5, it suggests that the left index finger holds and depresses/touches the curved screen 16 at Ctrl, thus the control unit configures Ctrl and En1 to be “depressed” and the other side-keys except Alt to be “released”, in other words, after a single input operation of Ctrl is identified, a possible “depressed” side-key or side-key combination may be Ctrl +En1 or Ctrl +Alt+En1(if Alt has been configured to be “depressed” before); or

(3) If pMiddle.x+(pIndex.x-pMiddle.x)*2.5<p41.x, it suggests that the left index finger holds and depresses/touches the curved screen 16 at Rmt, thus the control unit configures Rmt to be “depressed” and the other side-keys to be “released”.

(B) If p33.x=pRing.x or p33.x>pRing.x−(pRing.x-pPinky.x)*0.5, it suggests that the left pinky finger is released, a touch point of the left pinky finger at the right side of the curved screen 16 is lost, thus the control unit assigns a variable corresponding to the left pinky finger with “released”.

Subsequently, at any time, if detecting that there are four touch points at the right side of the curved screen 16 again, it suggests that the left pinky finger holds and depresses/touches the curved screen 16 at the right side again, and the touch point of the left pinky finger at the right side of the curved screen 16 is regained. Thus, the control unit assigns the variable corresponding to the left pinky finger with “depressing”, and meanwhile sorts the four touch points by x value from largest to smallest and gets a touch point sequence, and then sequentially stores touch points in the touch point sequence as p41(x, y), p42(x, y), p43(x, y) and p44(x, y), and then proceed as follows:

(1) If pRing.x−(pRing.x-pPinky.x)*1.5<p44.x<=pRing.x−(pRing.x-pPinky.x)*0.5, it suggests that the left pinky finger holds and depresses/touches the curved screen 16 at Punc, thus the control unit configures Punc to be “depressed” and the other side-keys except Ctrl to be “released”, in other words, after a single input operation of Punc is identified, a possible “depressed” side-key or side-key combination may be Punc or Ctrl+Punc (if Ctrl has been configured to be “depressed” before). And then the control unit updates pPinky with p44; or

(2) If p44.x<=pRing.x−(pRing.x-pPinky.x)*1.5, it suggests that the left pinky finger holds and depresses/touches the curved screen 16 at Alt, thus the control unit configures Alt and Punc to be “depressed” and the other side-keys except Ctrl to be “released”, in other words, after a single input operation of Alt is identified, a possible “depressed” side-key or side-key combination may be Alt+Punc or Ctrl+Alt+Punc (if Ctrl has been configured to be “depressed” before).

(C) If p32.x=pMiddle.x or pMiddle.x−(pMiddle.x-pRing.x)*0.5<p32.x<=pMiddle.x+(pIndex.x-pMiddle.x)*0.5, this suggests that the left ring finger is released, and a touch point of the left ring finger at the right side of the curved screen 16 is lost, thus the control unit assigns a variable corresponding to the left ring finger with “released”.

Subsequently, at any time, if detecting that there are four touch points at the right side of the curved screen 16 again, it suggests that the left ring finger holds and depresses/touches the curved screen 16 again, and the touch point of the left ring finger at the right side of the curved screen 16 is regained. Thus, the control unit assigns the variable corresponding to the left ring finger with “depressing”, and meanwhile sorts the four touch points by x value from largest to smallest and gets a touch point sequence, and then stores touch points in the touch point sequence as p41(x, y), p42(x, y), p43(x, y) and p44(x, y).

In addition, the control unit configures Num to be “depressed” and the other side-keys except Ctrl and Alt to be “released”, in other words, after a single input operation of Num is identified, a possible “depressed” side-key or side-key combination may be Num, Ctrl+Num, Alt+Num or Ctrl+Alt+Num (if Ctrl and/or Alt has/have been configured to be “depressed” before). And then the control unit updates pRing with p43.

(D) If p32.x=pRing.x or pRing.x−(pRing.x-pPinky.x)*0.5<p32.x<=pRing.x+(pMiddle.x-pRing.x)*0.5, this suggests that the left middle finger is released, a touch point of the left middle finger at the right side of the curved screen 16 is lost, thus the control unit assigns a variable corresponding to the left middle finger with “released”.

Subsequently, at any time, if detecting that there are four touch points at the right side of the curved screen 16 again, it suggests that the left middle finger holds and depresses/touches the curved screen 16 again, and the touch point of the left middle finger at the right side of the curved screen 16 is regained. Thus, the control unit assigns the variable corresponding to the left middle finger with “depressing”, and meanwhile sorts the four touch points by x value from largest to smallest and gets a touch point sequence and then sequentially stores touch points in the touch point sequence as p41(x, y), p42(x, y), p43(x, y) and p44(x, y).

In addition, the control unit configures En2 to be “depressed” and the other side-keys except Ctrl and Alt to be “released”, in other words, after a single input operation of En2 is identified, a possible “depressed” side-key or side-key combination may be En2, Ctrl+En2, Alt+En2 or Ctrl+Alt+En2 (if Ctrl and/or Alt has/have been configured to be “depressed” before). And then the control unit updates pMiddle with p42.

With regard to Shift configured at the left side of the curved screen 16, when first detecting losing of a touch point corresponding to Shift and then detecting regaining of the point at the left side of the curved screen 16, the control unit identifies a single input operation of Shift, and reverses an operating configuration of Shift from being “released” to being “depressed” or from being “depressed” to being “released”.

Subsequently, at any time when all of the left index, middle, ring and pinky fingers are released and leave the curved screen 16, the control unit will detect that there are not any touch points at the right side of the curved screen 16, i.e., all of the touch points at the right side of the curved screen 16 are lost. No one know at what positions the left index, middle, ring and pinky fingers will hold and depress/touch the right side of the curved screen 16 next time. So, the control unit configures the positions of Rmt, Ctrl, En1, En2, Num, Punc and Alt as well as the positions of Shift, 2 Hands to be undetermined again, and meanwhile disables all of the side-keys, and then waits for two touch points at the left side and four touch points at the right side of the curved screen 16 to be detected again at the same time.

In addition, at any time when the control unit detects that there are not any touch points at the left side of the curved screen 16, i.e., all of touch points at the left side of the curved screen 16 are lost. It suggests that the left hand holds the mobile phone no longer. The control unit configures the positions of Rmt, Ctrl, En1, En2, Num, Punc and Alt as well as the positions of Shift and 2 Hands to be undetermined again, and meanwhile disables all of the side-keys, and then waits for two touch points at the left side and four touch points at the right side of the curved screen 16 to be detected again at the same time.

When the left fingers holding the mobile phone and operating the side-keys intentionally or subconsciously adjust holding positions because of fatigue, discomfort and the other reason, touch points at the left and right sides of the curved screen 16 will change following the adjusting. In order to avoid identifying this kind of changes as input operations of the side-keys as far as possible, the control unit can process as follows: (a) When detecting that a touch point corresponding to 2 Hands is lost, the control unit disables all of the side-keys; (b) Avoid simultaneously operating two or more side-keys. So, when detecting that there are less than five touch points remained at the left and right sides of the curved screen 16, i.e., touch points lost at the left and right sides of the curved screen 16 is more than one, the control unit disables all of the side-keys; (c) Avoid simultaneously operating two or more side-keys configured at the right side of the curved screen 16. So, when detecting that there are less than three touch points remained at the right side of the curved screen 16, i.e., touch points lost at the right side of the curved screen 16 is more than one, the control unit disables all of the side-keys. After disabling all of the side-keys, the control unit configures the positions of all of the side-keys to be undetermined again, and then waits for two touch points at the left side and four touch points at the right side of the curved screen 16 to be detected again at the same time.

The other aspects not described in this part are the same as or similar to the counterpart description in Part A.

Part I.

If the curved screen 16 as shown in FIG. 19 is a 3D multi-touch screen display, a touch point is represented by a coordinate triple (x, y, p), wherein p is a pressure applied at the touch point by a finger on the curved screen 16.

It is assumed that each of Shift, En1, En2, Num and Punc is operated according to the method 2 described in the brief summary.

It is assumed that only one side-key can be operated at any time.

Steps before enabling all of the side-keys are the same as or similar to the counterpart description of Part H.

After enabling all of the side-keys, the control unit circularly scans and detects touches and changes thereof at right side of the curved screen 16, and

(A) At any time, if still or again detecting that there are four touch points at the right side of the curved screen 16, the control unit sorts the four touch points by x value from largest to smallest and gets a touch point sequence, and then sequentially stores touch points in the touch point sequence as p41, p42, p43 and p44, and

(a) If a variable corresponding to the left index finger has been assigned with “released”, and

(1) If pMiddle.x+(pIndex.x-pMiddle.x)*0.5<p41.x<=pMiddle.x+(pIndex.x-pMiddle.x) *1.5, it suggests that the left index finger holds and depresses/touches the curved screen 16 at En1 after it is released, thus the control unit configures En1 to be “depressed” and the other side-keys except Alt to be “released”. And meanwhile, the control unit assigns the variable corresponding to the left index finger with “depressing”. And then updates pIndex with p41; or

(2) If pMiddle.x+(pIndex.x-pMiddle.x)*1.5<p41.x<=pMiddle.x+(pIndex.x-pMiddle.x) *2.5, it suggests that the left index finger holds and depresses/touches the curved screen 16 at Ctrl after it is released, thus the control unit configures Ctrl and En1 to be “depressed” and the other side-keys except Alt to be “released”. And meanwhile, the control unit assigns the variable corresponding to the left index finger with “depressing”; or

(3) If pMiddle.x+(pIndex.x-pMiddle.x)*2.5<p41.x, it suggests that the left index finger holds and depresses/touches the curved screen 16 at Rmt after it is released, thus the control unit configures Rmt to be “depressed” and the other side-keys to be “released”. And meanwhile, the control unit assigns the variable corresponding to the left index finger with “depressing”.

(b) If p41.p>thresholdIndex, or p41.p>thresholdIndex for a given time, and moreover p41.x=pIndex.x or pIndex.x−(pIndex.x-pMiddle.x)*0.5<p41.x<=pIndex.x+(pIndex.x-pMiddle.x) *0.5, it suggests that the left index finger depresses/touches En1 hard, the control unit configures En1 to be “depressed” and the other side-keys except Alt to be “released”. And then updates pIndex with p41.

(c) If p42.p>thresholdMiddle, or p42.p>thresholdMiddle for a given time, it suggests that the left middle finger depresses/touches En2 hard, the control unit configures En2 to be “depressed” and the other side-keys except Ctrl and Alt to be “released”. And then updates pMiddle with p42.

(d) If p43.p>thresholdRing, or p43.p>thresholdRing for a given time, it suggests that the left ring finger depresses/touches Num hard, the control unit configures Num to be “depressed” and the other side-keys except Ctrl and Alt to be “released”. And then updates pRing with p43.

(e) If p44.p>thresholdPinky, or p44.p>thresholdPinky for a given time, and moreover p44.x=pPinky.x or pPinky.x−(pRing.x-pPinky.x)*0.5<p44.x<=pPinky.x+(pRing.x-pPinky.x) *0.5, it suggests that the left pinky finger depresses/touches Punc hard, the control unit configures Punc to be “depressed” and the other side-keys except Ctrl to be “released”. And then updates pPinky with p44.

(f) If a variable corresponding to the left pinky finger has been assigned with “released”, and

(1) If pRing.x−(pRing.x-pPinky.x)*1.5<p44.x<=pRing.x−(pRing.x-pPinky.x)*0.5, it suggests that the left pinky finger holds and depresses/touches the curved screen 16 at Punc after it is released, thus the control unit configures Punc to be “depressed” and the other side-keys except Ctrl to be “released”. And meanwhile, the control unit assigns the variable corresponding to the left pinky finger with “depressing”. And then updates pPinky with p44; or

(2) If p44.x<=pRing.x−(pRing.x-pPinky.x)*1.5, it suggests that the left pinky finger holds and depresses/touches the curved screen 16 at Alt after it is released, thus the control unit configures Alt and Punc to be “depressed” and the other side-keys except Ctrl to be “released”. And meanwhile, the control unit assigns the variable corresponding to the left pinky finger with “depressing”.

(B) At any time, if detecting that there are only 3 touch points remained at the right side of the curved screen 16, it suggests that a left finger holding the curved screen 16 at the right side is released, the control unit sorts the 3 touch points by x value from largest to smallest and gets a touch points, and then sequentially stores touch points in the touch point sequence as p31(x, y), p32(x, y) and p33(x, y), and then proceeds as follows:

(a) If p31.x=pMiddle.x or p31.x<=pMiddle.x+(pIndex.x-pMiddle.x)*0.5, it suggests that the left index finger is released, a touch point of the left index finger at the right side of the curved screen 16 is lost, thus the control unit assigns the variable corresponding to the left index finger with “released”; or

(b) If p33.x=pRing.x or p33.x>pRing.x−(pRing.x-pPinky.x)*0.5, it suggests that the left pinky finger is released, a touch point of the left pinky finger at the right side of the curved screen 16 is lost, thus the control unit assigns the variable corresponding to the left pinky finger with “released”.

And meanwhile, the control unit circularly scans and detects touches and changes thereof at the left side of the curved screen 16, and process as follows:

Name an initial touch point and a current touch point of the left thumb at the left side of the curved screen 16 respectively as pThumb and pShift. At any time, if detecting that pShift.p>thresholdThumb, or pShift.p>thresholdThumb for a given time, and moreover pShift.x=pThumb.x or pThumb.x−15 cm<pShift.x<=pThumb.x+15 cm, it suggests that the left thumb depresses/touches Shift hard, the control unit reverses an operating configuration of Shift from being “released” to being “depressed” or from being “depressed” to being “released”.

The thresholdThumb, thresholdlndex, thresholdMiddle, thresholdRing and thresholdPinky are predefined threshold values, and they can also be replaced with new values determined by means of testing and verifying when the user uses the mobile phone for the first time.

The other details not described in this part are the same as or similar to the counter description of Part B and H.

Part J.

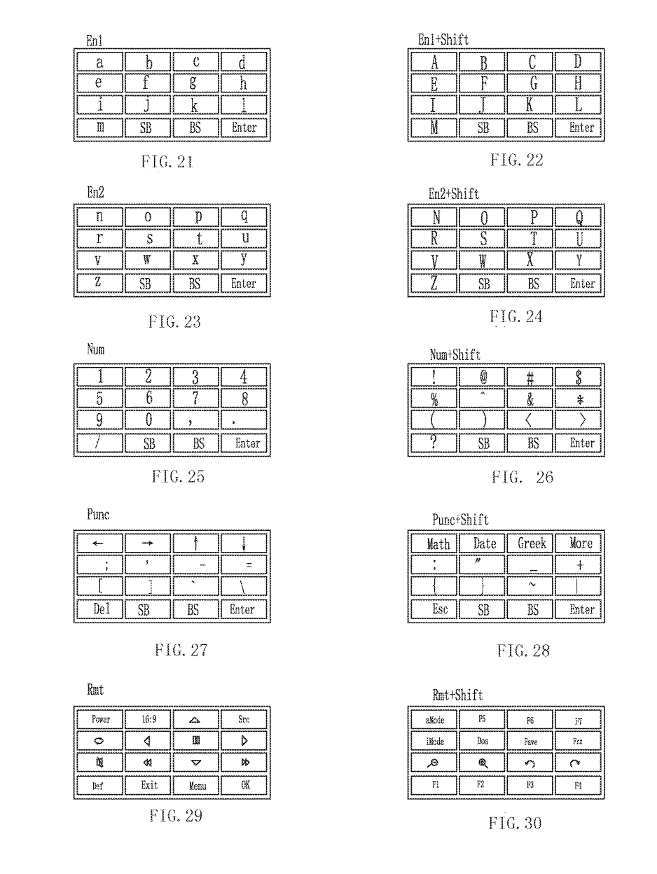

FIG. 31 is a slide mobile phone with a 3*5 physical keyboard and four side-keys: En1, En2, Num and Punc. Several keyboard layouts of the physical keyboard, which respectively correspond to a portion of side-keys or side-key combinations, are shown in FIG. 33-38.

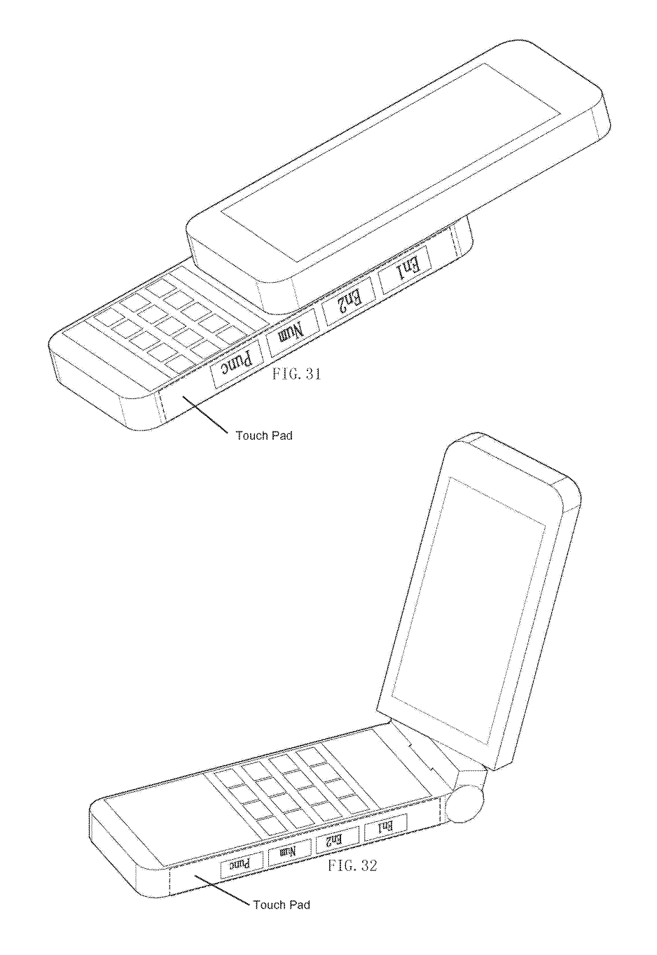

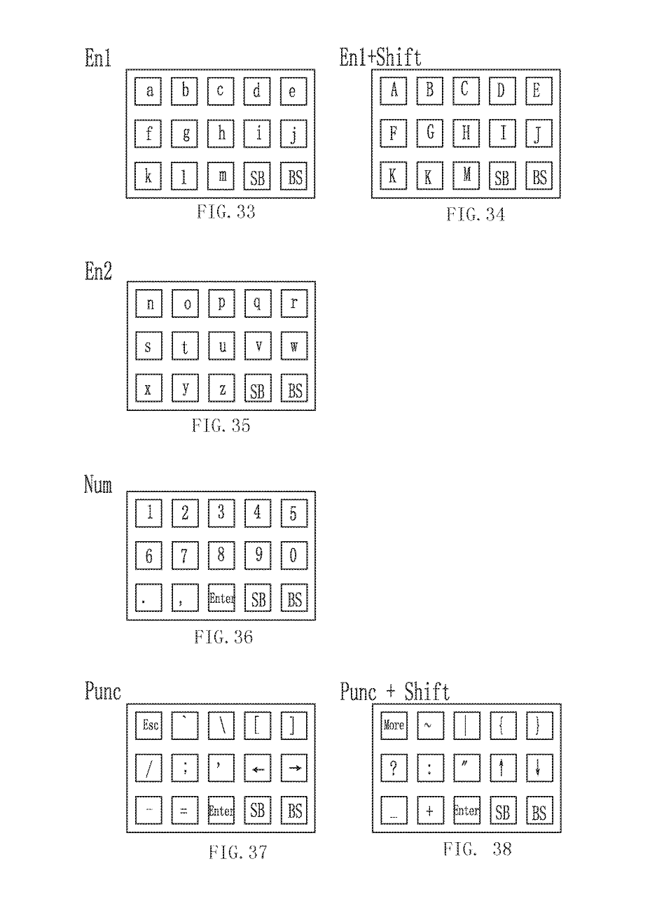

FIG. 32 is a flip mobile phone with a 4*4 physical keyboard and four side-keys: En1, En2, Num and Punc. Several keyboard layouts of the physical keyboard, which correspond to respective side-keys or side-key combinations, are shown in FIG. 21-28.

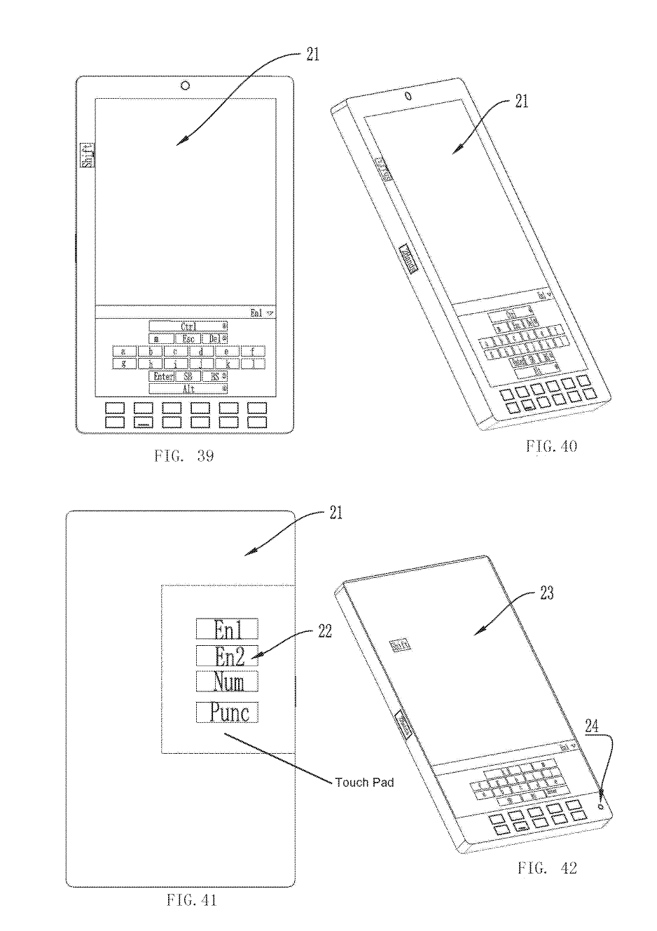

FIG. 39 is a tablet computer 21 with a 2*6 physical keyboard at the bottom, Shift at a frame of the top left corner, 2 Hands at the left side, and a multi-touch pad 22 at the left of the back. A keyboard dynamically-mapping zone is configured on a touch screen display on the front surface. Several keyboard layouts for displaying in the keyboard dynamically-mapping zone are shown in FIGS. 43-48. A corresponding side-key or side-key combination are respectively labelled at the top left corner of the several keyboard layouts. A left hand holds the tablet 21 at the left with a left thumb holding Shift and a raised portion of a base of the left thumb naturally depressing/touching 2 Hands, and meanwhile with left index, middle, ring and pinky fingers holding the touch pad 22, in which four touch points are generated and served as side-keys: En1, En2, Num and Punc.

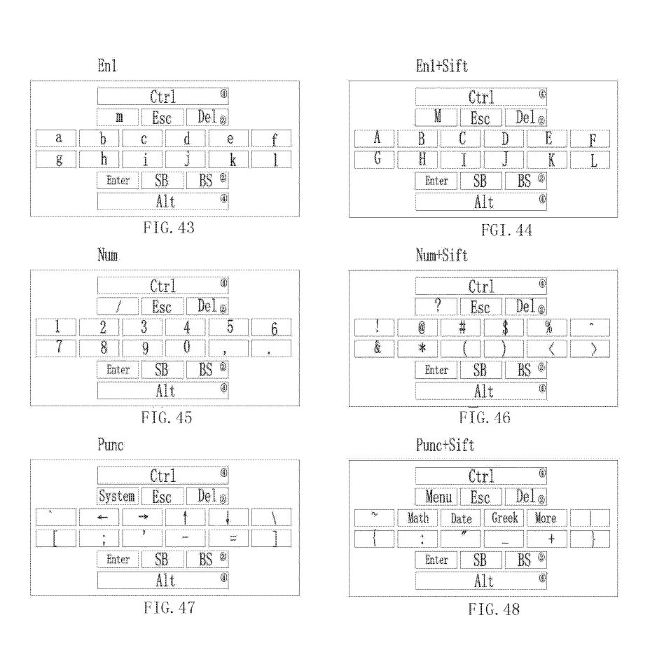

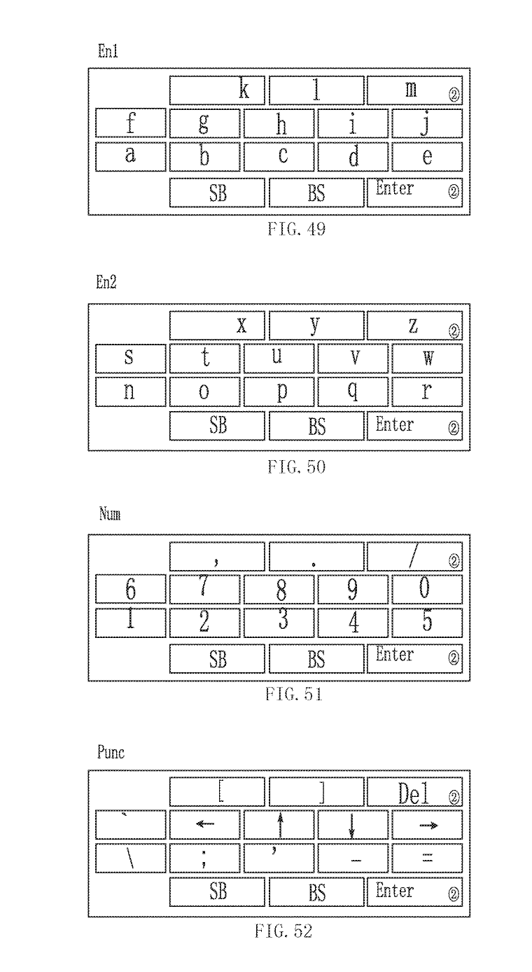

FIG. 42 is a frameless tablet computer 23 with a 2*5 physical keyboard at the bottom and a keyboard dynamically-mapping zone on a touch screen display on the front surface. Except that Shift is configured on the touch screen display, a configuration for the other side-keys is the same as that of the tablet 21. A PCT patent application with a publication Ser. No. WO/2014/101519 discloses a frameless tablet computer with a grip holding-point which can be served as Shift. Several keyboard layouts for displaying on the keyboard dynamically-mapping zone are shown in FIG. 49-52. A camera 24 is located at the bottom right corner.

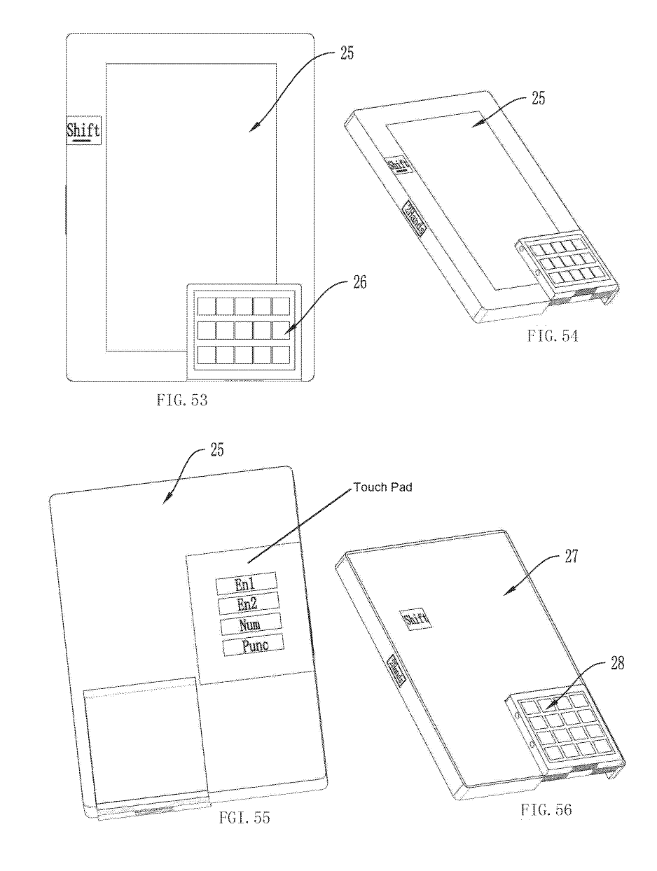

FIG. 53 is a tablet computer 25 with a 3*5 flip physical keyboard 26. The keyboard 26 is coupled to the tablet 25 by connecting ribbons. The keyboard 26 is flipped backwards and folded into the back of the tablet 25 when not in use. If the keyboard 26 is transparent, a touch screen display of the tablet 25 can dynamically display a keyboard layout underneath the keyboard 26. A portion of keyboard layouts of the keyboard 26 are shown in FIG. 33-38. And a side-key configuration of the tablet 25 is the same as that of the tablet 21.

FIG. 56 is a frameless tablet computer 27 with a 4*4 flip physical keyboard 28. A side-key configuration of the tablet 27 is the same as that of the tablet 23. A plurality of keyboard layouts for the tablet 27 are shown in FIG. 21-28.

Part K.

The above mentioned side-keys for a keyboard can also be used for the other purposes when not in an edit mode or a shortcut mode, and they can also be used for the other purposes by repeating a same operation for two or more times quickly.

As shown in FIG. 15-16, a side-key does not have to be used as a side-key for a keyboard, and can be used independently.

This invention is also applicable to the other handheld digital devices similar to a mobile phone or a tablet.

If a handheld digital device is too large, when it is held by a hand, either or both of index and pinky fingers of the hand may be unable to reach a multi-touch pad configured at a side of the device. In this case, the multi-touch pad can be extended towards the back of the handheld digital device in order for the index and pinky fingers to reach it.

If configuring a multi-touch pad at the left side or the right of the back side of a handheld digital device, the device is applicable to a left handed user.

Part L.

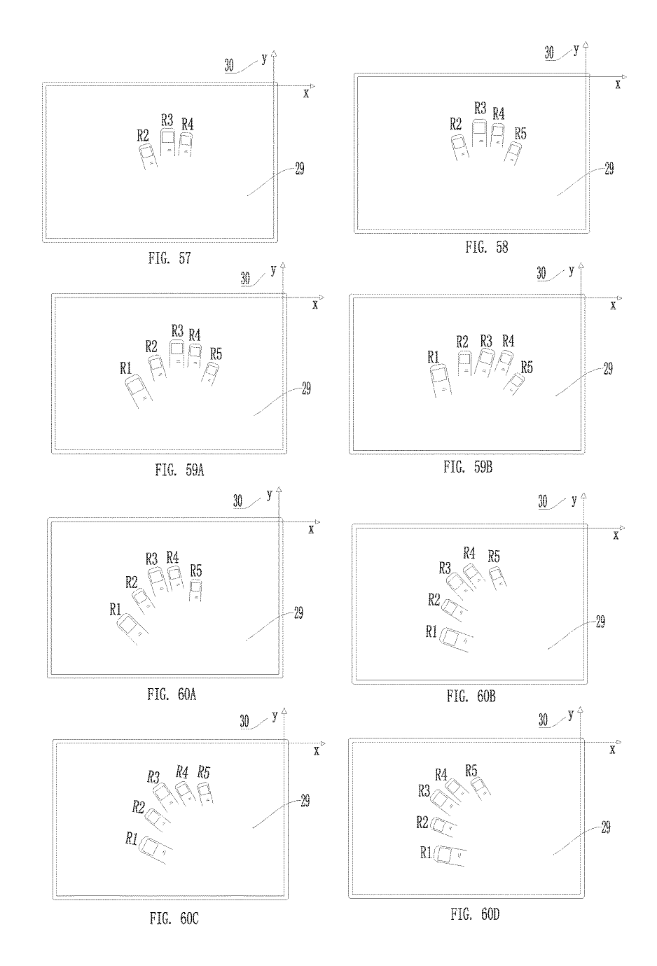

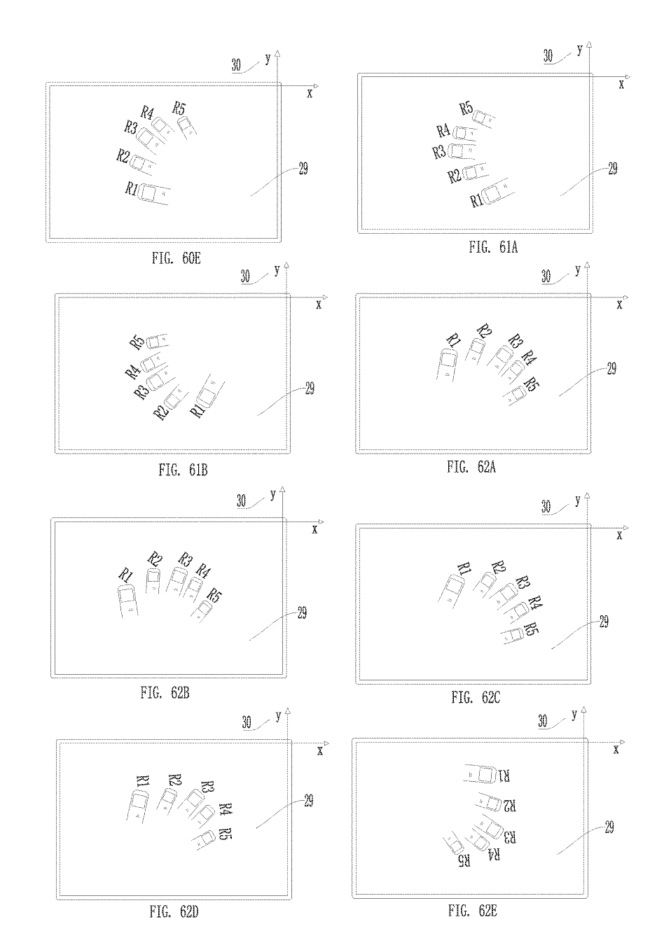

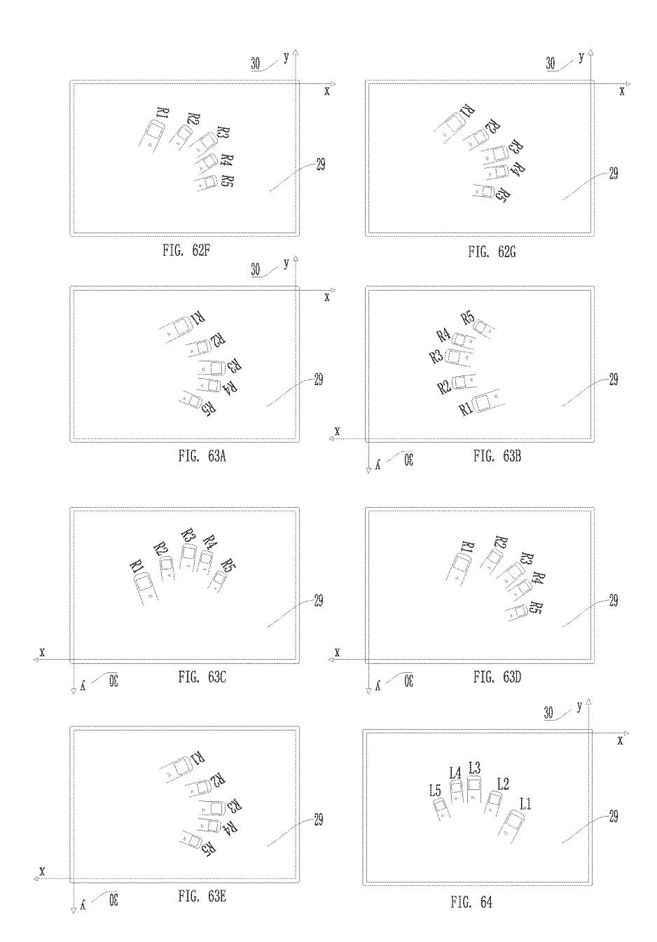

FIG. 57- FIG. 76 show a touch pad mouse. A plurality of mouse buttons are configured in a multi-touch pad 29. And positions of the plurality of mouse buttons are initially configured to be undetermined or pending. One or more of fingers touching and resting on the touch pad 29 can individually or simultaneously slide, pinch in/out, or rotate, etc. The touch pad 29 uses a rectangular coordinate system 30.

FIG. 57-FIG. 59A illustrate three embodiments with 3, 4 and 5 mouse buttons operated respectively by 3, 4 and 5 fingers of a right hand. In FIG. 57- FIG. 63E, R1, R2, R3, R4 and R5 respectively represent right thumb, index, middle, ring and pinky fingers. And FIG. 64 is an embodiment with five mouse buttons by five fingers of a left hand, wherein L1, L2, L3, L4 and L5 respectively represent left thumb, index, middle, ring and pinky fingers.

Sliding all of fingers touching and resting on the pad 29 is used for moving a mouse cursor, and sliding a single index finger when the other fingers stay on the pad 29 is used for scrolling.

Because all or most of fingers of a hand rest on the pad 29, and moreover a wrist of the hand does not have to flex, the touch pad mouse will greatly relieve fatigue of the fingers and wrist.

The following describes about how to implement a mouse with five mouse buttons operated by a right hand on the multi-touch pad 29 as shown in FIG. 59A-FIG. 63E.

As shown in FIG. 59A-FIG. 63E, five mouse buttons are configured on the pad 29, five right fingers: R1, R2, R3, R4 and R5 respectively correspond to and operate the five mouse buttons: the fourth, left, middle, right and fifth mouse buttons.

FIG. 59A-FIG. 63E show only a portion of possible touch patterns of a right hand on the pad 29. When five fingers of the right hand touch the pad 29, they will generate five touch points on the pad 29 to form a specific touch pattern. A touch point is represented by a coordinate pair (x, y) if the pad 29 is a 2D multi-touch sensitive surface or a coordinate triple (x, y, p) if the pad 29 is a 3D multi-touch sensitive surface, wherein p represents a pressure applied at the touch point by a finger.

According to a rectangular coordinate system 30, a control unit sorts the five touch points by x value from smallest to largest and get a first touch point sequence: pX1, pX2, pX3, pX4 and pX5, and then sorts them by y value from largest to smallest and get a second touch point sequence: pY1, pY2, pY3, pY4 and pY5.

For a touch pattern as shown in FIG. 59A, it is certain that pY1.y≠pY2.y and pY1=pX3, and pX1, pX2, pX3, pX4 and pX5 respectively correspond to R1, R2, R3, R4 and R5. And herein, pY1=pX3 means that pY1.x=pX3.x and pY1.y=pX3.y, i.e., they are the same touch point.

For a touch pattern as shown in FIG. 59B, it is certain that pY1.y=pY2.y=pY3.y≠pY4.y and pX2.y=pX3.y=pX4.y, and pX1, pX2, pX3, pX4 and pX5 respectively correspond to R1, R2, R3, R4 and R5.

For a touch pattern as shown in FIG. 60A, it is certain that pY1.y=pY2.y≠pY3.y and pX3.y=pX4.y, and pY5, pX2, pX3, pX4 and pX5 respectively correspond to R1, R2, R3, R4 and R5.

For a touch pattern as shown in FIG. 60B, it is certain that pY1.y≠pY2.y and pY1=pX4, and pY5, pY4, pX3, pX4 and pX5 respectively correspond to R1, R2, R3, R4 and R5.

For a touch pattern as shown in FIG. 60C, it is certain that pY1.y=pY2.y=pY3.y≠pY4.y and pX3.y=pX4.y=pX5.y, and pY5, pY4, pX3, pX4 and pX5 respectively correspond to R1, R2, R3, R4 and R5.

For a touch pattern as shown in FIG. 60D, it is certain that pY1.y=pY2.y≠pY3.y and pX4.y=pX5.y, and pY5, pY4, pY3, pX4 and pX5 respectively correspond to R1, R2, R3, R4 and R5.

For a touch pattern as shown in FIG. 60E, it is certain that pX1.x≠pX2.x and pX1=pY4, and pY5, pY4, pY3, pX4 and pX5 respectively correspond to R1, R2, R3, R4 and R5.

For a touch pattern as shown in FIG. 61A, it is certain that pX1.x≠pX2.x and pX1=pY3, and pY5, pY4, pY3, pY2 and pY1 respectively correspond to R1, R2, R3, R4 and R5.

For a touch pattern as shown in FIG. 61B, it is certain that pY5.y≠pY4.y and pY5=pX4, and pX5, pX4, pX3, pY2 and pY1 respectively correspond to R1, R2, R3, R4 and R5.

For a touch pattern as shown in FIG. 62A, it is certain that pY1.y≠pY2.y and pY1=pX2, and pX1, pX2, pX3, pY4 and pY5 respectively correspond to R1, R2, R3, R4 and R5.

For a touch pattern as shown in FIG. 62B, it is certain that pY1.y=pY2.y≠pY3.y and pX2.y=pX3.y, and pX1, pX2, pX3, pX4 and pX5 respectively correspond to R1, R2, R3, R4 and R5.

For a touch pattern as shown in FIG. 62C, it is certain that pX5.x≠pX4.x and pX5=pY4, and pX1, pX2, pY3, pY4 and pY5 respectively correspond to R1, R2, R3, R4 and R5.

For a touch pattern as shown in FIG. 62D, it is certain that pX3.x≠pX4.x=pX5.x and pY4.x=pY5.x, and pX1, pX2, pX3, pY4 and pY5 respectively correspond to R1, R2, R3, R4 and R5.

For a touch pattern as shown in FIG. 62E, it is certain that pY3.y≠pY4.y =pY5.y and pX1.y=pX2.y, and pY1, pY2, pY3, pX2 and pX1 respectively correspond to R1, R2, R3, R4 and R5.

For a touch pattern as shown in FIG. 62F, it is certain that pX2.x≠pX3.x=pX4.x=pX5.xand pY3.x=pY4.x=pY5.x, and pX1, pY2, pY3, pY4 and pY5 respectively correspond to R1, R2, R3, R4 and R5.

For a touch pattern as shown in FIG. 62G, it is certain that pX3.x≠pX4.x=pX5.x and pY3.x=pY4.x, and pX1, pY2, pY3, pY4 and pY5 respectively correspond to R1, R2, R3, R4 and R5.

For a touch pattern as shown in FIG. 63A, it is certain that pX5.x≠pX4.x and pX5=pY3, and pY1, pY2, pY3, pY4 and pY5 respectively correspond to R1, R2, R3, R4 and R5.

For a touch pattern as shown in FIG. 63B, it is certain that pX5.x≠pX4.x and pX5=pY3, and pY1, pY2, pY3, pY4 and pY5 respectively correspond to R1, R2, R3, R4 and R5.

For a touch pattern as shown in FIG. 63C, it is certain that pY5.y≠pY4.y and pY5=pX3, and pX5, pX4, pX3, pX2 and pX1 respectively correspond to R1, R2, R3, R4 and R5.

For a touch pattern as shown in FIG. 63D, it is certain that pY5.y≠pY4.y and pY5=pX4, and pX5, pX4, pX3, pY2 and pY1 respectively correspond to R1, R2, R3, R4 and R5.

For a touch pattern as shown in FIG. 63E, it is certain that pX1.x≠pX2.x and pX1=pY3, and pY5, pY4, pY3, pY2 and pY1 respectively correspond to R1, R2, R3, R4 and R5.

As shown in FIG. 63B-FIG. 63E, the touch pad mouse are put upside down.

The touch pattern in FIG. 63A are not the same as that in FIG. 63B, but a set of relations: pX5.x≠pX4.x and pX5=pY3 between touch points in the first and second touch point sequences for the touch pattern in FIG. 63A, are the same as that for the touch pattern in FIG. 63B; and a touch point sequence: pY1, pY2, pY3, pY4 and pY5 corresponding one to one to R1, R2, R3, R4 and R5 for the touch pattern in FIG. 63A, is the same as that for the touch pattern in FIG. 63B. So are between the touch patterns in FIG. 63D and FIG. 61B, or in FIG. 63E and FIG. 61A.

By comparing coordinates between touch points in the first and second touch point sequences, a set of relations between the touch points will be found. And based on the set of relations and a touch pattern corresponding to the set of relations, for example, one of the touch patterns in FIG. 59A-FIG. 63E, a touch point sequence by compositing the touch points in the first and second touch point sequences, which sequentially corresponding to R1, R2, R3, R4 and R5, will be found.

In some touch patterns, two or more sets of relations between touch points in the first and second touch point sequences may be found. For example, for the touch pattern in FIG. 62C, a different set of relations: pY1.y≠pY2.y and pY1=pX2 may be found. Based on the different set of relations, a touch point sequence: pX1, pX2, pX3, pY4 and pY5 will be found, and although it is a little different from the above mentioned touch point sequence: pX1, pX2, pY3, pY4 and pY5 for the same touch pattern in FIG. 62C, in fact, like the sequence: pX1, pX2, pY3, pY4 and pY5, the sequence: pX1, pX2, pX3, pY4 and pY5 also correspond one to one to R1, R2, R3, R4 and R5.

A finite number of discrete standard touch patterns can be used to represent all possible touch patterns. For each standard touch pattern, a specific set of relations between touch points in the first and second touch point sequences are definite, and a specific touch point sequence gotten by compositing the touch points in the first and second touch point sequences is definite too. According to the above method, a table including connections between a set of relations and a touch point sequence for all of the standard touch patterns is established. In this way, based on a real-time touch pattern of five fingers of a right hand, once such a specific set of relations are determined, a specific touch point sequence is determined by looking up in the table.

The touch patterns as shown in FIG. 59A-FIG. 63E are generated by touching of a right hand stretching fingers naturally. If a right hand does not stretch fingers naturally when touching the pad 29, a set of proper and qualified relations between touch points in the first and second touch point sequences may not be found. In such a case, the control unit prompts a user by vibrating, sound, text, pictures, animation, video, etc. to stretch fingers naturally to re-touch the touch pad 29.

After finding a touch point sequence according to the above method, the control unit sequentially matches touch points in the touch point sequence to five right fingers: R1, R2, R3, R4 and R5. Subsequently, the control unit sequentially stores the touch points in the touch point sequence as pThumb, pIndex, pMiddle, pRing and pPinky, and respectively configures centers of the fourth, left, middle, right and fifth mouse buttons to be pThumb, pIndex, pMiddle, pRing and pPinky, and then further enables all of the five mouse buttons.

For example, after finding a touch point sequence: pX1, pX2, pX3, pX4 and pX5 based on a set of relations: pY1.y≠pY2.y and pY1=pX3, between touch points in the first and second touch point sequences, which corresponds to the touch pattern in FIG. 59A, the control unit respectively matches pX1, pX2, pX3, pX4 and pX5 to R1, R2, R3, R4 and R5, and stores pX1, pX2, pX3, pX4 and pX5 as pThumb, pIndex, pMiddle, pRing and pPinky, and so on.

A mouse button is operated according to either or both of the methods 1 and 2 described in the brief summary. When released or depressed/touched hard with a finger, a mouse button is configured to be “depressed”; and when touched again or touched/depressed naturally again by the finger, the mouse button is configured to be “released”.

For more details about how to operate a mouse button and how to identify a single input operation of a mouse button, please refer to the counterpart description of Part A, B, E and F.

After initial positions of the five mouse buttons are determined, following changing of one or more touch points of the five right fingers on the pad 29, positions of the five mouse buttons are updated as follows: (1) The control unit performs the updating based on a touch point sequence found according to the above described method; (2) The control unit performs the updating based on every minor changes of touch points of the five right fingers relative to pThumb, pIndex, pMiddle, pRing and pPinky respectively, wherein a minor change is much smaller than a distance between any two of pThumb, pIndex, pMiddle, pRing and pPinky; (3) If failing to perform the updating, the control unit disables all of the five mouse buttons and configures the positions thereof to be undetermined again, and then prompts the user by vibrating, sound, text, pictures, animation, video, and so on to re-touch and re-rest the five right fingers on the touch pad 29.

At any time when all of the five right fingers are released and leave the touch pad 29, that is, there are not any touch points detected on the touch pad 29, the control unit disables all of the mouse buttons and meanwhile configures the positions thereof to be undetermined again, and then waits for five touch points to be detected on the touch pad 29 again.

If the touch pad mouse does not need five mouse buttons, all of unused touch points of five touch points of the five right fingers can be ignored; alternatively, two or more touch points/fingers, individually or in combination, are used for a same mouse button. In this way, all of the five right fingers can still be allowed to comfortably touch and rest on the touch pad 29 at the same time. And such a method for dealing with a case where mouse buttons/key buttons are less than touch points of fingers is applicable to all parts of this specification.

In addition, the touch pad mouse can also be configured with six or seven mouse buttons. In a case where configured with seven mouse buttons, the sixth and seventh mouse buttons are configured respectively outside the fourth and fifth mouse buttons, and respectively operated by the thumb and the pinky finger first being released and then moving outside to touch the touch pad 29 again. Wherein positions of the sixth and seventh mouse buttons are respectively determined based on positions of the fourth and fifth mouse buttons according to widths of the thumb and the pinky finger

The other aspects not described in this part are the same as or similar to the counterpart description of Part A, B, E and F.

Besides the touch pad 29 is used as a mouse, when pinching in/out two or more of the five right fingers on the touch pad 29, a zoom out/in operation is performed; and when rotating one or more of the five right fingers on the touch pad 29, a rotation operation is performed, and so on.

When all of the five right fingers are dedicated to the touch pad mouse, a different quantity of right fingers can be used to perform the other functions, for example, a long touch operation with a single finger touching the touch pad 29 over a time threshold, a zoom operation with two fingers pinching in/out, a rotation operation with two fingers rotating, and so on.

The above method by proper modification is also applicable to the other cases where the touch pad mouse is operated by a left hand as shown in FIG. 64 or configured with three or four mouse buttons as shown in FIG. 57 or 58.

The touch pad mouse should be configured for usage of a left or right hand in advance or by setting on demand, for example, switching on/off a switch.

According to the above method, a tablet computer can easily be reformed to become a mouse.

Part M.

This part describes different methods for dynamically configuring positions of the mouse buttons as follows.

As shown in FIG. 65A-65D, when five fingers of a right hand touches and rests on the touch pad 29, five touch points of five touches 32-36 (illustrated by broken lines) are detected, wherein FIG. 65D shows a case where the touch pad mouse is put upside down.

Method 1.

(1) The control unit fits a virtual circle 37 based on the five touch points.

(2) The control unit calculates five slopes: k1, k2, k3, k4 and k5 of five straight lines from a center O of the virtual circle 37 respectively to the five touch points, wherein the center O can be replaced by any point semi-surrounded by the five touch points.

(3) The control unit divides k1-k5 into first and second slope groups based on relative positions of the five touch points respectively to the center O. Let's use P to represent a touch point, if P.x<O.x, a slope corresponding to P is put in the first slope group, otherwise in the second slope group.

For example, as shown in FIG. 65A, slopes corresponding to touch points of R1, R2 and R3 are put in the first slope group, and slopes corresponding to touch points of R4 and R5 are put in the second slope group.

When detecting that the touch pad mouse is put upside down (in this case, a device for detecting whether the touch pad mouse is put upside down is available), if P.x>O.x, a slope corresponding to P is put in the first slope group, otherwise in the second slope group.

For example, as shown in FIG. 65D, slopes corresponding to touch points of R1, R2 and R3 are put in the first slope group, and slopes corresponding to touch points of R4 and R5 are put in the second slope group.

(4) The control unit respectively sorts slopes in the first and second slope groups from largest to smallest and gets first and second slop sequence.

(5) The control unit sequentially puts the first and second slope sequences together and gets a new slope sequence.

(6) The control unit gets a touch point sequence based on the new slope sequence according to corresponding relationships between the five touch points and the five slopes.

(7) The control unit sequentially matches R1, R2, R3, R4 and R5 one to one to five touch points in the touch point sequence.

(8) The control unit sequentially stores the five touch points in the touch point sequence as pThumb, pIndex, pMiddle, pRing and pPinky.

(9) In this embodiment, the touch pad mouse are configured with five mouse buttons, the control unit configures central positions of the fourth, left, middle, right and fifth mouse buttons to be pThumb, pIndex, pMiddle, pRing and pPinky respectively and then enables all of the five mouse buttons.

Steps after enabling all of the five mouse buttons are the same as or similar to the counter description of Part L.

The other aspects not described in this part are the same as or similar to the counterpart description of Part L.

Method 2.

Steps (1)-(2) are the same as the steps (1)-(2) of the above method 1 in this part.

(3) The control unit divides k1-k5 into first, second, third and fourth slope groups based on relative positions of the five touch points respectively to the center O, which respectively correspond to the fourth, third, second and first quadrant BOC, COA, AOD and DOB.

For example, let's use P to represent a touch point, if P.x≧O.x and P.y≦O.y such as a touch point of R1 as shown in FIG. 65D, a slope corresponding to the touch point of R1 is put in the first slope group; if P.x<O.x and P.y≦O.y such as a touch point of R1 as shown in FIG. 65B, a slope corresponding to the touch point of R1 is put in the second slope group; if P.x<O.x and P.y>O.y such as a touch point of R2 as shown in FIG. 65A, a slope corresponding to the touch point of R2 is put in the third slope group; if P.x≧O.x and P.y>O.y such as a touch point of R3 as shown in FIG. 65C, a slope corresponding to the touch point of R3 is put in the fourth slope group.

(4) The control unit finds the first empty slope group from the four slope groups. For example, the first empty slope group is the first one in FIG. 65A, the first one in FIG. 65B, the second one in FIG. 65C and the third one in FIG. 65D respectively.

(5) The control unit regards the four slope groups as a closed loop chain where the last and first slope groups are deemed to be adjacent, and renumbers the four slope groups from the first empty slope group, and gets a new slope group sequence, wherein the first empty slope group is the first slope group in the new slope group sequence.

For example for FIG. 65C, after the renumbering, the first, second, third and fourth slope groups in the new slope group sequence are respectively the original second, third, fourth and first slope groups, wherein the first slope group in the new slope group sequence is an empty one which is the original second slope group.

(6) The control unit respectively sorts slopes in the first, second, third and fourth slope groups in the new slope group sequence from largest to smallest and gets first, second, third and fourth slope sequences.

(7) The control unit sequentially puts the first, second, third and fourth slope sequences together and gets a new slope sequence.

The other steps are the same as the steps (6)-(9) of the above method 1 in this part.

The other aspects not described in this method are the same as the counterpart description of the above method 1 in this part.

The above described methods are also applicable when the touch pad mouse is operated by five left fingers as shown in FIG. 66 by sequentially matching L5, L4, L3, L2 and L1 to the five touch points in the touch point sequence.

The above described methods by proper modification is also applicable when the touch pad mouse is configured with four or three mouse buttons operated only by four or three fingers of a hand as shown in FIG. 65E-65F.

The other respects not described in this part are the same as or similar to the counterpart description of Part L.

The method 2 is better than the method 1 in this part.

Part N.

Method 1:

A method is described as follows for dynamically configuring the positions of the five mouse buttons based on a polar coordinate system where a touch point is represented by a coordinate pair (r, (φ) or triple (r, φ, p), wherein φ is measured counterclockwise and limited to [0, 2π), and p is a pressure applied at the touch point by a finger.

(1) As shown in FIG. 67A and 67B, when five right fingers of a user touch the touch pad 29, the control unit will detect five touch points of five touches 32-36 generated by the five right fingers.

(2) The control unit finds two touch points of R1 and R5 by calculating and comparing linear distances between any two of the five touch points. A linear distance between the two touch points must be the longest.

(3) The control unit fits a virtual circle 37 based on the five touch points.

(4) The control unit creates a polar coordinate system as shown in FIG. 67A or 67B with a center O of the virtual circle 37 as a pole and a ray from the center O and through one of the two touch points as a polar axis OX. No matter whether the five touch points are represented in rectangular or polar coordinates, the control unit converts all of coordinates of the five touch points to polar coordinates based on the polar coordinate system and gets a copy of the five touch points, wherein touch points in the copy are represented by the polar coordinates.

(5) The control unit sorts the touch points in the copy from largest to smallest by φ value and gets a first touch point sequence, wherein the first touch point sequence is consistent with a natural order of R1, R2, R3, R4 and R5.

If a φ value of the second touch point in the first touch point sequence <π, the control unit gets a second touch point sequence based on the first touch point sequence according to corresponding relationships between the five touch points and the touch points in the copy, wherein touch points in the second touch point sequence are represented by original coordinates.

The control unit sequentially matches R1, R2, R3, R4 and R5 to five touch points in the second touch point sequence.

If the φ value of the second touch point in the first touch point sequence ≧π, it suggests that the polar axis OX is from the center O and through a touch point of R1 as shown in FIG. 67B. The control unit re-creates a new polar coordinate system as shown in FIG. 67A with the center O as a pole and a ray from the center O and through another one of the two touch points, that is, a touch point of R5, as a polar axis OX. And then, the control unit converts all of coordinates of the five touch points to new polar coordinates based on the new polar coordinate system and gets a new copy of the five touch points, wherein touch points in the new copy are represented by the new polar coordinates.

The control unit sorts the touch points in the new copy from largest to smallest by φ value and gets a new first touch point sequence, wherein the new first touch point sequence is consistent with a natural order of R1, R2, R3, R4 and R5.

The control unit gets a new second touch point sequence based on the new first touch point sequence according to corresponding relationships between the five touch points and the touch points in the new copy, wherein touch points in the new second touch point sequence is represented by the original coordinates.

The control unit sequentially matches R1, R2, R3, R4 and R5 to the touch points in the new second touch point sequence.

The center O as the pole of the polar coordinate system can be replaced with any point semi-surrounded by the five touch points of R1, R2, R3, R4 and R5.

The control unit can also find the two touch points of R1 and R5 by calculating and comparing angles between any two of rays from the center O and respectively through the five touch points. An angle between two rays from the center O and respectively through the two touch points of R1 and R5 must be the largest.

The other aspects not described in this method are the same as or similar to the counterpart description of the methods in Part M.

The logic, principle and rationale of the above described method are also applicable when the touch pad mouse is operated by a left hand or configured with three, four mouse buttons.

Method 2:

A method is described as follows for dynamically configuring the positions of the five mouse buttons by creating a rectangular coordinate system based on a virtual straight line fitted based on five touch points of R1, R2, R3, R4 and R5.

(1) When five right fingers: R1, R2, R3, R4 and R5 of a user touch the touch pad 29, the control unit will detect five touch points thereof on the touch pad 29 as shown in FIG. 68A-68H.

(2) The control unit fits a virtual straight line Lv: y=kx+b based on the five touch points. Wherein the touch pad mouse is put upside down as shown in FIG. 68B, 68D, 68F and 68H.

(3) The control unit finds a point semi-surrounded by the five touch points, for example, a center O of a virtual circle fitted based on the five touch points.

(4) The control unit creates two straight lines L1 and L2 which pass through the center O and are respectively parallel to y and x axes of the coordinate system 30.

(5) The control unit finds an intersection P1 between Lv and L1, if any, and an intersection P2 between Lv and L2, if any.

(6) Based on the virtual straight line Lv: y=kx+b,

(a) If Lv is parallel to L2, i.e., k=0, the linear equation becomes y=b, and P1.y>O.y as shown in FIG. 68A, the control unit creates a new rectangular coordinate system whose x axis: Xn is a ray starting at P1 and passing through a point (P1.x+1, P1.y) and whose y axis: Yn can be any ray perpendicular to Xn.

If Lv is parallel to L2 and P1.y<O.y as shown in FIG. 68B, the control unit creates a new rectangular coordinate system whose x axis: Xn is a ray starting at P1 and passing through a point (P1.x−1, P1.y) and whose y axis: Yn can be any ray perpendicular to Xn.

(b) If k>0 as shown in FIG. 68C and FIG. 68D, the control unit creates a new rectangular coordinate system whose x axis: Xn is a ray starting at P2 and passing through P1 and whose y axis: Yn can be any ray perpendicular to Xn.

(c) If k<0 as shown in FIG. 68E and FIG. 68F, the control unit creates a new rectangular coordinate system whose x axis: Xn is a ray starting at P1 and passing through P2 and whose y axis: Yn can be any ray perpendicular to Xn.

(d) If Lv is parallel to L1, i.e., the linear equation becomes x=a, and P2.x<O.x as shown in FIG. 68G, the control unit creates a new rectangular coordinate system whose x axis: Xn is a ray starting at P2 and passing through a point (P2.x, P2.y+1) and whose y axis: Yn can be any ray perpendicular to Xn.

If Lv is parallel to L1 and P2.x>O.x as shown in FIG. 68H, the control unit creates a new rectangular coordinate system whose x axis: Xn is a ray starting at P2 and passing through a point (P2.x, P2.y−1) and whose y axis: Yn can be any ray perpendicular to Xn.

(7) The control unit converts all of coordinates of the five touch points to new coordinates based on the new rectangular coordinate system and gets a copy of the five touch points, wherein touch points in the copy are represented by the new coordinates.

(8) The control unit sorts the touch points in the copy from smallest to largest and gets a first touch points sequence.

(9) The control unit gets a second touch point sequence based on the first touch point sequence according to corresponding relationships between the five touch points and the touch points in the copy, wherein touch points in the second touch point sequence are represented by original coordinates.

(10) The control unit sequentially matches R1, R2, R3, R4 and R5 to the touch points in the second touch point sequence.

The other steps and aspects not described in this method are the same as or similar to the counterpart description of the method 1 in this part.

The logic, principle and rationale of the present method are also applicable when the touch pad mouse is operated by a left hand or configured with three, four mouse buttons.

Method 3.

A method is described as follows for dynamically configuring the positions of the five mouse buttons by creating a rectangular coordinate system based on a virtual straight line fitted based on five touch points of R1, R2, R3, R4 and R5.

(1) When five right fingers: R1, R2, R3, R4 and R5 of a user touch the touch pad 29, the control unit will detect five touch points thereof on the touch pad 29 as shown in FIG. 69A-69H.

(2) The control unit fits a virtual straight line Lv: y=kx+b based on the five touch points. Wherein the touch pad mouse is put upside down as shown in FIG. 69B, 69D, 69F and 69H.

(3) The control unit finds an intersection P1 between Lv and y axis of the coordinate system 30, if any, and an intersection P2 between Lv and x axis of the coordinate system 30, if any.

(4) Based on the virtual straight line Lv: y=kx+b,

(a) If Lv is parallel to the x axis, i.e., k=0, the linear equation becomes y=b as shown in FIG. 69A, the control unit creates a new rectangular coordinate system whose x axis: Xn is a ray starting at P1 and passing through a point (P1.x+1, P1.y) and whose y axis: Yn can be any ray perpendicular to Xn.

If Lv is parallel to the x axis and detecting that the touch pad mouse is put upside down as shown in FIG. 69B, the control unit creates a new rectangular coordinate system whose x axis: Xn is a ray starting at P1 and passing through a point (P1.x−1, P1.y) and whose y axis: Yn can be any ray perpendicular to Xn.

(b) If k>0 and P1≠P2 as shown in FIG. 69C and FIG. 69D, the control unit creates a new rectangular coordinate system whose x axis: Xn is a ray starting at P2 and passing through P1 and whose y axis: Yn can be any ray perpendicular to Xn.

(c) If k>0 and P1=P2=(0, 0), i.e., the linear equation becomes y=kx, the control unit creates a new rectangular coordinate system whose x axis: Xn is a ray starting at (0, 0) and passing through a point (1, k) and whose y axis: Yn can be any ray perpendicular to Xn.

(d) If k<0 as shown in FIG. 69E, the control unit creates a new rectangular coordinate system whose x axis: Xn is a ray starting at P2 and passing through P1 and whose y axis: Yn can be any ray perpendicular to Xn.

If k<0 and detecting that the touch pad mouse is put upside down as shown in FIG. 69F, the control unit creates a new rectangular coordinate system whose x axis: Xn is a ray starting at P1 and passing through P2 and whose y axis: Yn can be any ray perpendicular to Xn.

(e) If Lv is parallel to the y axis, i.e., the linear equation becomes x=a as shown in FIG. 69G, the control unit creates a new rectangular coordinate system whose x axis: Xn is a ray starting at P2 and passing through a point (P2.x, P2.y+1) and whose y axis: Yn can be any ray perpendicular to Xn.

If Lv is parallel to the y axis and detecting that the touch pad mouse is put upside down as shown in FIG. 69H, the control unit creates a new rectangular coordinate system whose x axis: Xn is a ray starting at P2 and passing through a point (P2.x, P2.y−1) and whose y axis: Yn can be any ray perpendicular to Xn.

(5) The control unit converts all of coordinates of the five touch points to new coordinates based on the new rectangular coordinate system and gets a copy of the five touch points, wherein touch points in the copy are represented by the new coordinates.

(6) The control unit sorts the touch points in the copy from smallest to largest and gets a first touch points sequence.

(7) The control unit gets a second touch point sequence based on the first touch point sequence according to corresponding relationships between the five touch points and the touch points in the copy, wherein touch points in the second touch point sequence are represented by original coordinates.

(8) The control unit sequentially matches R1, R2, R3, R4 and R5 to the touch points in the second touch point sequence.

The other steps and aspects not described in this method are the same as or similar to the counterpart description of the method 2 in this part.

The logic, principle and rationale of the present method are also applicable when the touch pad mouse is operated by a left hand or configured with three, four mouse buttons.

The method 2 is better than the method 3 in this part.

Part O.

As shown in FIG. 70A-D, FIG. 71A-D, FIG. 72A-D and FIG. 73A-D, a user operates the touch pad mouse with five fingers and a palm of a left or right hand touching and resting on the touch pad 29. The five fingers and left and right parts of the palm will generate seven touch points on the touch pad 29.

As shown in FIG. 70A-D and 72A-D, two touches 38-L and 39-L respectively are that of right and left parts of a left palm; and as shown in FIG. 71A-D and FIG. 73A-D, two touches 38-R and 39-R respectively are that of right and left parts of a right palm.

In FIG. 70A, FIG. 70C, and FIG. 72A-FIG. 72D, L1-L is a straight line from a touch point of the touch 38-L to a touch point of L1, and L2-L is a straight line from a touch point of the touch 39-L to a touch point of L5. And in FIG. 70B, FIG. 70D, and FIG. 72A-FIG. 72D, <1-L is an angle between two rays from a point O and respectively passing through the touch point of the touch 38-L and the touch point of L1, and <2-L is an angle between two rays from the point O and respectively passing through the touch point of the touch 39-L and the touch point of L5.

In FIG. 71A, FIG. 71C, and FIG. 73A-FIG. 73D, L1-R is a straight line from a touch point of the touch 38-R to a touch point of R5, and L2-R is a straight line from a touch point of the touch 39-R to a touch point of R1. And in FIG. 71B, FIG. 71D and FIG. 73A-FIG. 73D, <1-R is an angle between two rays from a point O and respectively passing through the touch point of the touch 38-R and the touch point of R5, and <2-R is an angle between two rays from the point O and respectively passing through the touch point of the touch 39-R and the touch point of R1.

A touch pattern of a left hand is just opposite to that of a right hand as shown between FIG. 70A-D and FIG. 71A-D, and between FIG. 72A-D and FIG. 73A-D.

There are four methods as follows for identifying whether a left or right hand is touching and resting on the touch pad 29, and dynamically configuring the positions of the five mouse buttons.

Method 1:

(1) The control unit sorts the seven touch points and gets a touch point sequence according to the methods described in Part M.

As shown in FIG. 70A and 71A, O represents a center of a virtual circle fitted based on the seven touch points, and the center O can be replaced by any point surrounded by the seven touch points.

In addition, it is unnecessary to find the first empty slope group if seven slopes of straight lines from the center O respectively to the seven touch points are divided into four slope groups.

In a case as shown in FIG. 70A, the touch point sequence consecutively includes touch points of 39-L, L5, L4, L3, L2, L1 and 38-L if the seven slopes are divided into two slope groups, or touch points of 38-L, 39-L, L5, L4, L3, L2 and L1 if the seven slopes are divided into four slope groups.

In a case as shown in FIG. 71A, the touch point sequence consecutively includes touch points of 39-R, R1, R2, R3, R4, R5 and 38-R if the seven slopes are divided into two slope groups, or touch points of 38-R, 39-R, R1, R2, R3, R4 and R5 if the seven slopes are divided into four slope groups.

(2) The control unit regards the touch point sequence as a touch point closed loop chain in which the last and first touch points in the touch point sequence are deemed to be adjacent.

And from the first touch point in the touch point closed loop chain, the control unit sequentially calculates lengths of straight lines between every two adjacent touch points and gets a straight line sequence. For each straight line in the straight line sequence, its first and second endpoints are respectively the first and second of two adjacent touch points in relation to it.

For example, in a case as shown in FIG. 70A, the longest straight line L2-L is between two adjacent touch points of 39-L and L5 which respectively are first and second endpoints thereof.

And in a case as shown in FIG. 71A, the longest straight line L1-R is between two adjacent touch points of R5 and 38-R which respectively are first and second endpoints thereof.

(3) The control unit finds the longest straight line from the straight line sequence.

In a case as shown in FIG. 70A, the longest straight line is L2-L between two touch points of a left pinky finger and a left part of the left palm.

In a case as shown in FIG. 71A, the longest straight line is L1-R between two touch points of a right pinky finger and a right part of the right palm.

(4) The control unit regards the straight line sequence as a straight line closed loop chain in which the last and first straight lines in the straight line sequence are deemed to be adjacent, and then from the longest straight line, renumbers straight lines in the straight line closed loop chain and gets a new straight line closed loop chain.

In a case as shown in FIG. 70A, the last and first straight lines in the new straight line closed loop chain respectively are between two touch points of 38-L and 39-L and between two touch points of 39-L and L5.

In a case as shown in FIG. 71A, the last and first straight lines in the new straight line closed loop chain respectively are between two touch points of R4 and R5 and between two touch points of R5 and 38-R.

(5) The control unit, from a touch point which is the first endpoint (the second endpoint is also applicable) of the longest straight line, renumbers touch points in the touch point closed loop chain and gets a new touch point closed loop chain.

In a case as shown in FIG. 70A, the first and second touch points in the new touch point closed loop chain respectively are that of 39-L and L5.

In a case as shown in FIG. 71A, the first and second touch points in the new touch point closed loop chain respectively are that of R5 and 38-R.

(6) There are two options as the following:

Option 1:

(a) The control unit finds the second longest straight line in the new straight line closed loop chain.

In a case as shown in FIG. 70A, the second longest straight line is L1-L between two touch points of a thumb and a right part of the left palm, and it is also the sixth straight line in the new straight line closed loop chain.

In a case as shown in FIG. 71A, the second longest straight line is L2-R between two touch points of a thumb and a left part of the right palm, and it is also the third straight line in the new straight line closed loop chain.

(b) If the second longest straight line is the third one in the new straight line closed loop chain, the control unit identifies that a right hand is touching the touch pad 29 and the second and third touch points in the new touch point closed loop chain are respectively touch points of 38-R and 39-R, that is, of the right and left parts of the right palm as shown in FIG. 71A.

if the second longest straight line is the sixth one in the new straight line closed loop chain, the control unit identifies that a left hand is touching the touch pad 29 and the last and first touch points in the new touch point closed loop chain are respectively touch points of 38-L and 39-L, that is, of the right and left parts of the left palm as shown in FIG. 70A.

(c) If a right hand is touching the touch pad 29, the control unit identifies that the fourth, fifth, sixth, seventh and first touch points in the new touch point closed loop chain are respectively touch points of R1, R2, R3, R4 and R5 as shown in FIG. 71A. And the control unit matches R1, R2, R3, R4 and R5 respectively to the fourth, fifth, sixth, seventh and first touch points, and further configures the fourth, fifth, sixth, seventh and first touch points respectively to be positions of the fourth, left, middle, right and fifth mouse buttons.

If a left hand is touching the touch pad 29, the control unit identifies that the second, third, fourth, fifth and sixth touch points in the new touch point closed loop chain are respectively touch points of L5, L4, L3, L2 and L1 as shown in FIG. 70A. And the control unit matches L5, L4, L3, L2 and L1 to the second, third, fourth, fifth and sixth touch points respectively, and further configures the second, third, fourth, fifth and sixth touch points respectively to be positions of the fourth, left, middle, right and fifth mouse buttons.

Option 2:

Sometimes, the second longest straight line in the straight line sequence may be not a straight line between two touch points of a thumb and the thumb's ipsilateral and adjacent half part of a palm of a hand, so, the present option 2 is better than the above option 1.

(a) The control unit finds the third straight line and the antepenultimate straight line from the first straight line, that is, the longest straight line in the new straight line closed loop chain.

In a case as shown in FIG. 70A, the third straight line is between two touch points of L4 and L3 and the antepenultimate straight line is between two touch points of L1 and 38-L.

And in a case as shown in FIG. 71A, the third straight line is between two touch points of 39-R and R1 and the antepenultimate straight line is between touch points of R3 and R4.

(b) If the third straight line is longer than the antepenultimate straight line, the control unit identifies that a right hand is touching the touch pad 29, and the second and third touch points in the new touch point closed loop chain are respectively touch points of 38-R and 39-R, that is, of the right and left parts of the right palm as shown in FIG. 71A.

If the third straight line is shorter than the antepenultimate straight line, the control unit identifies that a left hand is touching the touch pad 29, and the last and first touch points in the new touch point closed loop chain respectively are touch points of 38-L and 39-L, that is, of the right and left parts of the left palm as shown in FIG. 70A.

(c) If a right hand is touching the touch pad 29, the control unit identifies that the fourth, fifth, sixth, seventh and first touch points in the new touch point closed loop chain are respectively touch points of R1, R2, R3, R4 and R5. And the control unit matches R1, R2, R3, R4 and R5 respectively to the fourth, fifth, sixth, seventh and first touch points as shown in FIG. 71A, and further configures the fourth, fifth, sixth, seventh and first touch points respectively to be positions of the fourth, left, middle, right and fifth mouse buttons.

If a left hand is touching the touch pad 29, the control unit identifies that the second, third, fourth, fifth and sixth touch points in the new touch point closed loop chain are respectively touch points of L5, L4, L3, L2 and L1. And the control unit matches L5, L4, L3, L2 and L1 to the second, third, fourth, fifth and sixth touch points respectively as shown in FIG. 70A, and further configures the second, third, fourth, fifth and sixth touch points respectively to be positions of the fourth, left, middle, right and fifth mouse buttons.

The other steps and aspects not described in this method are the same as or similar to the counterpart description of Part M.

Method 2:

Step (1) are the same as the step (1) in the above method 1, the control unit sorts the seven touch points and gets a touch points sequence.

(2) The control unit regards the touch point sequence as a touch point closed loop chain wherein the last and first touch points in the touch point sequence are deemed to be adjacent.

And then, from the first touch point in the touch point closed loop chain, the control unit sequentially calculates angles between every two adjacent rays from the center O and respectively passing through every two adjacent touch points in the touch point closed loop chain and gets an angle sequence. And for each angle in the angle sequence, its first and second rays respectively pass through the first and second of two adjacent touch points in relation to it.

For example, in a case as shown in FIG. 70B, the largest angle <2-L is between first and second rays respectively passing through the first and second of two adjacent touch points of 39-L and L5.

And in a case as shown in FIG. 71B, the largest angle <1-R is between first and second rays respectively passing through the first and second of two adjacent touch points of R5 and 38-R.

(3) The control unit finds the largest angle from the angle sequence.

In a case as shown in FIG. 70B, the largest angle is <2-L between two rays respectively passing through two touch points of a left pinky finger and a left part of the left palm.

In a case as shown in FIG. 71B, the largest angle is <1-R between two rays respectively passing through two touch points of a right pinky finger and a right part of the right palm.

(4) The control unit regards the angle sequence as an angle closed loop chain in which the last and first angles in the angle sequence are deemed to be adjacent, and then from the largest angle, renumber angles in the angle closed loop chain and get a new angle closed loop chain.

In a case as shown in FIG. 70B, the last and first angles in the new angle closed loop chain are respectively between two rays respectively passing through two touch points of 38-L and 39-L and between two rays respectively passing through two touch points of 39-L and L5.

In a case as shown in FIG. 71B, the last and first angles in the new angle closed loop chain are respectively between two rays respectively passing through two touch points of R4 and R5 and between two rays respectively passing through two touch points of R5 and 38-R.

(5) The control unit, from a touch point passed through by the first ray (the second ray is also applicable) of the largest angle, renumber touch points in the touch point closed loop chain and gets a new touch point closed loop chain.

In a case as shown in FIG. 70B, the first and second touch points in the new touch point closed loop chain respectively are that of 39-L and L5.

In a case as shown in FIG. 71B, the first and second touch points in the new touch point closed loop chain respectively are that of R5 and 38-R.

(6) There are two options as the following:

Option 1:

(a) The control unit finds the second largest angle in the new angle closed loop chain.

In a case as shown in FIG. 70B, the second largest angle is <1-L between two rays from the center O and respectively passing through two touch points of a left thumb and the right part of the left palm, and it is also the sixth angle in the new angle closed loop chain.

In a case as shown in FIG. 71B, the second largest angle is <2-R between two rays from the center O and respectively passing through two touch points of a right thumb and the left part of the right palm, and it is also the third angle in the new angle closed loop chain.

(b) If the second largest angle is the third one in the new angle closed loop chain, the control unit identifies that a right hand is touching the touch pad 29 and the second and third touch points in the new touch point closed loop chain respectively are touch points of 38-R and 39-R, that is, of the right and left parts of the right palm as shown in FIG. 71B.

if the second largest angle is the sixth one in the new angle closed loop chain, the control unit identifies that a left hand is touching the touch pad 29 and the last and first touch points in the new touch point closed loop chain respectively are touch points of 38-L and 39-L, that is, of the right and left parts of the left palm as shown in FIG. 70B.

(c) If a right hand is touching the touch pad 29, the control unit identifies that the fourth, fifth, sixth, seventh and first touch points in the new touch point closed loop chain respectively are touch points of R1, R2, R3, R4 and R5. And the control unit matches R1, R2, R3, R4 and R5 respectively to the fourth, fifth, sixth, seventh and first touch points as shown in FIG. 71B, and further configures the fourth, fifth, sixth, seventh and first touch points respectively to be positions of the fourth, left, middle, right and fifth mouse buttons.

if a left hand is touching the touch pad 29, the control unit identifies that the second, third, fourth, fifth and sixth touch points in the new touch point closed loop chain respectively are touch points of L5, L4, L3, L2 and L1. And the control unit matches L5, L4, L3, L2 and L1 respectively to the second, third, fourth, fifth and sixth touch points as shown in FIG. 70B, and further configures the second, third, fourth, fifth and sixth touch points respectively to be positions of the fourth, left, middle, right and fifth mouse buttons.

Option 2:

Sometimes, the second largest angle in the angle sequence may be not an angle between two rays from the center O and respectively passing through two touch points of a thumb and the thumb's ipsilateral and adjacent half part of a palm of a hand, so, the present option 2 is better than the above option 1.

(a) The control unit finds the third angle and the antepenultimate angle from the first angle, that is, the largest angle in the new angle closed loop chain.

In a case as shown in FIG. 70B, the third angle is between two rays from the center O and respectively passing through two touch points of L4 and L3, and the antepenultimate angle is between two rays from the center O and respectively passing through two touch points of L1 and 38-L.

And in a case as shown in FIG. 71B, the third angle is between two rays from the center O and respectively passing through two touch points of 39-R and R1, and the antepenultimate angle is between two rays from the center O and respectively passing through touch points of R3 and R4.

(b) If the third angle is larger than the antepenultimate angle, the control unit identifies that a right hand is touching the touch pad 29, and the second and third touch points in the new touch point closed loop chain respectively are touch points of 38-R and 39-R, that is, of the right and left parts of the right palm as shown in FIG. 71B.

If the third angle is smaller than the antepenultimate angle, the control unit identifies that a left hand is touching the touch pad 29, and the last and first touch points in the new touch point closed loop chain respectively are touch points of 38-L and 39-L, that is, of the right and left parts of the left palm as shown in FIG. 70B.

(c) If a right hand is touching the touch pad 29, the control unit identifies that the fourth, fifth, sixth, seventh and first touch points in the new touch point closed loop chain respectively are touch points of R1, R2, R3, R4 and R5. And the control unit matches R1, R2, R3, R4 and R5 respectively to the fourth, fifth, sixth, seventh and first touch points as shown in FIG. 71B, and further configures the fourth, fifth, sixth, seventh and first touch points respectively to be positions of the fourth, left, middle, right and fifth mouse buttons.

If a left hand is touching the touch pad 29, the control unit identifies that the second, third, fourth, fifth and sixth touch points in the new touch point closed loop chain respectively are touch points of L5, L4, L3, L2 and L1. And the control unit matches L5, L4, L3, L2 and L1 respectively to the second, third, fourth, fifth and sixth touch points as shown in FIG. 70B, and further configures the second, third, fourth, fifth and sixth touch points respectively to be positions of the fourth, left, middle, right and fifth mouse buttons.

The other steps and aspects not described in this method are the same as or similar to the counterpart description of the above method 1 in this part.

In this method, the center O can also be replaced with any point surrounded by the seven touch points, but a center of a virtual circle or ellipse is the best.

Method 3:

(1) The control unit sorts the seven touch points and gets a touch point sequence according to the method 1 of Part N by creating a polar coordinate system as shown in FIG. 70C or 71C with a center O of a virtual circle as a pole, wherein the virtual circle is fitted based on the seven touch points and a polar axis OX of the polar coordinate system can be any ray from the center O.

In a case as shown in FIG. 70C, the touch point sequence consecutively includes touch points of 38-L, 39-L, L5, L4, L3, L2 and L1.

In a case as shown in FIG. 71C, the touch point sequence consecutively includes touch points of 38-R, 39-R, R1, R2, R3, R4 and R5.

(2) The other steps are the same as the steps (2)-(6) in the above method 1.

The other aspects not described in this method are the same as or similar to the counterpart description of the above method 1 and Part N.

Method 4:

Step (1) is the same as the step (1) in the above method 3, and a related embodiment is shown in FIG. 70D and 71D.

(2) The other steps are the same as the steps (2)-(6) in the above method 2.

The other aspects not described in this method are the same as or similar to the counterpart description of the above method 2 and Part N.

Part P.

For this method for dynamically configuring the positions of the five mouse buttons on the touch pad 29, a touch area of a touch must be available.

This part is based on FIG. 72A-D and FIG. 73A-D. For more description of FIG. 72A-D and FIG. 73A-D, please see the initial portion of Part O.

Because two touch areas of two touches 38-L and 39-L must be larger than any of touch areas of L1-L5, and two touch areas of two touches 38-R and 39-R must be larger than any of touch areas of R1-R5, so

(1) The control unit finds first and second touch points respectively with the first and second largest touch areas from the seven touch points, which are respectively points P1 and P2 as shown in FIG. 72A-D and FIG. 73A-D.

(2) The control unit identifies the first and second touch points as that of two parts of a palm of a hand.

(3) The control unit identifies the other five touch points of the seven touch points as that of five fingers of the hand.

(4) The control unit finds a point surrounded by the seven touch points, for example, a center O of a virtual circle fitted based on the seven touch points as shown in FIG. 72A-D and FIG. 73A-D.

(5) There are six options for identifying whether a left or right hand is touching the touch pad 29 as follows:

Option 1:

If P1.x<P2.x and both P1.y and P2.y≦O.y, or if P1.x>P2.x and both P1.y and P2.y>O.y, or if P1.y<P2.y and both P1.x and P2.x>O.x, or if P1.y>P2.y and both P1.x and P2.x≦O.x, the control unit identifies that a left hand is touching the touch pad 29, and P1 and P2 are respectively touch points of 39-L and 38-L.

If P1.x>P2.x and both P1.y and P2.y≦O.y, or if P1.x<P2.x and both P1.y and P2.y>O.y, or if P1.y>P2.y and both P1.x and P2.x>O.x, or if P1.y<P2.y and both P1.x and P2.x≦O.x, the control unit identifies that a right hand is touching the touch pad 29, and P1 and P2 are respectively touch points of 38-R and 39-R.

Alternatively or additionally, Option 2:

(a) The control unit sorts P1 and P2 and gets a touch point sequence according to one of the methods of Part M and N.

In a case as shown in FIG. 72A-D, the touch point sequence consecutively includes P2 and P1.

In a case as shown in FIG. 73A-D, the touch point sequence consecutively includes P1 and P2.

(b) The control unit identifies that a left hand is touching the touch pad 29, and P1 and P2 respectively are touch points of 39-L and 38-L, if P1 and P2 respectively are the second and first touch points in the touch point sequence.

Otherwise, the control unit identifies that a right hand is touching the touch pad 29, and P1 and P2 respectively are touch points of 38-R and 39-R, if P1 and P2 respectively are the first and second touch points in the touch point sequence.

Alternatively or additionally, Option 3:

(a) The control unit sorts P1 and P2 and gets a touch point sequence according to the method 1 of Part N by creating a polar coordinate system with the center O as a pole and a ray from the center O and passing through P1 (P2 is also applicable) as a polar axis.

In a case as shown in FIG. 72A-D, the touch point sequence consecutively includes P2 and P1.

In a case as shown in FIG. 73A-D, the touch point sequence consecutively includes P2 and P1 too.

(b) The control unit identifies that a left hand is touching the touch pad 29, and P1 and P2 respectively are touch points of 39-L and 38-L, if P2.φ<180° (or)90°).

Otherwise, the control unit identifies that a right hand is touching the touch pad 29, and P1 and P2 respectively are touch points of 38-R and 39-R, if P2.φ>180° (or)90°).

Alternatively or additionally, Option 4:

(a) The control unit sorts P1 and P2 and gets a first touch point sequence according to one of the methods described in M and N. Wherein, one virtual curve of two virtual circles/ellipses/parabolas/hyperbolas or the other two virtual curves fitted based on P2 and P2 is selected if a center/focus of the one virtual curve is the nearest to a center/centroid of the touch pad 29.

In a case as shown in FIG. 72A-D, the first touch point sequence consecutively includes P2 and P1.

In a case as shown in FIG. 73A-D, the first touch point sequence consecutively includes P1 and P2.

(b) The control unit sorts the other five touch points and gets a second touch point sequence according to one of the methods in Part L, M and N.

In a case as shown in FIG. 72A-D, the first touch point sequence consecutively includes five touch points of L5, L4, L3, L2 and L1.

In a case as shown in FIG. 73A-D, the second touch point sequence consecutively includes five touch points of R1, R2, R3, R4 and R5.

(c) The control unit calculates a first linear distance between the last touch point in the first touch point sequence and the first touch point in the second touch point sequence, and a second linear distance between the first touch point in the first touch point sequence and the last touch point in the second touch point sequence.

In a case as shown in FIG. 72A-D, the first and second linear distances respectively are L2-L and L1-L.

In a case as shown in FIG. 73A-D, the first and second linear distances respectively are L2-R and L1-R.

Alternatively, the control unit calculates a first angle between two rays from the center O and respectively passing through the last touch point in the first touch point sequence and the first touch point in the second touch point sequence, and a second angle between two rays from the center O and respectively passing through the first touch point in the first touch point sequence and the last touch point in the second touch point sequence.

In a case as shown in FIG. 72A-D, the first and second angles respectively are <2-L and <1-L.

In a case as shown in FIG. 73A-D, the first and second angles respectively are <2-R and <1-R.

(d) The control unit identifies that a left hand is touching the touch pad 29, and P1 and P2 respectively are touch points of 39-L and 38-L, if the first linear distance is longer than the second linear distance.

Otherwise, the control unit identifies that a right hand is touching the touch pad 29, and P1 and P2 respectively are touch points of 38-R and 39-R, if the first linear distance is shorter than the second linear distance.

Alternatively, the control unit identifies that a left hand is touching the touch pad 29, and P1 and P2 respectively are touch points of 39-L and 38-L, if the first angle is larger than the second angle.

Otherwise, the control unit identifies that a right hand is touching the touch pad 29, and P1 and P2 respectively are touch points of 38-R and 39-R, if the first angle is samller than the second angle.

(e) If a right hand is touching the touch pad 29, the control unit matches R1, R2, R3, R4 and R5 respectively to touch points in the second touch point sequence as shown in FIG. 73A-D, and further configures the touch points in the second touch point sequence respectively to be positions of the fourth, left, middle, right and fifth mouse buttons.

If a left hand is touching the touch pad 29, the control unit matches L5, L4, L3, L2 and L1 respectively to touch points in the second touch point sequence as shown in FIG. 72A-D, and further configures the touch points in the second touch point sequence respectively to be positions of the fourth, left, middle, right and fifth mouse buttons.

Alternatively or additionally, Option 5:

Generally, a hand roughly touches and rests on the touch pad 29 as shown in FIG. 72A, FIG. 72D, FIG. 73A or FIG. 73D.

When the touch pad mouse is placed as shown in FIG. 72A or FIG. 73A, the control unit identifies that a left hand is touching the touch pad 29 as shown in FIG. 72A if P1 is at the left of P2, that is, P1.x<P2.x, or identifies that a right hand is touching the touch pad 29 as shown in FIG. 73A if P1 is at the right of P2, that is P1.x>P2.x.

When the control unit detects that the touch pad mouse is put upside down as shown in FIG. 72D or FIG. 73D, the control unit identifies that a left hand is touching the touch pad 29 if P1 is at the left of P2, that is, P1.x>P2.x, or identifies that a right hand is touching the touch pad 29 if P1 is at the right of P2, that is, P1.x<P2.x.

Alternatively or additionally, Option 6:

Generally, a hand roughly touches and rests on the touch pad 29 as shown in FIG. 72A, FIG. 72D, FIG. 73A or FIG. 73D.

(a) The control unit identifies one at the left and the other one at the right of P1 and P2 to be new first and second touch points by comparing coordinates of P1 and P2.

For example, when the touch pad mouse is put as shown in FIG. 72A and FIG. 73A, if P1.x<P2.x, P1 is at the left and P2 is at the right as shown in FIG. 72A, and the control unit identifies P1 and P2 respectively to be the new first and second touch points.

When the control unit detects that the touch pad mouse is put upside down as shown in FIG. 72D and 73D, if P1.x<P2.x, P1 is at the right and P2 is at the left as shown in FIG. 73D, and the control unit identifies P2 and P1 respectively to be the new first and second touch points.

(b) The control unit sorts the other five touch points and gets a touch point sequence according to one of the methods described in Part L, M and N.

In a case as shown in FIG. 72A and FIG. 72D, the touch point sequence consecutively includes five touch points of L5, L4, L3, L2 and L1, wherein the first touch point, i.e., a touch point of L5, is at the left, and the last touch point, i.e., a touch point of L1 is at the right.

In a case as shown in FIG. 73A or FIG. 73D, the touch point sequence consecutively includes five touch points of R1, R2, R3, R4 and R5, wherein the first touch point, i.e., a touch point of R1, is at the left, and the last touch point, i.e., a touch point of R5 is at the right.

(c) The control unit calculates a first linear distance between the new first touch point and the first touch point in the touch point sequence and a second linear distance between the new second touch point and the last touch point in the touch point sequence.

In a case as shown in FIG. 72A or FIG. 72D, the first and second linear distances respectively are L2-L and L1-L.

In a case as shown in FIG. 73A or FIG. 73D, the first and second linear distances respectively are L2-R and L1-R.

The control unit identifies that a left hand is touching the touch pad 29 as shown in FIG. 72A or FIG. 72D if the first linear distance is longer than the second linear distance and/or a touch area of the new first touch point is larger than that of the new second touch point. Otherwise, the control unit identifies that a right hand is touching the touch pad 29 as shown in FIG. 73A or FIG. 73D if the first linear distance is shorter than the second linear distance and/or a touch area of the new first touch point is smaller than that of the new second touch point.

Alternatively, the control unit calculates a first angle between two rays starting at the center O and respectively passing through the new first touch point and the first touch point in the touch point sequence and a second angle between two rays starting at the center O and respectively passing through the new second touch point and the last touch point in the touch point sequence.

In a case as shown in FIG. 72A or FIG. 72D, the first and second angles respectively are <2-Land <1-L.

In a case as shown in FIG. 73A or FIG. 73D, the first and second angles respectively are <2-R and <1-R.

The control unit identifies that a left hand is touching the touch pad 29 as shown in FIG. 72A or FIG. 72D if the first angle is larger than the second angle and/or a touch area of the new first touch point is larger than that of the new second touch point. Otherwise, the control unit identifies that a right hand is touching the touch pad 29 as shown in FIG. 73A or FIG. 73D if the first angle is smaller than the second angle and/or a touch area of the new first touch point is smaller than that of the new second touch point.

(d) If a right hand is touching the touch pad 29, the control unit matches R1, R2, R3, R4 and R5 respectively to touch points in the touch point sequence as shown in FIG. 73A or FIG. 73D, and further configures the touch points in the touch point sequence respectively to be positions of the fourth, left, middle, right and fifth mouse buttons.

If a left hand is touching the touch pad 29, the control unit matches L5, L4, L3, L2 and L1 respectively to the touch points in the touch point sequence as shown in FIG. 72A or FIG. 72D, and further configures the touch points in the touch point sequence respectively to be positions of the fourth, left, middle, right and fifth mouse buttons.

The above options 1, 2, 3 and 4 is better than the above options 5 and 6 in this part.

(6) After identifying whether a left or right hand is touching the touch pad 29, the control unit sorts the other five touch points and gets a touch point sequence according to the methods described in Part L, M and N.

In a case as shown in FIG. 72A-FIG. 72D, the touch point sequence consecutively includes five touch points of L5, L4, L3, L2 and L1.

In a case as shown in FIG. 73A-FIG. 73D, the touch point sequence consecutively includes five touch points of R1, R2, R3, R4 and R5.

(7) If a right hand is touching the touch pad 29, the control unit sequentially matches R1, R2, R3, R4 and R5 to the touch points in the touch point sequence, and further sequentially configures the touch points in the touch point sequence to be positions of the fourth, left, middle, right and fifth mouse buttons.

If a left hand is touching the touch pad 29, the control unit sequentially matches L5, L4, L3, L2 and L1 to the touch points in the touch point sequence, and further configures the touch points in the touch point sequence to be positions of the fourth, left, middle, right and fifth mouse buttons.

The above steps (6) and (7) are unnecessary for the above options 4 and 6.

The other aspects not described in this part are the same as or similar to the counterpart description of Part O.

If the touch pad mouse is configured in advance or can be configured on demand for usage of a left or right hand, in the other words, if it is known in advance whether the touch pad mouse is for usage of a left or right hand, the steps described in the above methods of Part O and P, for identifying whether a left or right hand is touching the touch pad 29, is not necessary.

All of the methods described in Part O and P are also applicable to the other cases where the touch pad mouse is configured with four, three or two mouse buttons operated by five, four, three or two fingers of a hand.

Part Q.

FIG. 74A-FIG. 76 show that the touch pad mouse is operated by a right hand. A point O is a center of a virtual circle fitted based on seven touch points of five fingers and left and right parts of a palm, of the right hand. Two touches 38-R and 39-R are respectively that of the right and left parts of the palm, and two touch points P1 and P2 are respectively centroids of the two touches 38-R and 39-R. In this part, seven touch areas corresponding to the seven touch points must be available, wherein two touch areas of the touches 38-R and 39-R must be respectively the first and second largest.

There are three methods for dynamically configuring the positions of the five mouse buttons as follows.

Method 1.

(1) As shown in FIG. 74A and FIG. 74B, the control unit finds two touch points respectively with the first and second largest touch areas from the seven touch points. The two touch points must be respectively P1 and P2.

(2) The control unit sorts the seven touch points and gets a touch point sequence according to the method 1 of Part M. But seven slopes corresponding to the seven touch points are grouped as the following.

(a) The control unit finds a straight line L1 passing through P1 (P2 is also applicable) and the center O.

(b) The control unit divides seven slopes of straight lines from the center O and respectively passing through the seven touch points into two slope groups \textcircled{1} and \textcircled{2} which go clockwise according to relative positions of the seven touch points to the straight line L1.

Specifically, the control unit finds a reference point of a touch point, which is an intersection between the straight line L1 and a straight line passing through the touch point and parallel to the x axis of the coordinate system 30, if an x value of the touch point is smaller than an x value of the reference point, a slope corresponding to the touch point is put in the slope group \textcircled{1}, otherwise in the slope group \textcircled{2} as shown in FIG. 74A. But when the control unit detects that the touch pad mouse is put upside down (In this case, a device used for detecting whether the touch pad mouse is put upside down is available), if the x value of the touch point is larger than the x value of the reference point, the slope corresponding to the touch point is put in the slope group \textcircled{1}, otherwise in the slope group \textcircled{2} as shown in FIG. 74B.

For example, as shown in FIG. 74A, an x value of a touch point of R2 is smaller than an x value of its reference point rP2, a slope corresponding to the touch point of R2 is put in the slope group \textcircled{1}. And an x value of a touch point of R3 is larger than an x value of its reference point rP3, a slope corresponding to the touch point of R3 is put in the slope group \textcircled{2}.

As shown in FIG. 74B, the touch pad mouse is put upside down, the x value of the touch point of R2 is larger than the x value of its reference point rP2, and the slope corresponding to the touch point of R2 is put in the slope group \textcircled{1}. And the x value of the touch point of R3 is smaller than the x value of its reference point rP3, the slope corresponding to the touch point of R3 is put in the slope group \textcircled{2}.

In addition, if a y value of a touch point in the straight line L1 is smaller than a y value of the center O, a slope corresponding to the touch point is put in the slope group \textcircled{1} such as P1 as shown in FIG. 74A, otherwise in the slope group \textcircled{2}. But when the control unit detects that the touch pad mouse is put upside down, if a y value of a touch point in the straight line L1 is larger than a y value of the center O, a slope corresponding to the touch point is put in the slope group \textcircled{1} such as P1 as shown in FIG. 74B, otherwise in the slope group \textcircled{2}.

(3) The control unit excludes the two touch points P1 and P2 from the touch point sequence and gets a new touch point sequence.

(4) The control unit sequentially matches five touch points in the new touch point sequence to R1, R2, R3, R4 and R5.

The other steps and aspects not described in this method are the same as or similar to the counterpart description of Part M.

Method 2.

Step (1) is the same as the step 1 in the above method in this part.

(2) The control unit sorts the seven touch points and gets a touch point sequence according to the method 2 of Part M. But seven slopes corresponding to the seven touch points are grouped as the following.

(a) The control unit calculates a first straight line L1: y=k1*x+b1, which passes through P1 (P2 is also applicable) and the center O, and a second straight line L2: y=k2*x+b2, which is perpendicular to L1 and pass through the center O.

(b) The control unit divides seven slopes of straight lines from the center O and respectively passing through the seven touch points into four slope groups \textcircled{1}, \textcircled{2}, \textcircled{3} and \textcircled{4} which go clockwise according to relative positions of the seven touch points respectively to the straight lines L1 and L2. Wherein, a slope group where a slope corresponding to P1 is, is always regarded as the group \textcircled{1} as shown in FIG. 75A-FIG. 75E.

Specifically, for a touch point, the control unit finds two reference points which are two intersections between a straight line respectively and L1 and L2, wherein the straight line passes through the touch point and is parallel to a coordinate axis of the coordinate system 30, and sometimes only one reference point can be found. And then, the control unit determines whether the touch point is between the two reference points, and finally determines which slope group a slope corresponding to the touch point is put.

For example, two reference points: rP2-1 and rP2-2 for a touch point of R2 are two intersections between a straight line, which passes through the touch point of R2 and is parallel to a y axis of the coordinate system 30, respectively and the straight lines L1 and L2 which both are not parallel to a coordinate axis of the coordinate system 30. Let's use Pr2 to represent the touch point of R2. As shown in FIG. 75A, rP2-2.y≦rP2-y<rP2-1.y and Pr2.x<O.x, a slope corresponding to the touch point of R2 is put in the group \textcircled{2}.

For another example, two reference points: P1-1 and P1-2 for P1 are two intersections between a straight line, which passes through P1 and is parallel to an x axis of the coordinate system 30, respectively and the straight lines L1 and L2 which both are not parallel to a coordinate axis of the coordinate system 30, wherein P1-1 and P1 are the same point in the straight line L1. As shown in FIG. 75A, P1-2.x<P1.x≦P1-1.x and P1.y<O.y, a slope corresponding to P1 is put in the group \textcircled{1}. As described above, a slope group where the slope corresponding to P1 is, is always the slope group \textcircled{1}.

As shown in FIG. 75B, L1 is parallel to they axis, and P1.y<O.y.

As shown in FIG. 75C, L1 is parallel to the x axis, P1.x>O.x.

As shown in FIG. 75D, L1 is parallel to the x axis too, P1.x<O.x.

As shown in FIG. 75E, L1 is parallel to they axis too, and P1.y>O.y.

A slope corresponding to P1 is put in the group \textcircled{1} as FIG. 75B-E.

(3) The control unit excludes the two touch points P1 and P2 from the touch point sequence and gets a new touch point sequence.

(4) The control unit sequentially matches five touch points in the new touch point sequence to R1, R2, R3, R4 and R5.

The other steps and aspects not described in this method are the same as or similar to the counterpart description of the above method 1 in this part.

The present method 2 is better than the method 1 in this part.

Method 3.

Step (1) is the same as the step (1) of the method 1 in this part.

(2) The control unit sorts the seven touch points and gets a touch point sequence according to the method 1 of Part N by creating a polar coordinate system with the center O as a pole and a ray from the center O and through P1 (P2 is also applicable) as a polar axis OX as shown in FIG. 76.

(3) The control unit excludes the two touch points P1 and P2 from the touch point sequence and gets a new touch point sequence.

(4) The control unit sequentially matches five touch points in the new touch point sequence to R1, R2, R3, R4 and R5.

(5) The other steps for dynamically configuring the mouse buttons are the same as the method 1 described in Part N.

The other steps and aspects not described in this method are the same as or similar to the counterpart description of the method 1 of Part N.

The above three methods in this part are also applicable to the other cases where the touch pad mouse is operated by a left hand, or is configured with two, three or four mouse buttons which are operated by two, three, four or five fingers of a hand.

Part R.

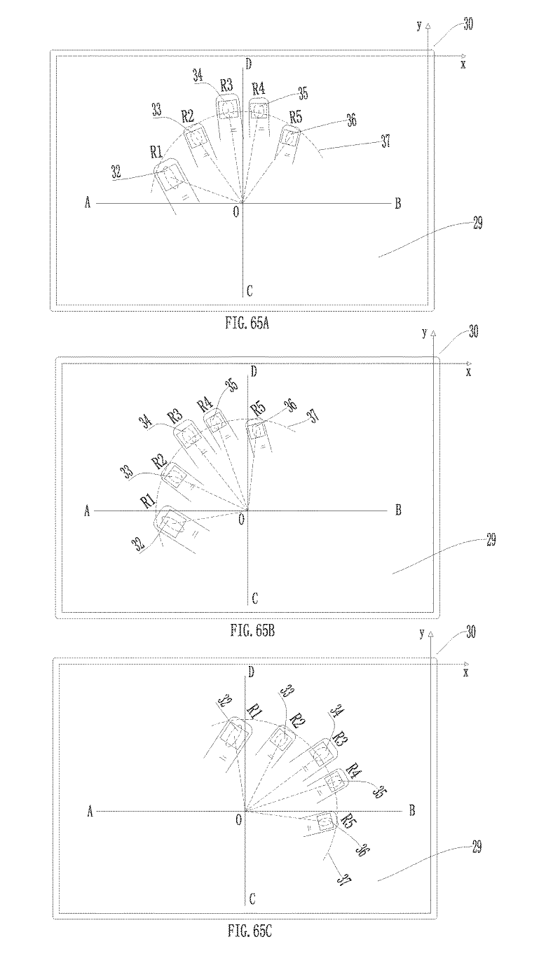

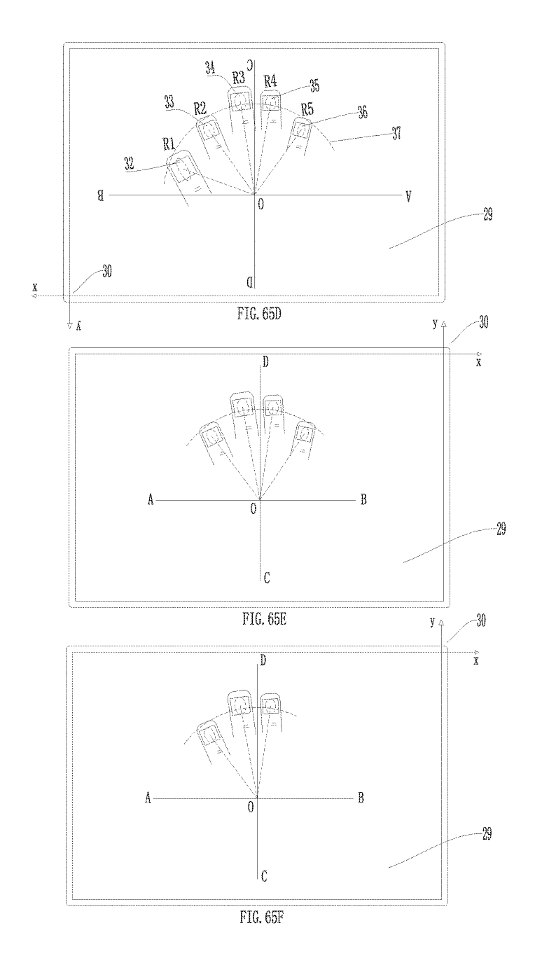

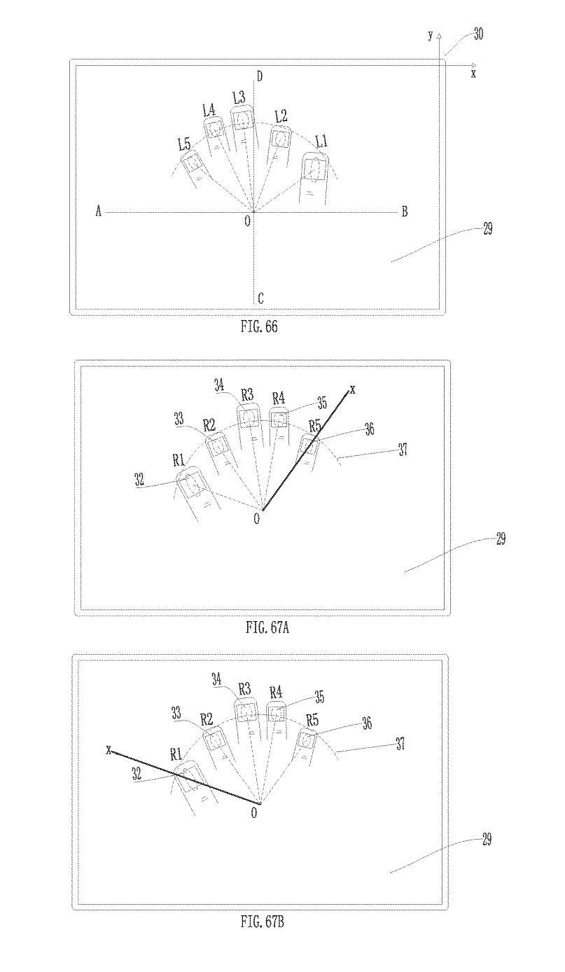

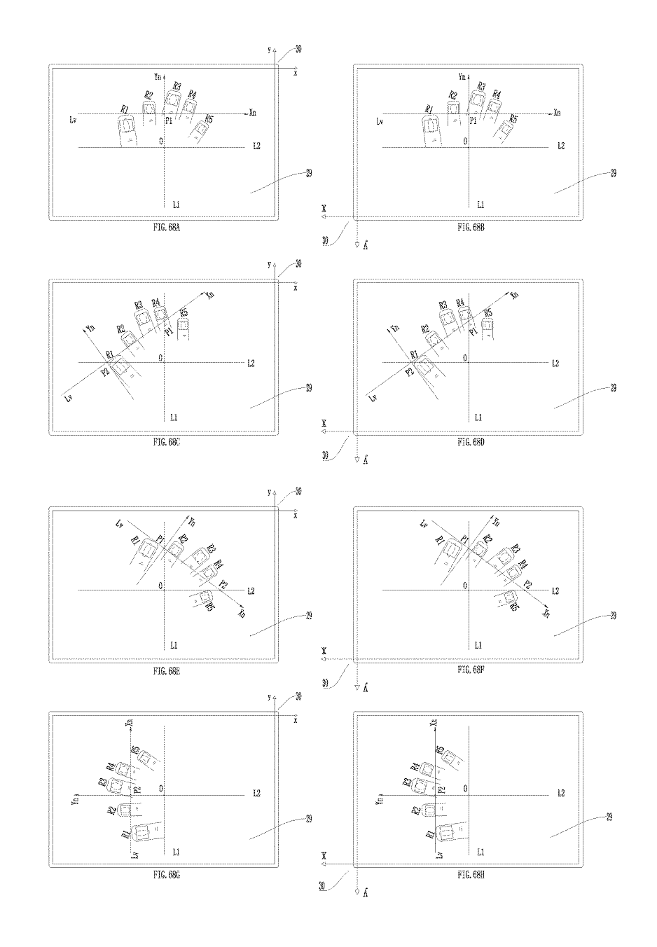

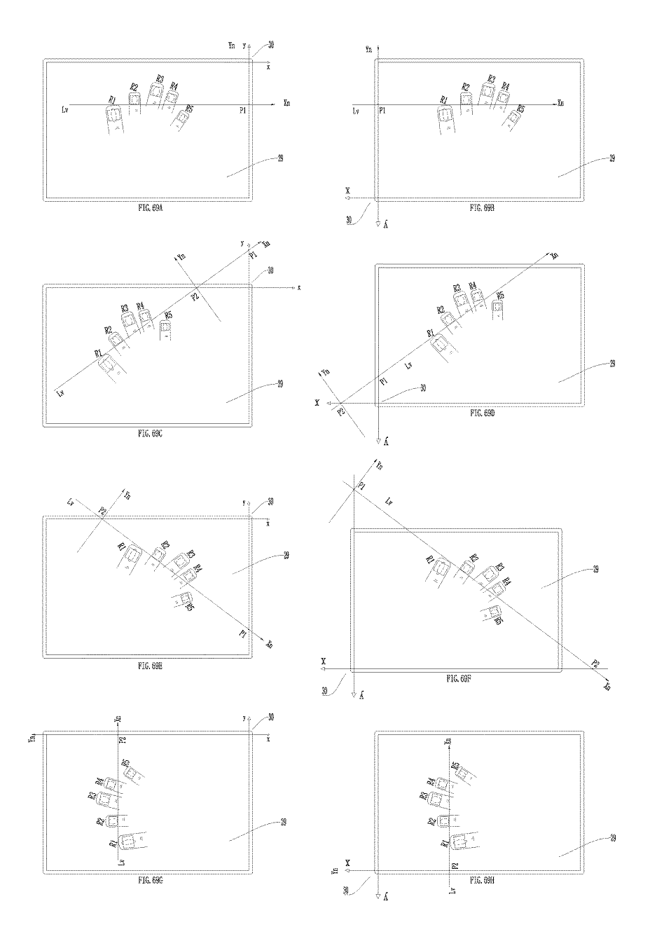

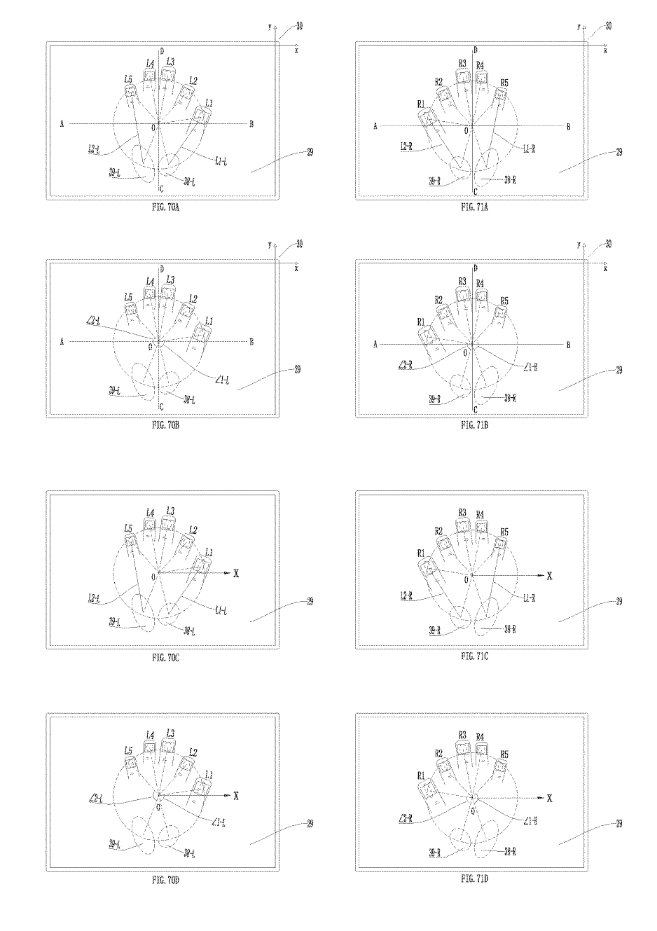

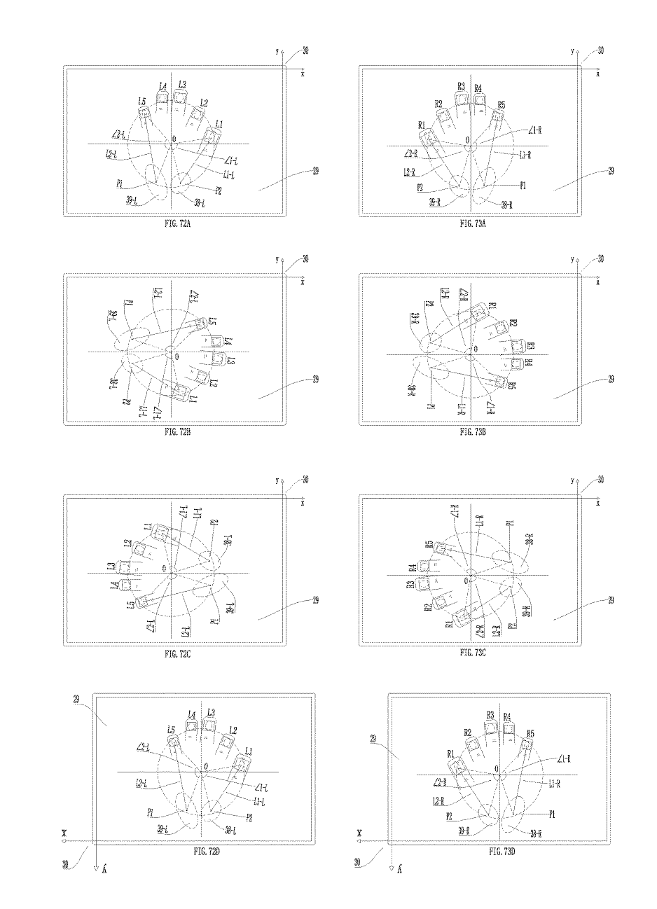

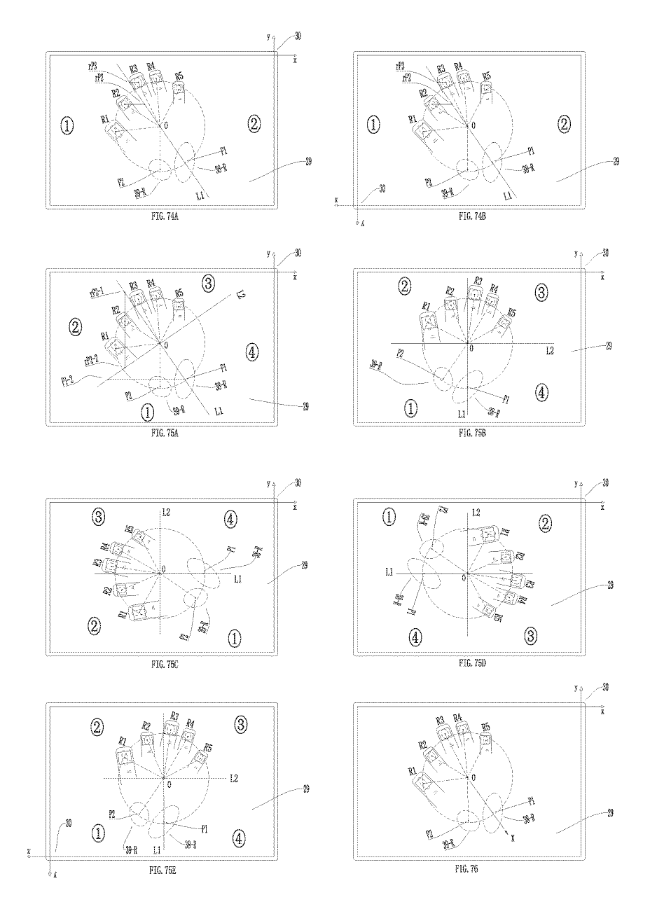

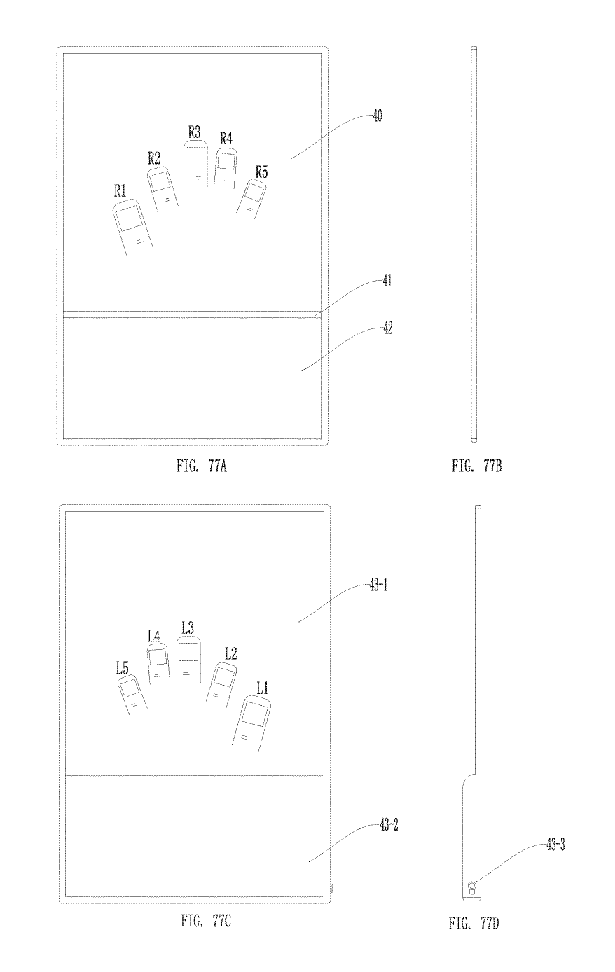

FIG. 77A-77B show a touch pad mouse comprising a touch pad 40 for a mouse and a tray pad 42 for resting a palm on. And there is a groove 41 between the touch pad 40 and the tray pad 42. The groove 41 is for a user to know a boundary of the touch pad 40 by touching.

FIG. 77C-77D show a touch pad mouse comprising a touch pad 43-1 for a mouse and a tray pad 43-2 for resting a palm on, the touch pad 43-1 is thinner than the tray pad 43-2. And there is a switch 43-3 at the right side and it is used for configuring the touch pad mouse for a left or right handed user by switching on/off it.

FIG. 77E-77F show a touch pad mouse comprising a touch pad 43-4 for a mouse and a tray pad 43-5 for resting a palm on, the touch pad 43-4 is thicker than the tray pad 43-5. And there is a switch 43-6 at the right side and it is used for configuring the touch pad mouse for a left or right handed user by switching on/off it.

FIG. 77G-77H show a touch pad mouse comprising a touch pad 44-1 for a mouse and a tray pad 44-3 for resting a palm on, the tray pad 44-3 is a slant. And there is a groove 44-2 between the touch pad 44-1 and the tray pad 44-3. The groove 44-2 is for a user to know a boundary of the touch pad 44 -1 by touching.

Part S.

If a device has a large touch sensitive surface, a user can also use his/her two hands to touch and rest on the large touch sensitive surface to realize much more key buttons which positons are determined dynamically.

FIG. 78A-81B shows a large touch screen display device with a touch sensitive screen 47. Ten key buttons are configured on the touch sensitive screen 47. And initially, the ten key buttons are disabled and positions thereof are configured to be undetermined. The ten key buttons respectively correspond to and are operated by five left fingers: L1, L2, L3, L4, L5 and five right fingers: R1, R2, R3, R4, R5 of a user.

When the user uses the device for the first time, the user is asked to touch and rest ten fingers of his/her two hands on the screen 47 as shown in FIG. 78A. A control unit will detect ten touch points on the screen 47. And then, the control unit divides the ten touch points into two groups which respectively include five touch points at the left and right of the screen 47. And based on the two groups of touch points, the control unit respectively fits two virtual circles: ccIL0 and ccIR0, and calculates an average r0 of a radius rL0 of ccIL0 and a radius rR0 of ccIR0, and stores r0, rL0 and rR0 which are deemed to be predefined radius values.

When in use normally, the control unit will detect ten touch points when the user touches and rests the ten fingers on the screen 47.

(1) According to a coordinate system 46, the control unit sorts the ten touch points from smallest to largest by x value and gets one touch point sequence: pL1, pL2, pL3, pL4, pL5, pR1, pR2, pR3, pR4 and pR5.

(2) The control unit divides touch points in the one touch point sequence into first and second touch point groups which respectively include the first five touch points: pL1, pL2, pL3, pL4, pL5 and the last five touch points: pR1, pR2, pR3, pR4, pR5.

(3) The control unit fits first and second virtual circles ccIL and ccIR respectively based on pL1-5 and pR1-5.

(4) The control unit calculates: (a) a difference between ccIL's radius rL and ccIR's radius rR; alternatively or additionally (b) a difference between r0 and rL and a difference between r0 and rR; alternatively or additionally (c) a difference between rL0 and rL and a difference between rR0 and rR, which may correspond to cases, for example, as shown in FIG. 78A-FIG. 79B.

(5) If the difference(s) is/are smaller than one or more different predefined threshold value(s), for example, r0*25%, the control unit confirms that the ten touch points are grouped correctly, that is, each of the first and second touch point groups just correspond to one of the two hands. Wherein, a predefined threshold value for one method calculating difference may differ from that for another method calculating difference.

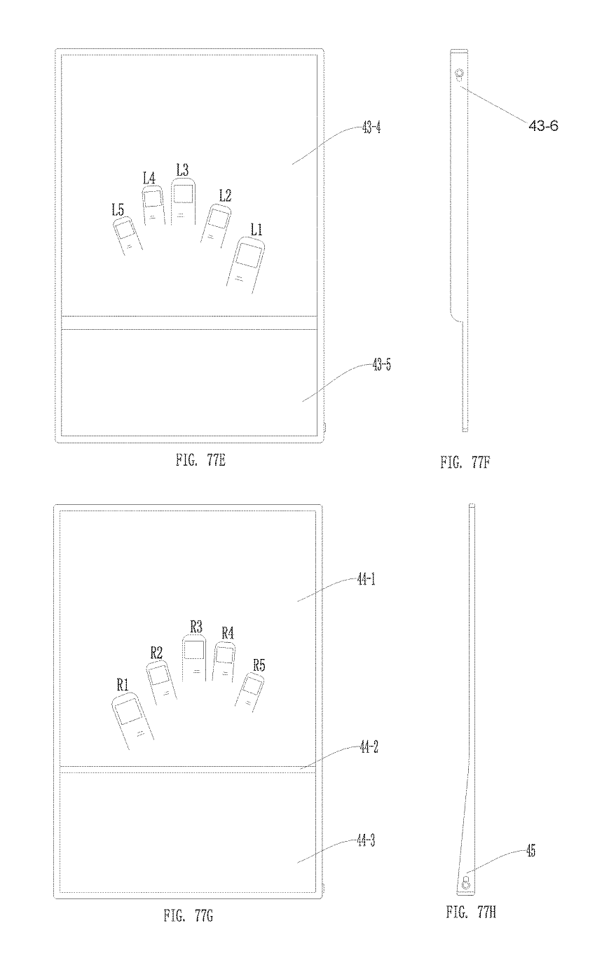

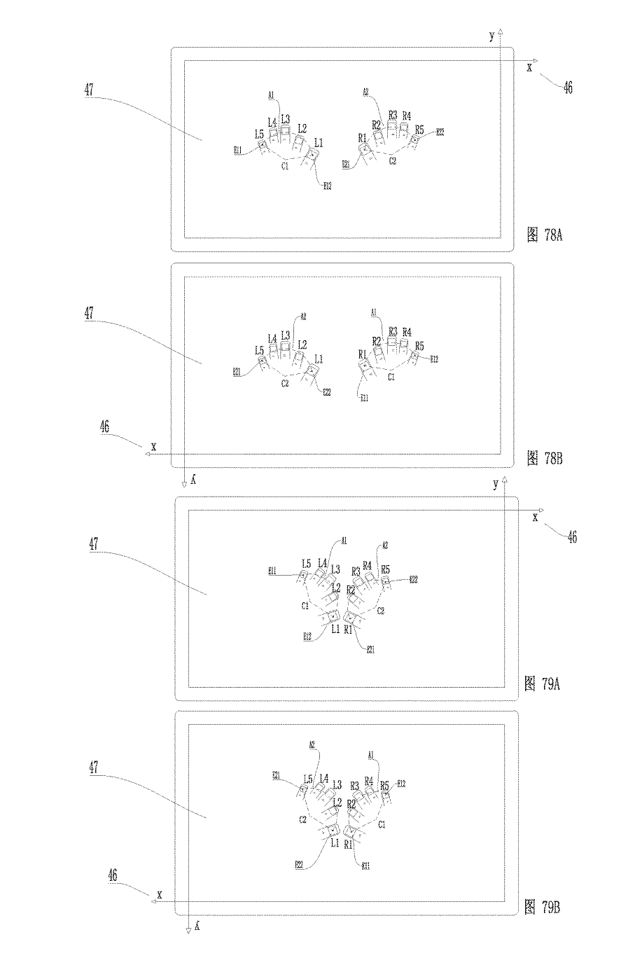

Especially, if both or either of the difference between rL0 and rL and the difference between rR0 and rR exceed(s) one or two different predefined threshold value(s), the control unit re-calculates a difference between rR0 and rL and a difference between rL0 and rR, which may correspond to cases, for example, as shown in FIG. 80A-FIG. 80B. If the re-calculated differences are smaller than the one or two different predefined threshold value(s), the control unit confirms that the ten touch points are grouped correctly. Wherein, a predefined threshold value for a left hand may differ from that for a right hand.

If failing to group the ten touch points correctly through the above steps, the control unit continue to process as follows:

(1) According to the coordinate system 46, the control unit sorts the ten touch points by y value from largest to smallest and gets another touch point sequence: pU1, pU2, pU3, pU4, pU5, pD1, pD2, pD3, pD4 and pD5.

(2) The control unit divides touch points in the another touch point sequence into first and second touch point groups which respectively include the first five touch points: pU1, pU2, pU3, pU4, pU5 and the last five touch points: pD1, pD2, pD3, pD4, pD5.

(3) The control unit fits first and second virtual circles ccIU and ccID respectively based on pU1-5 and pD1-5.

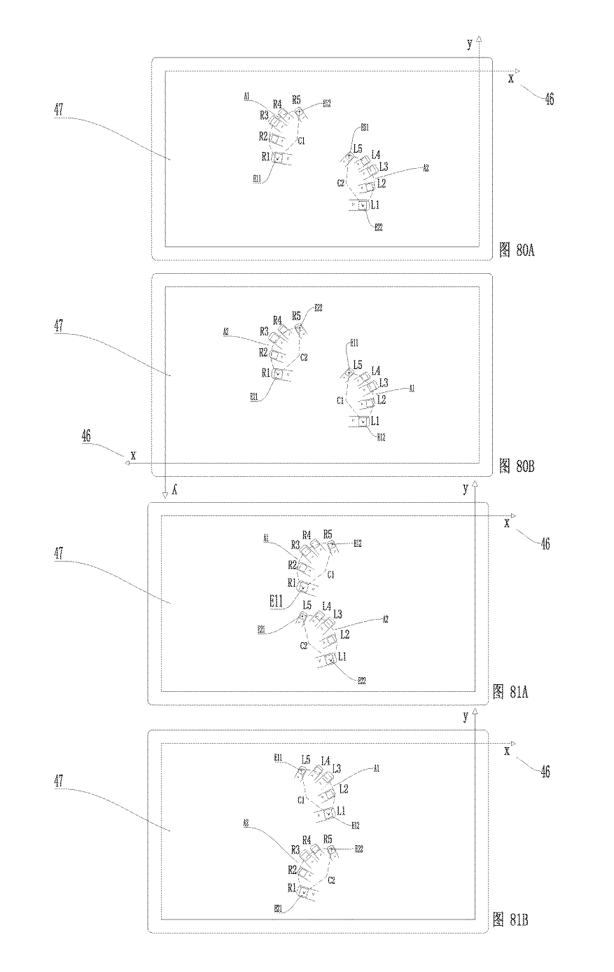

(4) The control unit calculates: (a) a difference between ccIU's radius rU and ccID's radius rD; alternatively or additionally (b) a difference between r0 and rU and a difference between r0 and rD; alternatively or additionally (c) a difference between rL0 and rU and a difference between rR0 and rD, which may correspond to cases, for example, as shown in FIG. 81B.

(5) If the difference(s) is/are smaller than the one or more different predefined threshold value(s), the control unit confirms that the ten touch points are grouped correctly.

Especially, If both or either of the difference between rL0 and rU and the difference between rR0 and rD exceed(s) the one or two different predefined threshold value(s), the control unit re-calculates a difference between rR0 and rU and a difference between rL0 and rD, which may correspond to cases, for example, as shown in FIG. 81A. If the re-calculated differences are smaller than the one or two different predefined threshold value(s), the control unit confirms that the ten touch points are grouped correctly.

If still failing to group the ten touch points correctly, the control unit continue to process as follows:

Option 1:

The control unit prompts the user by sound, vibrating, text, image, animation, and so on to re-touch and re-rest the two hands on the screen 47, and then groups ten new touch points according to the steps described in the above first and second groupings.

Option 2:

The control unit continue to group the ten touch points as follows.

(1) The control unit rotates the coordinate system 46 by an angle such as 30° and gets a new coordinate system.

(2) The control unit converts coordinates of the ten touch points to new coordinates based on the new coordinate system, and gets a copy of the ten touch points, wherein touch points in the copy are represented by the new coordinates.

(3) The control unit groups the touch points in the copy according to the steps described in the above first and second groupings.

(4) If still failing to group the touch points in the copy correctly, the control unit repeats the above steps: (1)-(3) by progressively rotating the coordinate system by the same angle for a plurality of times.

If once grouping touch points in a copy correctly, the control unit gets first and second touch point groups according to corresponding relationships between the ten touch points and the touch points in a copy, wherein touch points in the first and second touch point groups are represented by the original coordinates.

If still failing to group touch points in any copy correctly when rotated back to the initial positon of the coordinate system 46, the control unit prompts the user by sound, vibrating, text, image, animation, and so on to re-touch and re-rest the two hands on the screen 47, and then groups ten new touch points according to the steps described in the above description.

After grouping the ten touch points correctly, the control unit do as follows:

(1) The control unit respectively sorts touch points in the first and second touch point groups according to methods described in Part L, M or N and gets a first and second touch point sequences.

(2) The control unit finds two intersections: E11 and E12 between ccIL(or ccIU) and two rays starting at a center C1 of ccIL(or ccIU) and respectively passing through the first and last touch points in the first touch point sequence, and gets a first virtual circular arc A1 whose two endpoints are E11 and E12 as shown in FIG. 78A-FIG. 81B. A1 intersects with a ray starting at the center C1 and passing through any of the other touch points in the first touch point sequence.

The control unit finds two intersections: E21 and E22 between ccIR(or ccID) and two rays starting at a center C2 of ccIR(or ccID) and respectively passing through the first and last touch points in the second touch point sequence and gets a second virtual circular arc A2 whose two endpoints are E21 and E22 as shown in FIG. 78A-FIG. 81B. A2 intersects with a ray starting at the center C2 and passing through any of the other touch points in the second touch point sequence.

(3) The control unit compares coordinates of C1 respectively with that of E11 and E12, and also compares coordinates of C2 respectively with that of E21 and E22.

(a) If C1.y is smaller than both E11.y and E12.y, and C2.y is smaller than both E21.y and E22.y, it suggests that a touch pattern of the two hands is as shown in FIG. 78A, and the control unit matches the first and second touch point groups respectively to left and right hands of the user.

(b) If C1.y is greater than both E11.y and E12.y, and C2.y is greater than both E21.y and E22.y, it suggests that a touch pattern of the two hands is as shown in FIG. 78B, and the control unit matches the first and second touch point groups respectively to right and left hands of the user.

(c) If C1.y is smaller than E11.y and C1.x is smaller than E12.x, and furthermore C2.y is smaller than E22.y and C2.x is greater than E21.x, it suggests that a touch pattern of the two hands is as shown in FIG. 79A, and the control unit matches the first and second touch point groups respectively to left and right hands of the user.

(d) If C1.y is greater than E12.y and C1.x is smaller than E11.x, and furthermore C2.y is greater than E21.y and C2.x is greater than E22.x, it suggests that a touch pattern of the two hands is as shown in FIG. 79B, and the control unit matches the first and second touch point groups respectively to right and left hands of the user.

(e) If C1.y is smaller than E12.y and C1.x is greater than E11.x, and furthermore C2.y is smaller than E21.y and C2.x is smaller than E22.x, it suggests that a touch pattern of the two hands is as shown in FIG. 80A, and the control unit matches the first and second touch point groups respectively to right and left hands of the user.

(f) If C1.y is greater than E11.y and C1.x is greater than E12.x, and furthermore C2.y is greater than E22.y and C2.x is smaller than E21.x, it suggests that a touch pattern of the two hands is as shown in FIG. 80B, and the control unit matches the first and second touch point groups respectively to left and right hands of the user.

(g) If C1.y is smaller than E12.y and C1.x is greater than E11.x, and furthermore C2.y is smaller than E21.y and C2.x is smaller than E22.x, it suggests that a touch pattern of the two hands is as shown in FIG. 81A, and the control unit matches the first and second touch point groups respectively to right and left hands of the user.

(h) If C1.y is smaller than E11.y and C1.x is smaller than E12.x, and furthermore C2.y is smaller than E22.y and C2.x is greater than E21.x, it suggests that a touch pattern of the two hands is as shown in FIG. 81B, and the control unit matches the first and second touch point groups respectively to left and right hands of the user.

FIG. 78A-FIG. 81B show only a portion of possible touch patterns of the two hands, wherein the display device is put upside down in FIG. 78B, 79B and 80B. A finite number of discrete standard two hand touch patterns can be used to represent all possible two hand touch patterns. For each standard two hand touch pattern, relative positions of a first center to a first virtual circular arc and a second center to a second virtual circular arc are definite, and moreover corresponding relationships between two touch point groups and two hands of a user are definite too. According to the above method, a table including connections between the above “relative positions” and “corresponding relationships” for all of the standard two hand touch patterns is established. In this way, based on a specific two hand touch pattern of a user, once such “relative positions” are determined, corresponding relationships between two touch point groups and two hands of the user are determined by looking up in the table.

After matching the first and second touch point groups to the two hands, based on the first touch point sequence, the control unit sequentially matches touch points in the first touch point sequence to the five right fingers: R1, R2, R3, R4 and R5, or the five left fingers: L5, L4, L3, L2 and L1; and based on the second touch point sequence, the control unit sequentially matches touch points in the second touch point sequence to the five right fingers: R1, R2, R3, R4 and R5, or the five left fingers: L5, L4, L3, L2 and L1.

And based on the above predefined corresponding relations between the ten fingers and the ten key buttons, the control unit configures the ten touch points one-to-one to be positions of the ten key buttons.

About how to operate a single key button, and how to identify a single input operation of a single key button, and how to update position of a single key button in real time, please refer to the relevant description in the above parts, especially in Part L, M and N.

When all of fingers of one of the two hands de-touch (leave) the screen 47, that is, when all of touch points thereof are detected no longer, the control unit disables all of key buttons corresponding to the one of the two hands and configures positions of the key buttons to be undetermined again.

When all of fingers of the two hands de-touch (leave) the screen 47, that is, when all of touch points thereof are detected no longer, the control unit disables all of key buttons configured on the screen 47 and configures positons of the key buttons to be undetermined again.

In this part, fitting a virtual circle based on touch points of a hand can be replaced by fitting a virtual conic section of the other type, such as a virtual ellipse, parabola or hyperbola. As we all know, a circle is a special case of a conic section, especially an ellipse. And comparing radiuses/diameters of two virtual circles can be replaced by comparing semi-latus rectum(s)/latus rectum(s) of two virtual conic sections of the other type. And calculating a virtual circular arc can be replaced by calculating a virtual conic arc of the other type. And a center of a virtual circle/circular arc can be replaced by a focus of a virtual conic section/arc of the other type, or by a center of a virtual ellipse/elliptical arc. And finding a relative position of a center to a related virtual circular arc by comparing coordinates of the center respectively with that of two endpoints of the virtual circular arc can be replaced by finding a relative position of a focus to a related virtual conic arc by comparing coordinates of the focus respectively with that of two endpoints of the virtual conic arc, or by finding a relative position of a center to a related virtual elliptic arc by comparing coordinates of the center respectively with that of two endpoints of the virtual elliptic arc.

Herein, a center and radius/diameter of a virtual circular arc/circle respectively correspond to a focus/center and semi-latus rectum/latus rectum of a virtual conic arc/section of the other type.

In this part, comparing two radiuses/semi-latus rectums is identical to comparing two diameters/latus rectums.

It is not necessary to configure five key buttons for each of two hands of a user, or configure an identical number of key buttons for both of the two hands. In other words, each of the two hands can be configured with a different number of key buttons which may be less than five or more than five.

When key buttons configured for a hand is less than five, ignoring unused touch points of five touch points of five fingers of the hand, or combining multiple touch points/fingers of the hand for a same key button, or respectively and individually configuring multiple touch points/fingers of the hand for a same key button, is better than letting unused finger(s) of the hand hang(s) in the air.

If different number of key buttons are configured for each of two hands of a user, and moreover a unused finger(s) of the two hands hang(s) in the air, the control unit may need to group touch points of the two hands two times either by x or y value for getting two correct touch point groups. For example, if the left hand has three touch points for three key buttons and the right hand has four touch points for four key buttons, the control unit, by x value, first divides the seven touch points into two groups respectively with three and four touch points, if the first grouping is determined to be wrong, then divides the seven touch points into another two groups respectively with four and three touch points. And so are grouping the seven touch points by y value if necessary.

Besides performing key button operations, two hands of a user can also be used to perform many other touch operations by sliding, pinching or rotating, etc. on the screen 47.

Part T.

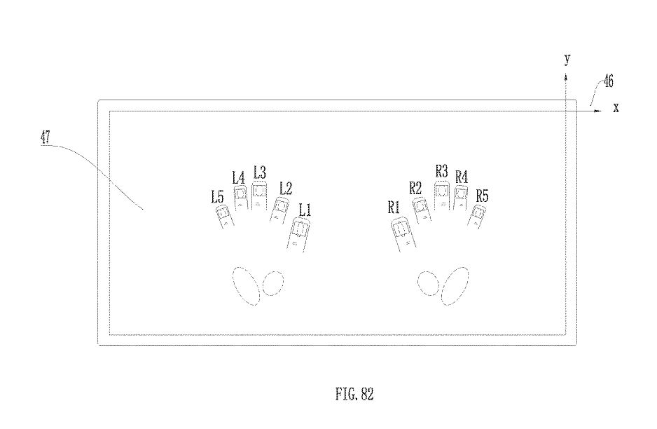

As shown in FIG. 82, a user uses all of ten fingers together with two palms of his/her two hands to touch and rest on the screen 47. Each of the two hands will generate seven touches on the screen 47 with five fingers and two parts of a palm thereof, and there are totally fourteen touch points for the two hands.

Ten key buttons are configured on the screen 47 and correspond one-to-one to the ten fingers, and initially, they are disabled and their positions are configured to be undetermined.

There are three methods for dynamically configuring positions of the ten key buttons as the following:

Method 1:

(1) A control unit groups the fourteen touch points according to the grouping method described in Part S and gets two correct touch point groups of which each includes seven touch points.

(2) The control unit respectively matches each of the two correct touch point groups to a left or right one of the two hands according to one of the methods described in Part O and P. Please refer to the relevant description of Part O and P for more details.

(3) The other steps for further dynamically configuring positions of each five of the ten key buttons respectively corresponding to five left or right fingers of the two hands are the same as the counterpart steps of one of the methods described in Part O and P.

Method 2:

If a touch area for each touch is available,

(1) The control unit excludes four touch points with the four largest touch areas from the fourteen touch points.

(2) The other steps for further dynamically configuring positions of the ten key buttons based on the remaining touch points which only include touch points of ten fingers of the two hands are the same as that of the method described in Part S.

Method 3:

If a touch area for each touch is available,

(1) The control unit groups the fourteen touch points according to the grouping method described in Part S and gets two correct touch point groups.

(2) For each of the two correct touch point groups, the control unit excludes two touch points with the two largest touch areas and gets two new touch point groups of which each only include touch points of five fingers of one of the two hands.

(3) The other steps for further dynamically configuring positions of the ten key buttons based on the two new touch point groups are the same as corresponding steps of the method described in Part S.

About the other aspects not described in this part, please refer to the same or similar description of Part S.

Part U.

In this specification, a point semi-surrounded or surrounded by touch points of a hand, for the methods described in Part M, N, O, P, Q, may be a center/centroid/focus of a virtual circle/parabola/ellipse/hyperbola or another virtual curve fitted based on the touch points, or a center/centroid of a triangle or quadrangle based on the leftmost, rightmost, topmost and bottommost touch points found from the touch points(sometimes only three qualified touch points can be found), and so on. Anyway, the point had better be a center/centroid of a virtual geometry fitted based on the touch points. Generally, a center of a virtual circle or ellipse is the best. In addition, two virtual circles/parabolas/ellipses/hyperbolas or other virtual curves will be fitted based on two touch points, for example, two touch points of two parts of a palm, one of them, whose center/focus/centroid is the nearest to a center of the touch pad 29, should be selected.

In the present invention, a touch sensitive pad/panel/screen is a touch sensitive surface in which a touch is detected in the form of either or both of a touch point and a touch area. If only a touch area for a touch is available, a touch point for the touch can be obtained by calculating a centroid of the touch area, and a touch point, a centroid of a touch area or a centroid of a touch means the same thing. And detecting a touch point/area means detecting a touch, and vice versa. Because of palm prints, two parts of a palm of a hand may generate more than two touch points on the touch sensitive surface. Nevertheless, a linear distance between any two of touch points of one of the two parts, is smaller than a width of a pinky finger of the hand as well as that between two centers of the two parts. Accordingly, the touch points of the one of the two parts can be identified, and then a virtual geometry is fitted based on the touch points, and a center/centroid of the virtual geometry is regarded a touch point of the one of the two parts.

In the present invention, a touch point may be presented in rectangular coordinates such as (x, y), (x, y, p), (x, y, z) or (x, y, z, p); or in polar coordinates such as (ρ, φ) or (ρ, φ, p); or in coordinates of the other type, wherein p represents a pressure value applied at the touch point on the touch sensitive surface by a finger or a part of a palm, etc. And the present invention includes, but is not limited to using a rectangular or polar coordinate system.

In the present invention, configuring a touch point to be a position of a key button generally means configuring the touch point to be a centroid/center of the key button.

In the present invention, a method(s) for side-keys and/or mouse buttons are also applicable to key buttons with the other functions.

1. A method for sorting a plurality of touch points of a hand on a touch sensitive surface, comprising,
finding a point semi-surrounded or surrounded by the plurality of touch points, and
creating a polar coordinate system with the point as a pole, and
converting coordinates of the plurality of touch points to polar coordinates based on the polar coordinate system and getting a copy of the plurality of touch points, wherein touch points in the copy are represented by the polar coordinates, and
sorting the touch points in the copy by polar angle and getting a first touch point sequence

2. The method of claim 1, further comprising,
getting a second touch point sequence based on the first touch point sequence according to corresponding relationships between the plurality of touch points and the touch points in the copy, wherein touch points in the second touch point sequence are represented by the original coordinates.

3. The method of claim 2, further comprising,
matching the plurality of touch points one-to-one with a plurality of fingers of the hand based on the second touch point sequence, wherein the plurality of fingers touching the touch sensitive surface generate the plurality of touch points, and
configuring at least a portion of the plurality of touch points to be positions of at least a portion of a plurality of key buttons configured on the touch sensitive surface based on predefined corresponding relationships between the plurality of fingers and the plurality of key buttons.

4. The method of claim 2, further comprising,
calculating lengths of straight lines between every two adjacent touch points in the second touch point sequence and getting a straight line sequence, wherein the last and first touch points in the second touch point sequence are deemed to be adjacent, and
finding the first longest straight line in the straight line sequence.

5. The method of claim 4, further comprising,
(i) finding a position of the first or second endpoint of the longest straight line in the second touch point sequence, and
matching a plurality of fingers of the hand one-to-one with a portion of the plurality of touch points based on the position together with the second touch point sequence, wherein the plurality of fingers touching the touch sensitive surface generate the portion of the plurality of touch points, and
configuring at least a portion of the plurality of touch points to be positions of at least a portion of a plurality of key buttons configured on the touch sensitive surface based on predefined corresponding relationships between the plurality of fingers and the plurality of key buttons; or alternatively
(ii) finding the third and antepenultimate straight lines in the straight line sequence from the first longest straight line, wherein the last and first straight lines in the straight line sequence are deemed to be adjacent,
identifying the hand to be a left or right one based on a relative length of the third straight line to the antepenultimate straight line; or alternatively
finding the second longest straight line in the straight line sequence,
finding a relative position of the second longest straight line to the first longest straight line in the straight line sequence, wherein the last and first straight lines in the straight line sequence are deemed to be adjacent,
identifying the hand to be a left or right one based on the relative position, and
finding a position of the first or second endpoint of the longest straight line in the second touch point sequence, and
matching a plurality of fingers of the hand one-to-one with a portion of the plurality of touch points based on the position together with the second touch point sequence, wherein the plurality of fingers touching the touch sensitive surface generate the portion of the plurality of touch points, and
configuring at least a portion of the plurality of touch points to be positions of at least a portion of a plurality of key buttons configured on the touch sensitive surface based on predefined corresponding relationships between the plurality of fingers and the plurality of key buttons

6. The method of claim 2, further comprising,
calculating angles between every two adjacent rays starting at the point and respectively passing through every two adjacent touch points in the second touch point sequence and getting an angle sequence, wherein the last and first touch points in the second touch point sequence are deemed to be adjacent, and
finding the first largest angle in the angle sequence.

7. The method of claim 6, further comprising,
(i) finding a position of a touch point passed through by the first or second ray of the first largest angle in the second touch point sequence, and
matching a plurality of fingers of the hand one-to-one with a portion of the plurality of touch points based on the position together with the second touch point sequence, wherein the plurality of fingers touching the touch sensitive surface generate the portion of the plurality of touch points, and
configuring at least a portion of the plurality of touch points to be positions of at least a portion of a plurality of key buttons configured on the touch sensitive surface based on predefined corresponding relationships between the plurality of fingers and the plurality of key buttons; or alternatively
(ii) finding the third and antepenultimate angles in the angle sequence from the first largest angle, wherein the last and first angles in the angle sequence are deemed to be adjacent,
identifying the hand to be a left or right one based on a relative size of the third angle to the antepenultimate angle; or alternatively
finding the second largest angle in the angle sequence,
finding a relative position of the second largest angle to the first largest angle in the angle sequence, wherein the last and first angles in the angle sequence are deemed to be adjacent,
identifying the hand to be a left or right one based on the relative position, and
finding a position of a touch point passed through by the first or second ray of the first largest angle in the second touch point sequence, and
matching a plurality of fingers of the hand one-to-one with a portion of the plurality of touch points based on the position together with the second touch point sequence, wherein the plurality of fingers touching the touch sensitive surface generate the portion of the plurality of touch points, and
configuring at least a portion of the plurality of touch points to be positions of at least a portion of a plurality of key buttons configured on the touch sensitive surface based on predefined corresponding relationships between the plurality of fingers and the plurality of key buttons.

8. The method of claim 2, further comprising,
excluding two touch points with the two largest touch areas from the second touch point sequence and getting a new touch point sequence, and
matching a plurality of fingers of the hand one-to-one with touch points in the new touch point sequence, wherein the plurality of fingers touching the touch sensitive surface generate the touch points in the new touch point sequence, and
configuring at least a portion of the plurality of touch points to be positions of at least a portion of a plurality of key buttons configured on the touch sensitive surface based on predefined corresponding relationships between the plurality of fingers and the plurality of key buttons.

9. A method for sorting a plurality of touch points of a hand on a touch sensitive surface, comprising,
finding a point semi-surrounded or surrounded by the plurality of touch points, and
calculating a plurality of slopes of straight lines from the point respectively to the plurality of touch points, and
dividing the plurality of slopes into a plurality of slope groups, and
sorting slopes in the plurality of slope groups respectively and getting a plurality of slope sequences, and
putting the plurality of slope sequences together and getting a slope sequence, and
getting a touch point sequence based on the slope sequence according to corresponding relationships between the plurality of touch points and the plurality of slopes.

10. The method of claim 9, further comprising,
matching the plurality of touch points one-to-one with a plurality of fingers of the hand based on the touch point sequence, wherein the plurality of fingers touching the touch sensitive surface generate the plurality of touch points , and
configuring at least a portion of the plurality of touch points to be positions of at least a portion of a plurality of key buttons configured on the touch sensitive surface based on predefined corresponding relationships between the plurality of fingers and the plurality of key buttons.

11. The method of claim 9, further comprising,
calculating lengths of straight lines between every two adjacent touch points in the touch point sequence and getting a straight line sequence, wherein the last and first touch points in the touch point sequence are deemed to be adjacent, and
finding the first longest straight line in the straight line sequence.

12. The method of claim 11, further comprising,
(i) finding a position of the first or second endpoint of the longest straight line in the touch point sequence, and
matching a plurality of fingers of the hand one-to-one with a portion of the plurality of touch points based on the position together with the touch point sequence, wherein the plurality of fingers touching the touch sensitive surface generate the portion of the plurality of touch points, and
configuring at least a portion of the plurality of touch points to be positions of at least a portion of a plurality of key buttons configured on the touch sensitive surface based on predefined corresponding relationships between the plurality of fingers and the plurality of key buttons; or alternatively
(ii) finding the third and antepenultimate straight lines in the straight line sequence from the first longest straight line, wherein the last and first straight lines in the straight line sequence are deemed to be adjacent,
identifying the hand to be a left or right one based on a relative length of the third straight line to the antepenultimate straight line; or alternatively
finding the second longest straight line in the straight line sequence,
finding a relative position of the second longest straight line to the first longest straight line in the straight line sequence, wherein the last and first straight lines in the straight line sequence are deemed to be adjacent,
identifying the hand to be a left or right one based on the relative position, and
finding a position of the first or second endpoint of the longest straight line in the touch point sequence, and
matching a plurality of fingers of the hand one-to-one with a portion of the plurality of touch points based on the position together with the touch point sequence, wherein the plurality of fingers touching the touch sensitive surface generate the portion of the plurality of touch points, and
configuring at least a portion of the plurality of touch points to be positions of at least a portion of a plurality of key buttons configured on the touch sensitive surface based on predefined corresponding relationships between the plurality of fingers and the plurality of key buttons

13. The method of claim 9, further comprising,
calculating angles between every two adjacent rays starting at the point and respectively passing through every two adjacent touch points in the touch point sequence and getting an angle sequence, wherein the last and first touch points in the touch point sequence are deemed to be adjacent; and
finding the first largest angle in the angle sequence.

14. The method of claim 13, further comprising,
(i) finding a position of a touch point passed through by the first or second ray of the first largest angle in the touch point sequence, and
matching a plurality of fingers of the hand one-to-one with a portion of the plurality of touch points based on the position together with the touch point sequence, wherein the plurality of fingers touching the touch sensitive surface generate the portion of the plurality of touch points, and
configuring at least a portion of the plurality of touch points to be positions of at least a portion of a plurality of key buttons configured on the touch sensitive surface based on predefined corresponding relationships between the plurality of fingers and the plurality of key buttons; or alternatively
(ii) finding the third and antepenultimate angles in the angle sequence from the first largest angle, wherein the last and first angles in the angle sequence are deemed to be adjacent,
identifying the hand to be a left or right one based on a relative size of the third angle to the antepenultimate angle; or alternatively
finding the second largest angle in the angle sequence,
finding a relative position of the second largest angle to the first largest angle in the angle sequence, wherein the last and first angles in the angle sequence are deemed to be adjacent,
identifying the hand to be a left or right one based on the relative position, and
finding a position of a touch point passed through by the first or second ray of the first largest angle in the touch point sequence, and
matching a plurality of fingers of the hand one-to-one with a portion of the plurality of touch points based on the position together with the touch point sequence, wherein the plurality of fingers touching the touch sensitive surface generate the portion of the plurality of touch points, and
configuring at least a portion of the plurality of touch points to be positions of at least a portion of a plurality of key buttons configured on the touch sensitive surface based on predefined corresponding relationships between the plurality of fingers and the plurality of key buttons.

15. The method of claim 9, further comprising,
excluding two touch points with the two largest touch areas from the touch point sequence and getting a new touch point sequence, and
matching a plurality of fingers of the hand one-to-one with touch points in the new touch point sequence, wherein the plurality of fingers touching the touch sensitive surface generate the touch points in the new touch point sequence, and
configuring at least a portion of the plurality of touch points to be positions of at least a portion of a plurality of key buttons configured on the touch sensitive surface based on predefined corresponding relationships between the plurality of fingers and the plurality of key buttons.

16. A method for sorting a plurality of touch points of a hand on a touch sensitive surface, comprising,
fitting a virtual straight line based on the plurality of touch points, and
creating a coordinate system with the virtual straight line as a coordinate axis , and
converting coordinates of the plurality of touch points to new coordinates based on the coordinate system and getting a copy of the plurality of touch points, wherein touch points in the copy are represented by the new coordinates, and
sorting the touch points in the copy along the coordinate axis and getting a first touch point sequence.

17. The method of claim 16, further comprising,
getting a second touch point sequence based on the first touch point sequence according to corresponding relationships between the plurality of touch points and the touch points in the copy, wherein touch points in the second touch point sequence are represented by the original coordinates.

18. The method of claim 17, further comprising,
matching a plurality of fingers of the hand one-to-one with the plurality of touch points based on the second touch point sequence, wherein the plurality of fingers touching the touch sensitive surface generate the plurality of touch points, and
configuring at least a portion of the plurality of touch points to be positions of at least a portion of a plurality of key buttons configured on the touch sensitive surface based on predefined corresponding relationships between the plurality of fingers and the plurality of key buttons.
